(19) United States
(12) Patent Application Publication
(10) Pub. No.: US 2011/0107203 A1
(43) Pub. Date: May 5, 2011

(54) SYSTEM AND METHOD FOR PROVIDING JUDICIAL ORDERS

(75) Inventors: Barbara NASH, Sagamore Hills, OH (US); Dave Nash, Sagamore Hills, OH (US); Linda Price, Sagamore Hills, OH (US); Steve Sibert, North Canton, OH (US); Larry Depasquale, North Canton, OH (US)

(73) Assignee: COURTVIEW JUSTICE SOLUTIONS, North Canton, OH (US)

(21) Appl. No.: 12/888,008

(22) Filed: Sep. 22, 2010

Related U.S. Application Data
(60) Provisional application No. 61/244,987, filed on Sep. 23, 2009.

(51) Int. Cl. G06F 17/20

(52) U.S. Cl. 715/243

(57) ABSTRACT

A system and method for providing judicial orders is provided. The system includes storage, case management data and components stored in the storage, and a user interface. The components include a set of controls that are related. At least some of the controls providing access to the case management data. The user interface enables the defining of judicial order templates, including the selection of the components included in the judicial order templates. The defined judicial order templates are used to create orders.

This application claims priority from U.S. Provisional Patent Application Ser. No. 61/244,987 filed on Sep. 23, 2010, the contents of which are incorporated herein by reference.

### FIELD OF THE INVENTION

The present invention relates generally to information systems. In particular, the invention relates to a system and method for providing judicial orders.

### BACKGROUND OF THE INVENTION

Judicial orders have been traditionally recorded manually by a court official during a court event. The same or another court official then prepares documents representing the order and provide copies to the appropriate parties, as well as filing a copy of the documents in the court's records. Such orders have been recorded in courtroom record computer systems by scanning the paper order documents in and saving them with related data that has to be re-entered.

In recent years, computers have become more prevalent in the courtroom, facilitating many processes. The provisioning of orders via computer systems poses many problems, however. If input screens for capturing all of the information for a judicial order are too general, they can be difficult to navigate, thereby slowing down the recording of the order by a court official, thus slowing down the operational speed of the court. If the input screens for capturing information for a judicial order are specifically tailored for each type of order, the programming and configuration of such a system can be onerous, potentially leading to inconsistencies.

In some cases, data is captured by a court official and then subsequently merged via a word processor such as Microsoft™ Word™, but this also can be onerous, time-consuming and prone to error.

It is therefore an object of the invention to provide a novel system and method for providing judicial orders.

### SUMMARY OF THE INVENTION

According to an aspect of the invention, there is provided a system for providing judicial orders, comprising:

storage;

case management data stored in said storage;

components stored in said storage, said components comprising a set of controls that are related, at least some of said controls providing access to said case management data structure;

a user interface for defining judicial order templates by selecting said components included in said judicial order templates, said judicial order templates being used to create orders.

The user interface can enable configuration of the controls.

Each of the components can have a scope attribute specifying the applicability of the component.

The order templates can have defined scopes.

Data for confirmed orders can be saved in the case management data structure.

Data for draft orders can be saved separate from the data for the confirmed orders.

Default values can be established for at least one field of the order templates.

Fields of the order templates can be flagged as mandatory.

Fields of the order templates can be flagged as hidden.

The user interface can enable the definition of rules governing the use of the order templates.

The order templates can be populated in the second user interface with data from the case management data structure related to a case and/or event for which an order is being generated.

At least one of the components can enable pre-defined text paragraphs to be inserted into an order.

The user interface can enable selection and insertion of the components into an order template.

The user interface can enable specification of the order of display of the components in the order template.

Upon confirmation of the draft orders, the data from the draft orders can be saved in the case management data structure.

The system can restrict confirmation of the draft orders based on privileges of a user using the system.

According to another aspect of the invention, there is provided a method for providing judicial orders, comprising:

providing a set of components in storage of a computer system, said components comprising a set of controls that are related, at least some of said controls providing access to case management data structure;

providing a user interface for defining judicial order templates by selecting said components included in said judicial order templates, said defined judicial order templates being used to create orders.

The user interface can enable configuration of the controls.

Each of the components can have a scope attribute specifying the applicability of the component.

The order templates can have defined scopes.

Data for confirmed orders can be saved in the case management data structure.

Data for draft orders can be saved separate from the data for the confirmed orders.

The user interface can enable the definition of rules governing the use of the order templates.

The order templates can be populated by the computer system with data from the case management data structure related to a case and/or event for which an order is being generated.

At least one of the components can enable pre-defined text paragraphs to be inserted into an order.

The user interface can enable selection and insertion of the components into an order template.

The user interface can enable specification of the order of display of the components in the order template.

Upon confirmation of the draft orders, the data from the draft orders can be saved in the case management data structure.

### BRIEF DESCRIPTION OF THE DRAWINGS

An embodiment will now be described, by way of example only, with reference to the attached Figures, wherein:

FIG. 1 shows a schematic representation of a judicial orders computer system in accordance with an embodiment of the invention and its working environment;

FIG. 2 shows a schematic diagram of the some of the components of the computer system of FIG. 1;

FIG. 3 shows a number of software and data elements of the computer system of FIG. 1;

FIG. 4 is a flowchart of two routes leading to the creation of an order using the computer system of FIG. 1;

FIG. 5 shows a data model for orders used by the computer system of FIG. 1;

FIGS. 6A to 6D show exemplary applications of judicial orders;

FIG. 7 shows a table of some data fields in the data model for orders of FIG. 5;

FIGS. 8 and 9 illustrate exemplary scenarios of how judicial orders can apply to different entities;

FIG. 10 shows a table of examples of orders on an event for a case;

FIGS. 11A to 11C, 12A to 12C, 13A, 13B, 14A and 14B show tables of rules for various types of orders used by the computer system of FIG. 1;

FIG. 15 shows a table of eligibility rules for representative orders;

FIGS. 16A and 16B shows a table of various order process components for representative orders;

FIGS. 17A and 17B show tables of order completion and consistency rules respectively for various orders;

FIG. 18 shows a session selection screen provided by the computer system of FIG. 1;

FIG. 19 show a session details screen provided by the computer system of FIG. 1;

FIG. 20 show a case selection screen provided by the computer system of FIG. 1;

FIG. 21 shows an anchor screen provided by the computer system of FIG. 1;

FIG. 22 shows the event notes and case notes sections of the anchor screen of FIG. 21 after expansion;

FIG. 23 shows the parties section of the anchor screen of FIG. 21 after expansion;

FIG. 24 shows the claims section of the anchor screen of FIG. 21 after expansion;

FIG. 25 shows the party charges section of the anchor screen of FIG. 21 after expansion;

FIG. 26 shows the maintain orders section of the anchor screen of FIG. 21 after expansion;

FIG. 27 shows the motions section of the anchor screen of FIG. 21 after expansion;

FIG. 28 shows the linked events and event timing sections of the anchor screen of FIG. 21 after expansion;

FIG. 29 shows the anchor screen of FIG. 21 with all sections expanded;

FIG. 30 shows an order summary screen provided by the computer system of FIG. 1;

FIG. 31 shows a particular order details screen provided by the computer system of FIG. 1;

FIG. 32 shows an alternative top section of the particular order details screen of FIG. 31;

FIG. 33 shows another alternative top section of the particular order details screen of FIG. 31;

FIG. 34 shows a pop-up box presented after activation of a button of the particular order details screen of FIG. 31;

FIG. 35 shows another alternative top section of the particular order details screen of FIG. 31;

FIG. 36 shows an activity listing box provided by the computer system of FIG. 1;

FIG. 37 shows a particular index screen provided by the computer system of FIG. 1;

FIG. 38 shows a pop-up displayed when hovering over an icon of the particular index screen of FIG. 37;

FIG. 39 shows a new orders section provided by the computer system of FIG. 1;

FIG. 40 shows a sentencing component provided by the computer system of FIG. 1 for building orders;

FIG. 41 shows a claim judgment component provided by the computer system of FIG. 1 for building orders;

FIG. 42 shows a bail component provided by the computer system of FIG. 1 for building orders;

FIG. 43 shows a record event result component provided by the computer system of FIG. 1 for building orders;

FIG. 44 shows a scheduled events component provided by the computer system of FIG. 1 for building orders;

FIG. 45 shows a free text component provided by the computer system of FIG. 1 for building orders;

FIG. 46 shows a paragraph selection component provided by the computer system of FIG. 1 for building orders;

FIG. 47 shows a paragraph selection component similar to the one shown in FIG. 46;

FIG. 48 shows a content builder component provided by the computer system of FIG. 1 for building orders;

FIG. 49 shows a content builder text editor provided by the computer system of FIG. 1 for searching and displaying paragraph descriptions;

FIG. 50 shows a preview of paragraph text merged by the computer system of FIG. 1;

FIG. 51 shows a docket component provided by the computer system of FIG. 1 for building orders;

FIG. 52 shows a document generation component provided by the computer system of FIG. 1 for building orders;

FIG. 53 shows a particular status code selection screen provided by the computer system of FIG. 1;

FIG. 54 shows a particular status code maintenance screen provided by the computer system of FIG. 1;

FIG. 55 shows a set up selection screen provided by the computer system of FIG. 1;

FIG. 56 shows a set up maintenance screen provided by the computer system of FIG. 1;

FIG. 57 shows the set up maintenance screen of FIG. 56 after the set up configuration is saved;

FIG. 58 shows a paragraph code selection screen provided by the computer system of FIG. 1;

FIG. 59 shows a paragraph code maintenance screen provided by the computer system of FIG. 1;

FIG. 60 shows an exemplary paragraph fields section provided by the computer system of FIG. 1 for selecting pre-defined text for inclusion in an order;

FIG. 61 shows a paragraph group code selection screen provided by the computer system of FIG. 1;

FIG. 62 shows a paragraph group code maintenance screen provided by the computer system of FIG. 1;

FIG. 63 shows a diagram of entity relationships for orders in the computer system of FIG. 1;

FIG. 64 shows a particular code selection screen provided by the computer system of FIG. 1;

FIG. 65 shows a particular code maintenance screen provided by the computer system of FIG. 1;

FIG. 66 shows an eligibility constraints screen provided by the computer system of FIG. 1;

FIG. 67 shows a free text component of a particular component field maintenance screen provided by the computer system of FIG. 1;

FIG. 68 shows the particular component field maintenance screen similar to FIG. 67 for a record event result component;

FIG. 69 shows the particular component field maintenance screen similar to FIG. 67 for a paragraph selector component;

FIG. 70 shows a section of the particular order details screen for a paragraph selector component;

FIG. 71 shows the particular component field maintenance screen similar to

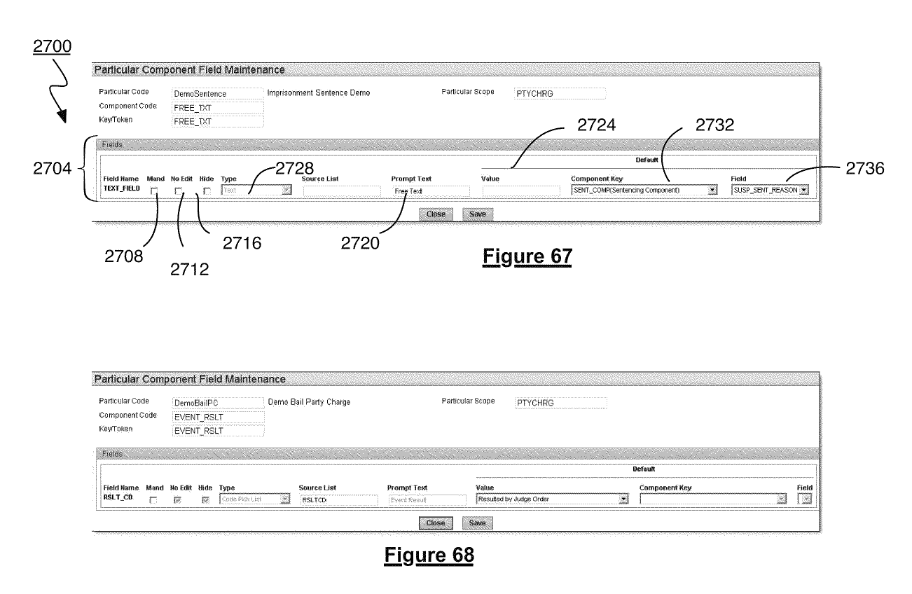

FIG. 67 for the content builder component;

FIG. 72 shows the particular component field maintenance screen similar to FIG. 67 for the docket component;

FIG. 73 shows the particular component field maintenance screen similar to FIG. 67 for the document generator component;

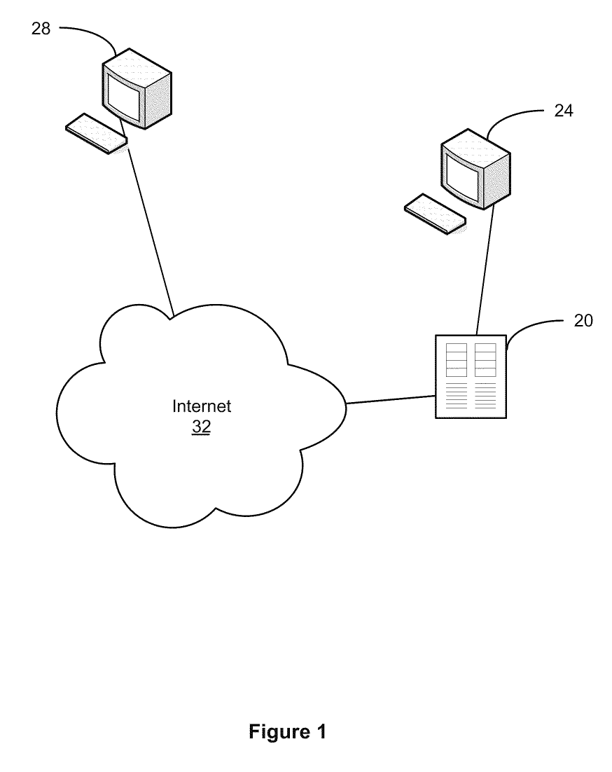

FIG. 74 shows an orders security maintenance screen provided by the computer system of FIG. 1;

FIG. 75 shows various possible states of an order's life cycle in the computer system of FIG. 1;

FIG. 76 shows a path to navigate to existing orders using the computer system of FIG. 1;

FIG. 77 shows the navigation paths a user may take when voiding orders using the computer system of FIG. 1;

FIG. 78 shows the voiding of an order to modify its status using the computer system of FIG. 1;

FIG. 79 shows a pop-up presented by the computer system of FIG. 1 after updating an order's status; and

FIG. 80 shows an activity listing box that is created by the computer system of FIG. 1 once an order has been modified.

### DETAILED DESCRIPTION OF THE EMBODIMENT

A judicial court computer system 20 for providing court orders and its working environment in accordance with an embodiment of the invention is shown in FIG. 1. The computer system 20 stores case, docket, schedule, motion, financial, and person-related data, etc. In addition, the computer system 20 stores data and resources that are used to provide court orders as will be described herein. The computer system 20 is in communication with a first client computer 24 over a local area network, and with a second client computer 28 over a large public network, such as the Internet 32. The first client computer 24 is used to access the data and functionality of the computer system 20 to define judicial order templates and configure various components as will be described. The second client computer 28 is used to access the data and functionality of the computer system 20 to create judicial orders using the defined judicial order templates, and to modify and cancel them. In this embodiment, the computer system 20 and first client computer 24 are located at a central site for a jurisdiction, and the second client computer 28 is located in a courtroom.

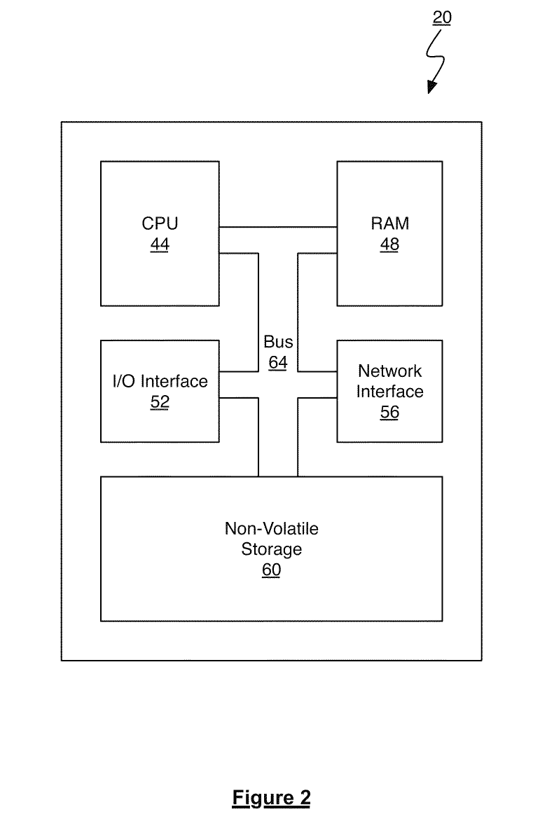

FIG. 2 shows various physical elements of the judicial court computer system 20. As shown, the computer system 20 has a number of physical and logical components, including a central processing unit (“CPU”) 44, random access memory (“RAM”) 48, an input/output (“I/O”) interface 52, a network interface 56, non-volatile storage 60, and a local bus 64 enabling the CPU 44 to communicate with the other components. The CPU 44 executes computer-executable instructions stored in the non-volatile storage 60 for providing an operating system and applications. RAM 48 provides relatively-responsive volatile storage to the CPU 44. The I/O interface 52 allows for input to be received from one or more devices, such as a keyboard, a mouse, etc., and outputs information to output devices, such as a display and/or speakers. The network interface 56 permits communication with the client computers 24, 28 and the central court computer system 36. Non-volatile storage 60 stores the computer-executable instructions for providing the operating system and applications, including computer-executable instructions for implementing the functionality described herein. In addition, non-volatile storage 60 stores data used by the computer system 20 as will be discussed herein. During operation of the judicial court computer system 20, the operating system, the applications and the data may be retrieved from the non-volatile storage 60 and placed in RAM 48 to facilitate execution.

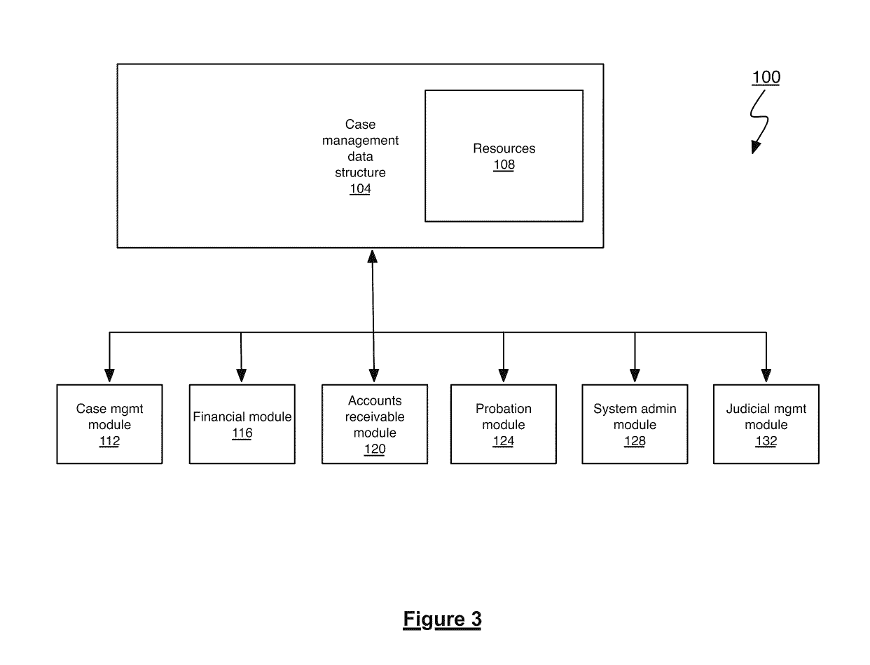

FIG. 3 shows a number of software and data elements of the computer system 20 stored in the non-volatile storage 60 thereof. A case management data structure 104 stores case-based data and co-exists with person-based data and functionalities. The case management data structure 104 records the official record for the court, as well as provides the basis for financial transactions. Resources 108 stored within the case management data structure 104 are used for generating and managing orders. An orders code table 108 references a number of resources stored in non-volatile storage 60 of the computer system 60. The resources include configuration data for components that can update the case management data structure 104, as well as components that allow the configuration of elements to be used in various particular (order) codes defined within the computer system 20. Some of these components employ business rules, free text that can be formatted using some word processing functions, text paragraphs constructed from text fields and other components, etc. This configuration data is stored in database code tables, some of which employ extensible mark-up language (“XML”) data structures stored within character large object fields (“CLOBs”).

Six major software modules perform various case management functions on the data stored in the case management data structure 104. A case management module 112 provides most case initialization and management. There are numerous code tables defined to manage entities such as party types, action (ordinance) codes, claim types, alert codes, docket codes, milestone (tickler) codes, police agencies, police officers, attorneys, etc. The case management module 112 contains functionality allowing users to initiate, manage, and dispose parties, charges, claims, and cases, search indexes for information retrieval, document generation, docketing, case receipting, manage identities, etc. A financial module 116 allows management of the standard functions in financial systems, account definition, general ledger, disbursement, receipt and check voiding, check reconciliation, open items management, end of period controls, etc. The financial transactions are all related to a special type of dockets, and so are intertwined with the case management module 112 and an accounts receivable module 120. The accounts receivable module 120 allows management of the dockets and receipts designated as receivables. Courts may track their receivables, create payment plans, manage disbursements to multiple payees within a case, etc.

A probation module 124 contains some duplicate functionality from the case management module 112 concerning initiating and managing cases, but the screens are designed for probation cases. The emphasis of the probation module 124 is on identity tracking and caseload management for officers, with code tables defined to manage entities such as probation officers, probation types, probation conditions, community service agencies, etc. A systems administration module 128 enables configuration of the major components, such as the definition of entities. Entities include case types, system-wide parameters, court site information, screen definitions, document definitions, and user accounts.

A judicial management module 132 shares some duplicate functionality with the case management module 112 regarding initiating and managing cases. The focus of the judicial management module 132 is on scheduling and calendar functions, with code tables defined to manage entities such as event codes, judges, event result codes, etc. Orders code tables are defined within the judicial management module 132 for particular codes (i.e., order templates), component templates, paragraph codes, etc. The judicial management module 132 provides the main interface for the computer system 20 within the court room, enabling users to create and confirm orders, save draft orders, etc. Scheduling and calendar functions of the judicial management module 132 allow automatic selection of available time slots for different event types, for each judge, or within a single session (block of dates available for multiple events and judges). Security permissions set using the system administration module 128 define what functions a user can perform or delegate to other users using the judicial management module 132. All of the modules 112 to 132 have a Web interface for enabling users to interact with them remotely via a client computer 24, 28.

The design of the judicial orders computer system 20 accommodates as much flexibility as possible in order to allow for administrative implementation of future orders without programming changes. Rather than providing separate screens for each order template, the judicial orders computer system 20 provides the building blocks in the form of components for orders so that order templates can be assembled by a user prior to the actual courtroom proceedings. The components are defined groups of controls (such as input boxes, drop-down lists, radio buttons, etc.). Each component generally includes related controls that are bundled together for ease of selection and relevance. The controls are tied to the data structures and functionality, and thus enable rapid deployment of the bundled controls to access that data and/or functionality in judicial orders.

The invention can be used to rapidly and safely generate and deploy order templates that are customized depending on the needs of the court. These customized order templates facilitate the collection of data. By bundling the controls into pre-defined components, order templates that enable fast data entry can be readily created without having to manually code the order templates and their interaction with the data.

As the components are tested prior to use within order templates, order templates can be deployed out into a production environment quickly without further validation. Thus, users can create and use order templates for a variety of purposes over time and make those order templates available to the judicial officers without the need to develop and test new code.

One of the biggest challenges faced by the design for the judicial orders computer system 20 is the integration of processing across all jurisdictions. The jurisdictions have different requirements for pace, timing and presentation based on the kinds of cases they handle as well as different practices that have become accepted as standard.

The judicial orders computer system 20 is designed to capture the decisions of one or more courts, enabling the efficient capture of information in the courtroom during a scheduled event. The design of the judicial orders computer system 20 is sensitive due to the demanding nature of the courtroom environment. Using the computer system 20, the need to enter data manually is significantly reduced. The computer system 20 is easily navigable and pre-populates as many of the fields as possible. Where extensive text is required for orders, the computer system 20 can provide pre-defined text or allow entry of the bulk of the text before or after the court proceeding. This eliminates the need to enter data manually in multiple locations or multiple systems, as is currently the situation in some jurisdictions and some environments where applications have grown up without integration.

Further, using the judicial order computer system 20, the amount of processing that has to be done after the court proceeding is minimized. Documents can be printed in the courtroom for immediate distribution to the participants.

The integration of orders capture with case management ensures accuracy of the data used to manage the case, immediately implements the order for case management and allows the current status of ordered activities to be displayed with the orders.

The judicial court computer system 20 is designed primarily for the courtroom event as that scenario has the greatest demands, with the understanding that orders may also be created in other situations. Orders are also captured in other situations, such as in chambers when no event was scheduled or at a desk, for example in responding to a request for a default order if the appropriate conditions are met or even in automatic batch processing, as in responding to the interface notification of enforcement activities.

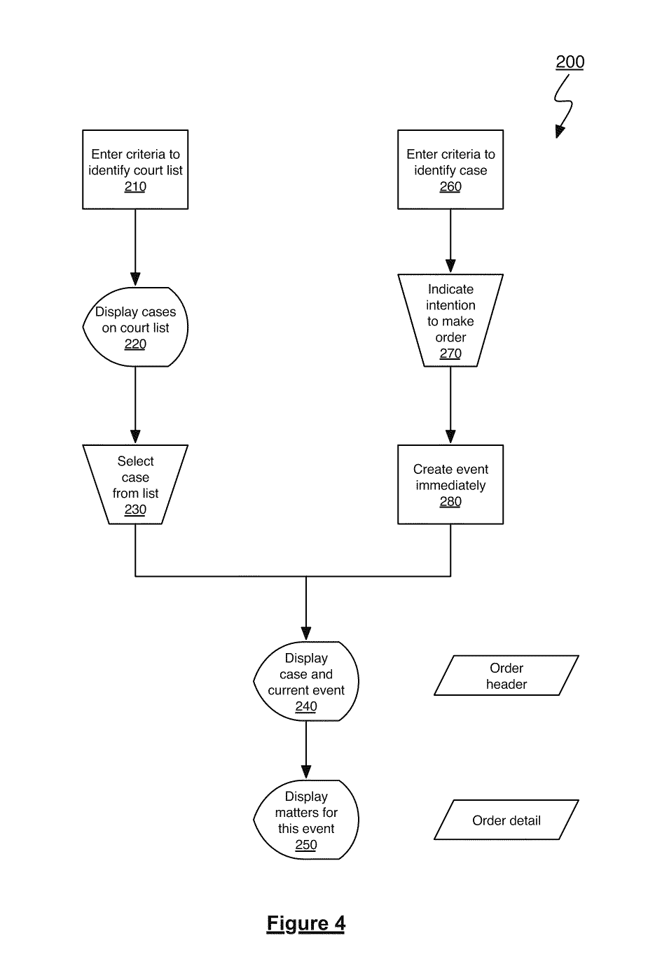

FIG. 4 shows two exemplary scenarios leading up to the creation of an order. One approach to generating an order is by entering criteria to identify a court list (210). This is a list of judicial sessions that have events scheduled within a certain date range, that can be filtered by the judicial session, judge, locality, etc. Selection of a session leads to selection of an event type, which allows the user to search for cases. Once selected, the cases on the court list are displayed, along with their matters and parties (220). A user then selects a case from the list generated at 220 (230). Upon selection of a case from the list at 230, general case details are displayed, together with the current event (240). In addition, a list of matters for the event are displayed. The user selects the case, which calls an anchor screen displaying the parties and matters that were scheduled for the event (250). A user can then select a matter or party on which to generate an order from the list presented at 250.

In an alternative approach, a user can enter criteria to identify or create a case (260). Upon identification of the case, the user can initiate a request to make an order for the specified case (270). Upon receiving the request to make an order, an event is generated (280). Upon generation of the event, the case and the newly-generated event are displayed at 240, together with a list of matters for the event at 250.

### Order Data Model

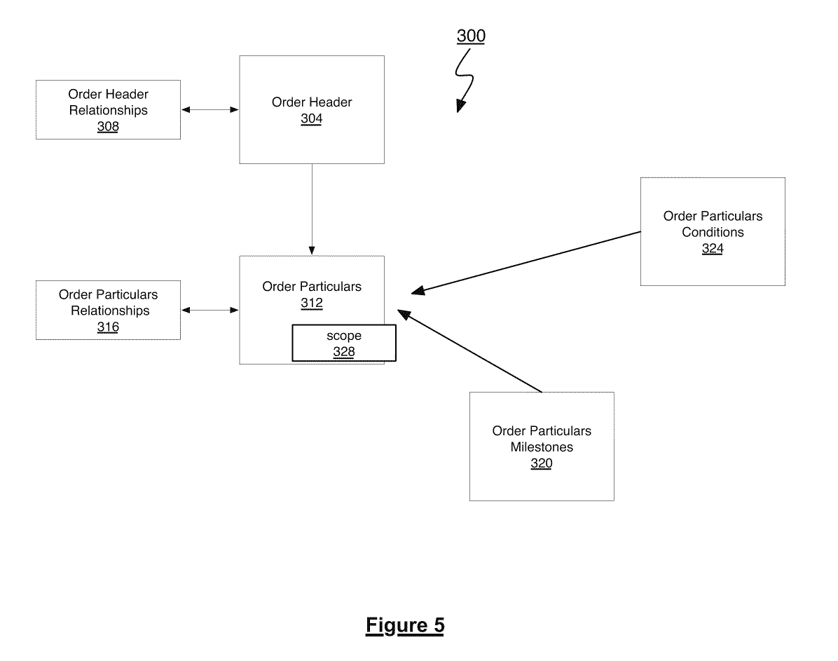

FIG. 5 shows a three-level data model 300 for orders. Each order includes an order header record 304 and one or more order particulars records 312.

The order header record 304 is the highest level and holds together the information that the order was made on a particular case by a particular judicial officer on a certain date and time in a certain location by linking to the case and event time record via order header relationships 308. The order header record 304 also contains a unique identifier for the order.

Under the order header record 304 (i.e., associated with the order header record 304) is one or more order particulars records 312. Order particulars records 312 correspond to the individual decisions or directions of the court, such as, for example, an adjournment, bail or dismissal. The order particulars records 312 link to the case management data structure 104 for that decision via order particular relationships 316. For example, an order can result in a new event being scheduled or new milestones being set. These are recorded via order particulars milestone records 320. In addition, order particulars records 312 can have one or more conditions as specified from the particular code table via order particular conditions records 324. (The conditions are actually connected to the particular code table). It can also link to other orders, such as breach and appeal orders. The linkage is maintained at the order header; i.e., one header can contain multiple particulars.

Each order particulars record 312 has a scope attribute 328. The scope of an order is defined at the particular code table, which controls what kind of entities an order can be made on. These include a party, the case, or different types of matters. There is a scope of “all”, which certain particular codes may be applied anywhere on the screen. The order header and particulars are stored in the same relational database where the case management data structure is stored. The data which makes up the order is stored in XML format in a CLOB field in the order particular record.

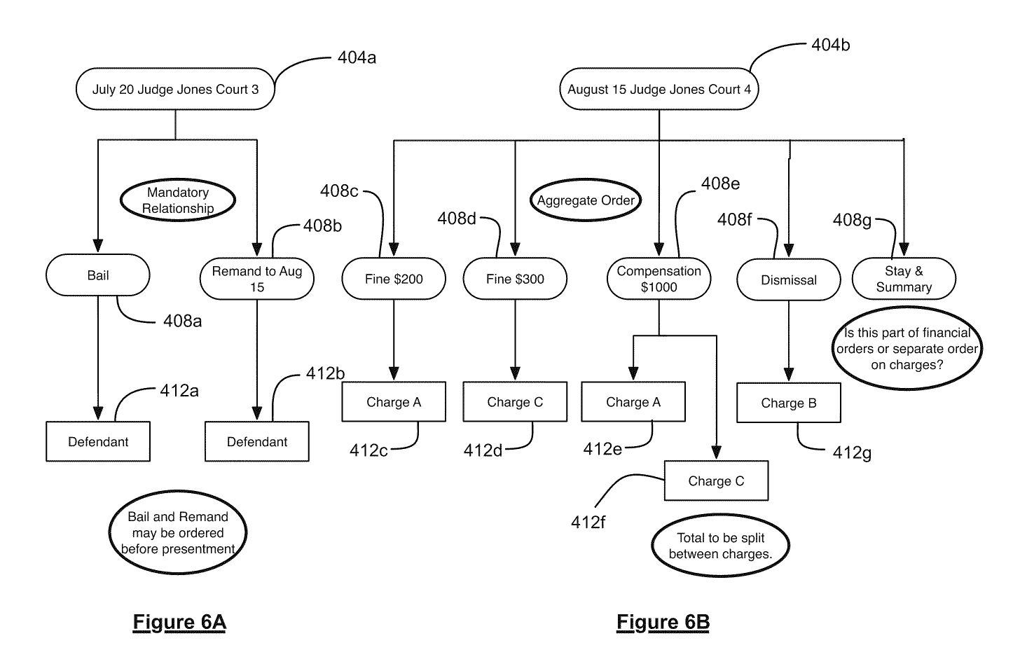

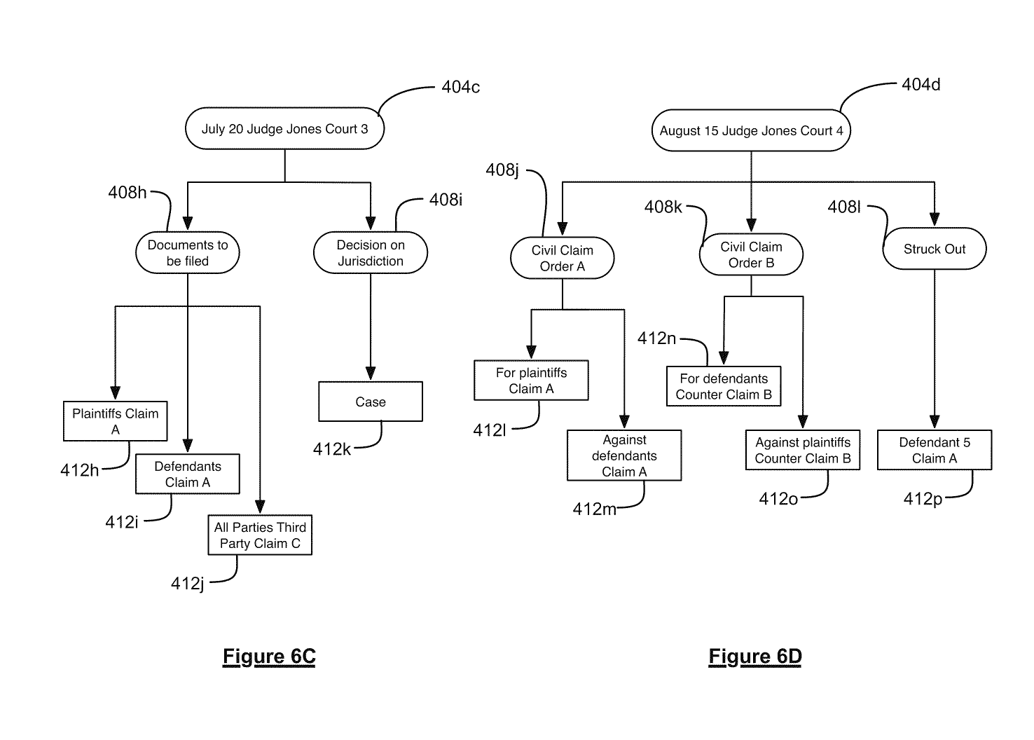

FIGS. 6A to 6D present examples of these three levels. In particular, FIG. 6A shows a criminal case with an order header 404a labeled “July 20 Judge Jones Court 3”. Two order particulars 408a, 408b (a bail and a remand order) are associated with the order header 404a. Each of the order particulars 408a, 408b has an associated entity 412a, 412b respectively to which the orders apply, corresponding to the defendant in each case.

FIG. 6B shows another criminal case with an order header 404b labeled “August 15 Judge Jones Court 4”. Five order particulars 408c to 408g (two fines, a compensation order, a dismissal order and a stay and summary order) are associated with the order header 404b. Order particulars 408c, 408d and 408f each have a single associated entity 412c, 412d, 412g respectively to which the orders apply, corresponding to the defendant in each case. Order particulars 408e is associated with two entities 412e and 412f to which the order applies. Order particulars 408g has no associated entity, as it relates to the case alone.

FIG. 6C shows a civil case dealt with the same day by Judge Jones as the criminal case shown in FIG. 6A. An order header 404c is labeled “July 20 Judge Jones Court 3”. A first order particulars 408h corresponds to documents to be filed, and applies to three entities 412h to 412j, representing parties in the case. As will be understood, these orders direct each of the three parties to file documents. A second order particulars 408i corresponds to a decision on jurisdiction and is associated with entity 412k (a case) indicating that the order particulars 408i correspond to a case.

FIG. 6D shows another civil case dealt with the same day by Judge Jones as the criminal case shown in FIG. 6B. An order header 404d is shown for this civil case, labeled “August 15 Judge Jones Court 4”. The order header 404d has three order particulars 408j to 408l. Order particulars 408j is a civil claim order associated with two entities 412l, 412m to which the order applies, identifying that the civil claim order “A” represented by order particulars 408j is for plaintiffs of claim A and against defendants of claim A. Order particulars 408k is a civil counter claim order “B” associated with two entities 412n, 412o to which the order applies, identifying that the civil counter claim order represented by order particulars 408k is for defendants of claim B and against plaintiffs of counter claim B. Orders particulars 408l is a struck out order, with an order scope 412p, identifying Defendant 5 of claim A as the party being struck out.

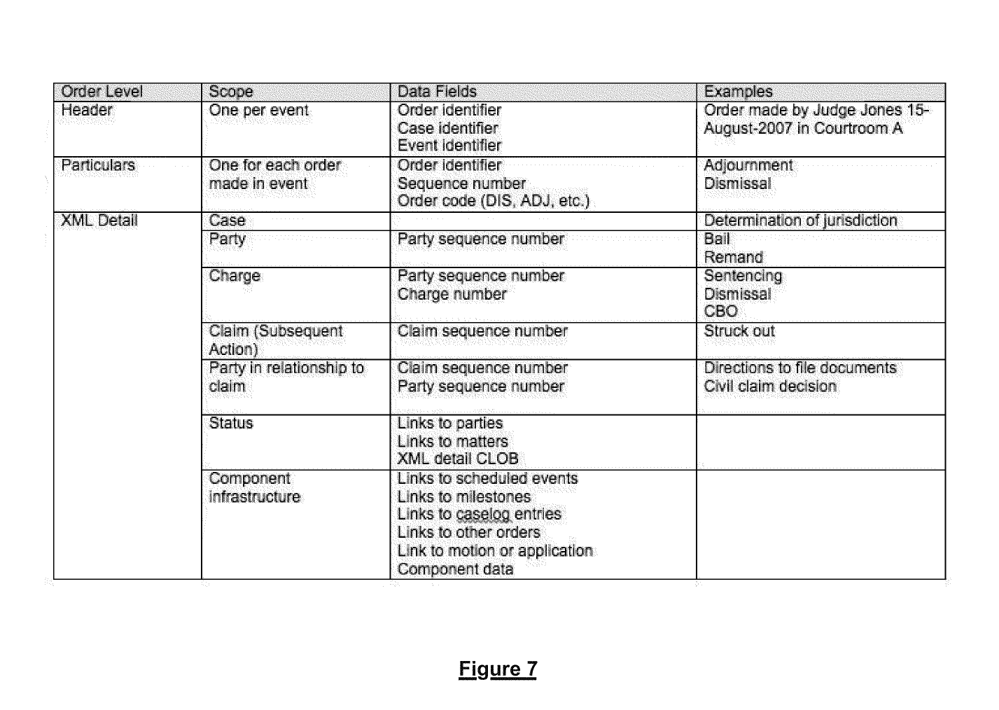

The table shown in FIG. 7 lists some of the data fields that are in the order header records 304 and the order particulars records 312, and the scope attributes 328 of the order header records 304. It highlights the approach of linking to the case management data structure 104 rather than creating a redundant data store. The order data structure is a superstructure associating the order information as it is embodied in the case management data structure 104.

Orders can be applied to a case as a whole, to parties on the case, to charges or claims, to a party to a particular claim or to another order.

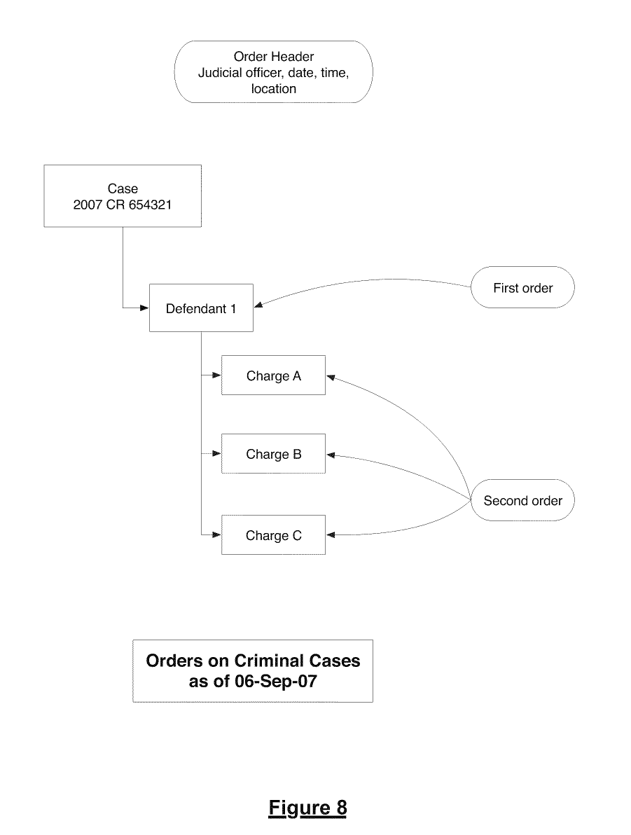

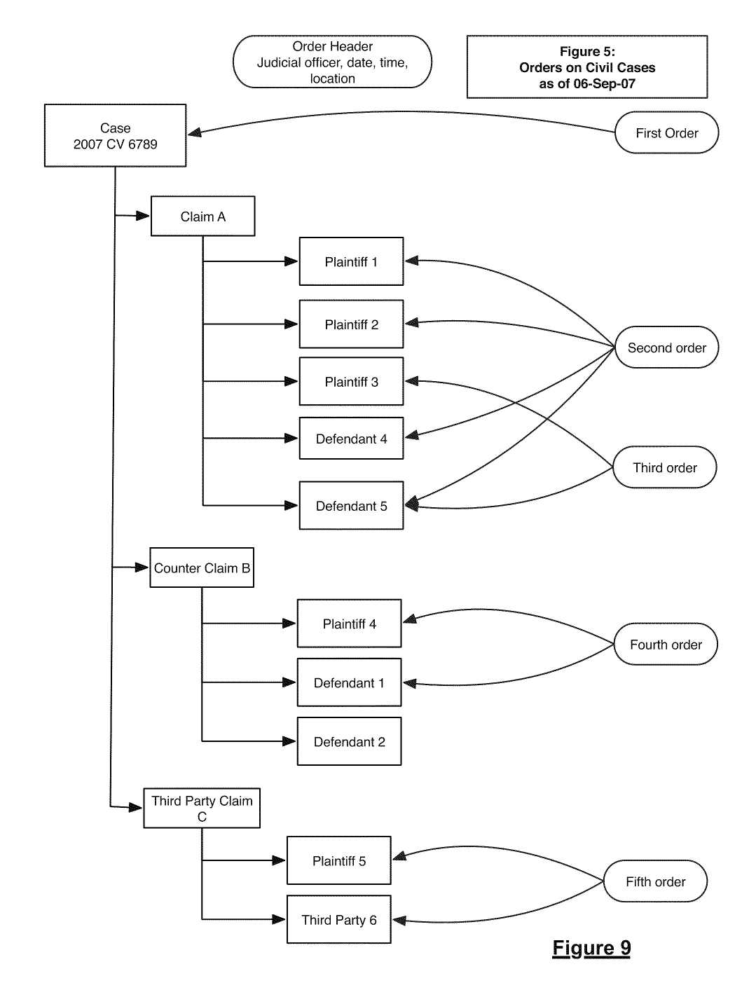

FIG. 8 illustrates examples of orders that apply to a party (bail and remand for defendant) and orders that apply to charges (fines, compensation and dismissal).

FIG. 9 illustrates the application of an order to the case as a whole (decision on jurisdiction) and to individual parties in their roles on particular claims (e.g., the plaintiff on claim B).

Each order is categorized in terms of the scope of its application. For example, most criminal orders apply to individual charges and some are applicable as aggregate orders. The application scope categories include the case as a whole, a party on the case, a charge or claim on the case, and a party in their role on a claim. When a user of the judicial management module 132 proceeds to create an order, only those orders with a scope that is applicable to the case or event that the user is viewing are made available as options.

### Relationships Between Orders

### Persistent Relationships

When the relationships between orders are considered, one distinction made is between persistent relationships between orders due to the nature of the orders and temporary relationships, usually for efficiency. The relationship between an interim and final order or bail variation and original bail order are permanent relationships. Applying the same order to multiple cases at once or using one order as the starting point for another order may be simply a matter of efficiency implying no ongoing relationship between the orders. If the relationship is persistent, it is represented in the case management data structure 104. Orders may be related at the different levels of the order structure as well.

Orders on different cases may be related, such as when a case is sent up for trial that results in a new case in the trial jurisdiction. These scenarios are handled by linking the cases together. In general, the cases are linked for rapid access from one to the other and that may suffice for the connection between the orders. It may also be the case that the same order is made for multiple members of a family, each with their own case. The first order is used as a template for the successive orders but the linking of the cases is sufficient to support future inquiries.

Within a case, an order made at one event may be related to an order made at a subsequent event. Interim and final orders, bail variations and breaches of a community based orders are examples of related orders at this level. The first order provides important information and constraints for the second order. This is a relationship at the level described as order header in the data model.

Within an event, orders may be related by an inherent requirement, for example, bail and remand. The payment summary and stay order are related to all the monetary orders on an event because they are summarizing and setting expectations for them as a group. This is a relationship at the level described as order particulars in the data model.

Within a certain order particulars, there may be one or more matters or parties to which it applies. A special instance is aggregate orders where a fine or sentence is applied to multiple charges in aggregate. For example, $1000 or 12 months may be ordered for multiple charges. While the fine in aggregate is represented on the order, financial docket entries are created for each charge, splitting the total amount between them. The case management data structure 104 stores the collection and distribution of money for each charge separately. Whether or not an order can be applied as an aggregate is an attribute specified during the configuration of a charge both as a control for the judicial management module 132 and to support statistics collected on aggregate orders.

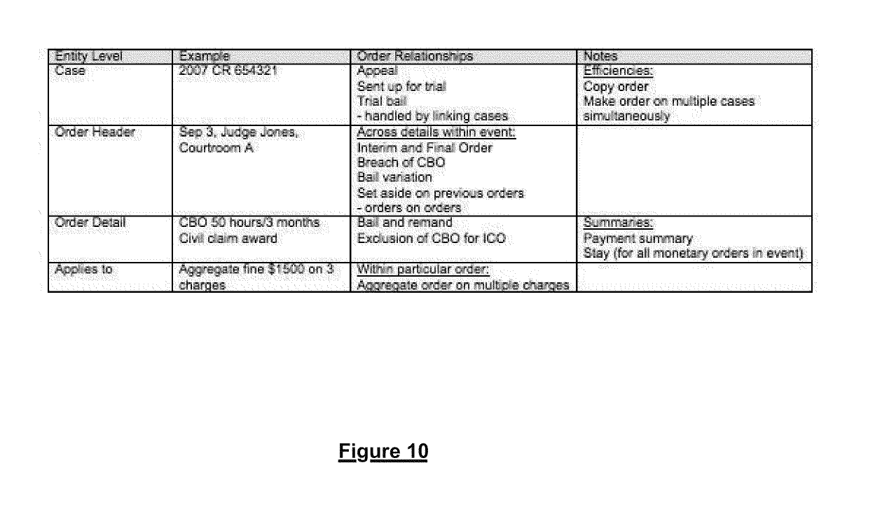

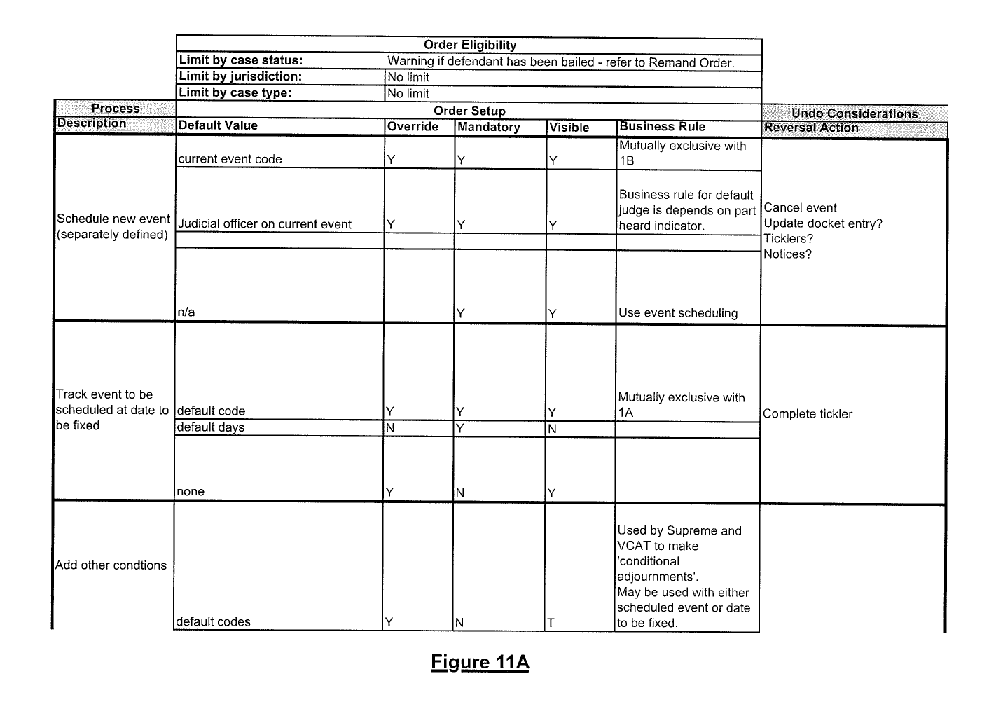

A table presented in FIG. 10 lists some of the kinds of relationships between orders at different levels of the model.

Some orders imply an update to a related order. Variation of bail and breaches are examples of this kind of order. In addition to creating a new order, the status of the previous order is changed. In some cases, the new order is populated from the previous order for efficiency so that the user can edit only what is changed. The new order may also be constrained by the previous order, for example the amount of a fine not paid would limit how much time could be ordered in an enforcement action.

Using one order to create one or more orders to save data entry is a matter of efficiency and usability but does not imply an enduring relationship between the orders. One type of efficiency is the application of the same order to multiple cases on the same event, say the same fine to each of multiple defendants charged with the same offence in a particular incident.

Another type of efficiency is the allowance of an existing order, even on another case, to be used as the starting point for a new order just to save the effort of repetitive date entry. If desired, an order can be saved as a template. When a new order is being made, the template can be selected from a list of saved templates for the same type of order.

In order to minimize the amount of processing to be done after the court proceeding and the re-entry of data, the order is actually embodied in the case management data structure 104. For example, when a fine is ordered, the amount due is stored in the docket entry against which payments are taken and which always shows the current status of the obligation. When an activity is ordered to be done by a certain time, such as filing documents, the date is stored as a milestone (tickler) which is turned off by docketing of the activity ordered and that can be used to produce reports of delinquent activities.

Embodying the order in the case management data structure 104 ensures the accuracy of the information used to manage the case. The current status is available for display upon inquiry on the order because of the linked data structures. User access and delegation user access to the judicial management module 132 is controlled by security based on the user profile. Confirmation of orders is strictly controlled based on the identity of the judicial officer who made the order. Judicial associates can be delegated corresponding security. For example, in a county court, a chief judge is given overarching security within a jurisdiction so as to be able to confirm on behalf of the judicial officer who made the order.

A judicial associate or registrar may be delegated to enter orders and have access through an appropriate security profile.

The available orders are limited by the context, including case type, jurisdiction, matter type and other considerations. Based on the type of order, the user is presented with fields to enter structured data, select pre-defined text and links to functions, such as event scheduling. Before an order can be accepted as complete, business rules are applied to check that all required entries have been made and that the orders cumulatively are within limits, if appropriate.

At any time during the order process, the user has access to reference data particularly for the charge. At the completion of order entry, the user can review a summary of the orders in this event, store the order as draft or confirm the order.

An order is linked to a particular case and consequently to the data structure for that case in the case management data structure 104. An order is also linked to an event and, therefore, to the date, time, location, event type and judicial officer or other user responsible for the order. The judicial officer who made the order is captured on the event and displayed on the order and on the summary case log entry for the order.

### Draft Orders

Since the order data is stored in the case management data structure 104, care is taken with an order in draft status. Draft information is not stored in the case management data structure 104 because it would be visible on the case to anyone with security to view the case, it would be picked up in automatic processing, it may trigger interfaces to other systems and it may be included in notice production. All the follow on actions are activated when data is stored in the case management data structure 104.

As proposed in the approach document, limited draft functionality is provided by storing the order data in a separate repository formatted using XML, which combines data and field labels in a text format. Draft order data is stored using a process that transfers all data entered in the screens into an XML structure that is stored in the database as a CLOB. The order data can subsequently be retrieved from the XML format into the order capture screens to resume work.

Data stored in XML format does not merge into final documents in the same way that data stored in the case management data structure 104 merges. The tokens in the documents look for the data in the case management data structure 104, not in XML.

If there is a pending order on a matter, the computer system 20 either prevents other orders using the same particular code under certain circumstances being made on the matter or, alternatively, warns the user that there is already an order pending confirmation. During the time that a draft order exists on the case, an indication that an order is in process is displayed.

In order to resume work on unconfirmed or draft orders, a user with appropriate security brings up the case in the judicial management module 132 and views a list of any unconfirmed orders on the case. By selecting one of the unconfirmed orders, the user can import the draft data from the XML structure into the screens and resume work on the order. Orders may be entered before, during or after a scheduled event.

If a draft order is deleted, the judicial orders computer system 20 deletes the order data structure and the corresponding XML data store. Once the order is confirmed, however, the process of reversing or voiding an order is more complex. Not only has the order information been stored in the case management data structure 104 but also have all the follow-on actions that occurred, possibly including interface triggers. The appropriate action depends on the current status of the action. Events cannot be cancelled after they have been occurred, for example.

### Representative Orders

An adjournment is a reasonably straightforward judicial order that is common to all jurisdictions. Adjournment begins with a choice of scheduling to a known date or to a date to be fixed later. In the first instance, event scheduling can be invoked and when the order is executed an event record is created that is visible on the calendar. In the second instance, a milestone is created as a reminder to schedule the event later unless a warrant has been issued.

The data to be entered in each instance are different. Event scheduling involves the event type, judicial officer, date, time and location some of which are entered and some returned by automatic scheduling. In addition, only certain matters from the current event can be adjourned to the new event. The creation of a reminder milestone for adjournment to a date to be fixed takes as input the type of reminder, the time to wait and possibly notes to the schedule coordinator.

### Constraints/Rules

After analysis of the actions that would take place when an order is executed, the discussion turned to considerations if the order had to be reversed. If an event has been scheduled, it can be cancelled unless it has already taken place. If a milestone has been set, it can be cancelled unless it has already been processed as completed or delinquent.

In addition to all the actions following upon the choice of scheduling a future event or setting a reminder milestone, there are several activities that will commonly occur when any order is executed. These standard activities include imposition of additional conditions and recording remarks that are not part of the official order language. Another standard action is to record the result of the current event, indicating whether the matter is part-heard, the reason for the event and event or case notes. The computer system 20 creates order data records with links to the case management data structure 104. The order is generally summarized in a docket entry with the current date. Usually, documents are produced and printed.

Two other sets of constraints analyzed for any order are those applied to determine whether the order is eligible for this case and those applied to determine whether the order can be accepted as complete. In the example of adjournment, the only eligibility rule is that if the defendant had been bailed, the user should be warned and referred to the remand order. The order can be accepted as complete if either an event or a milestone is ready to be created.

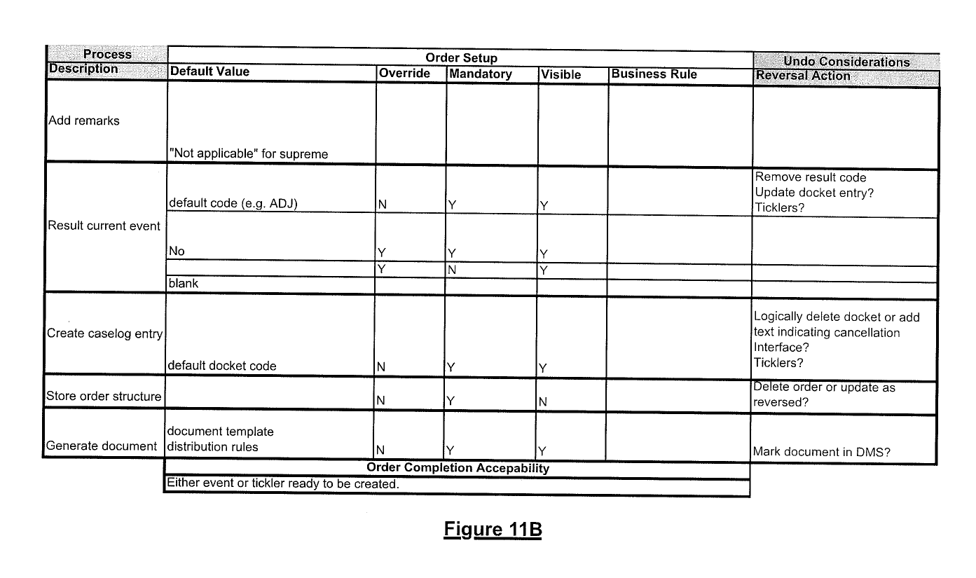

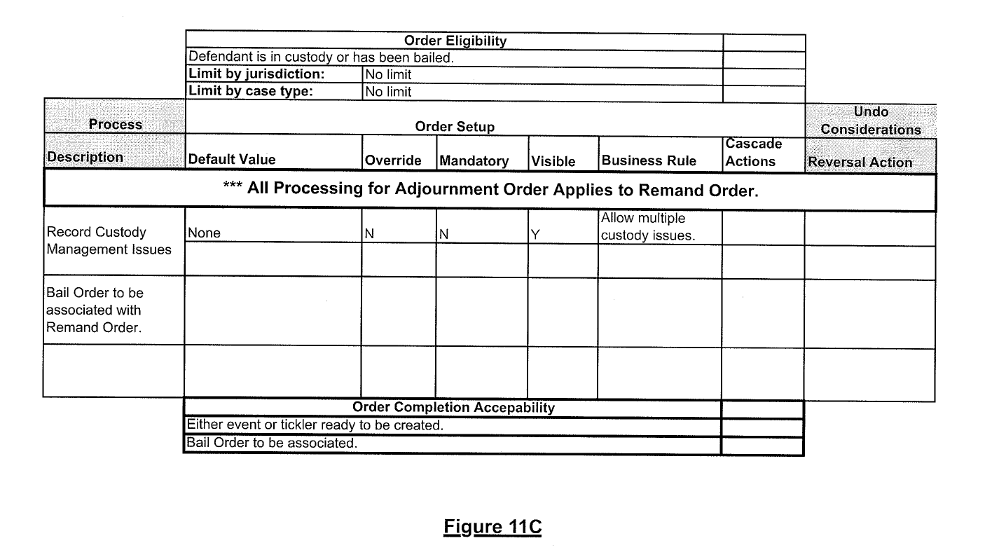

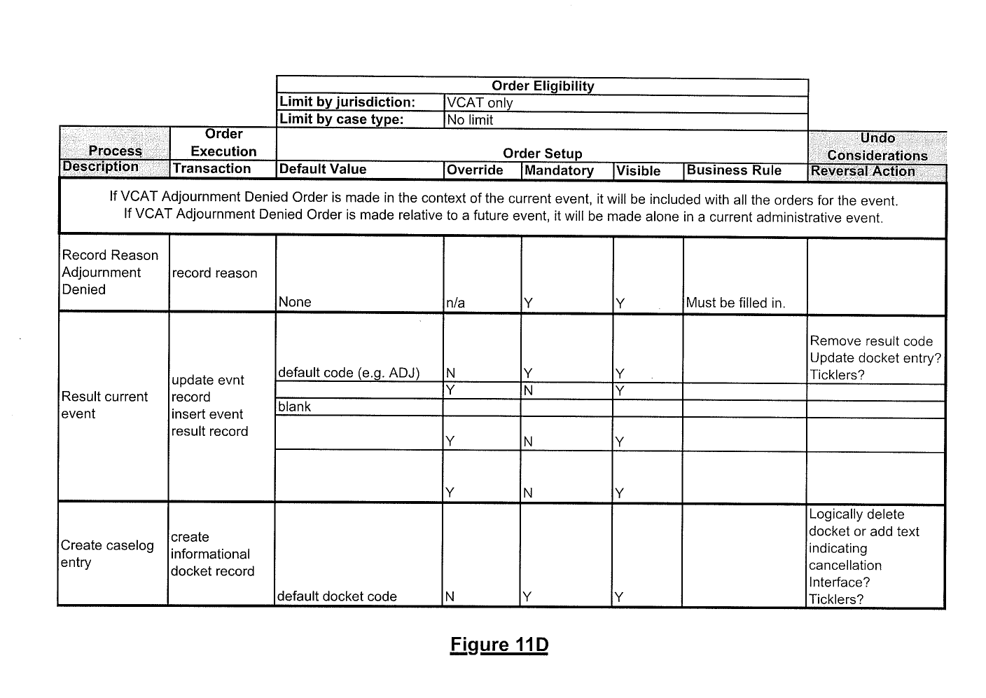

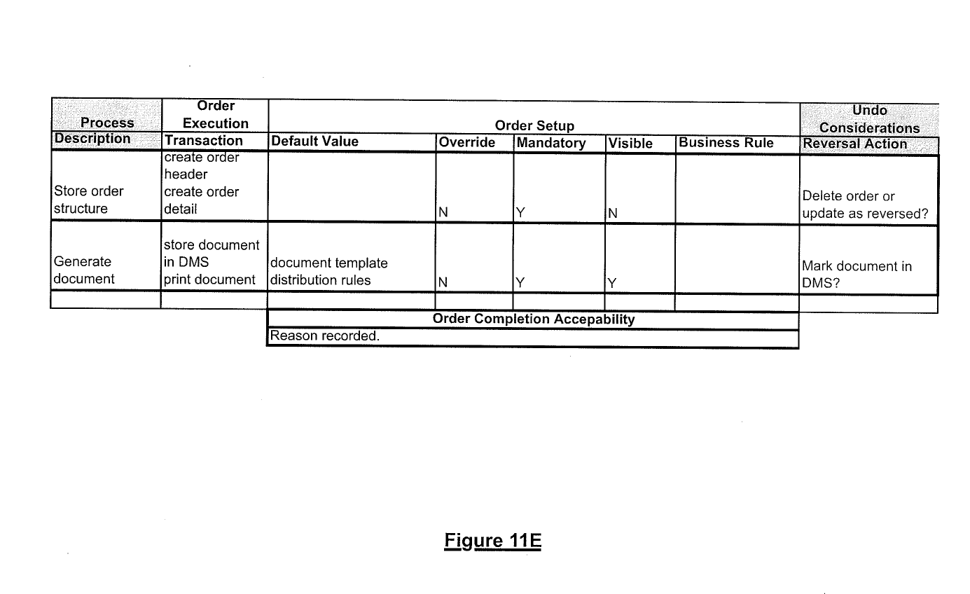

This analysis of the adjournment order is presented in the table shown in FIGS. 11A to 11C.

Similar rule sets apply to remand orders with the addition of custody management issues and an associated bail order. An order denying adjournment is limited to VCAT jurisdiction and uses many of the standard components with the particular component of recording the reason for the denial.

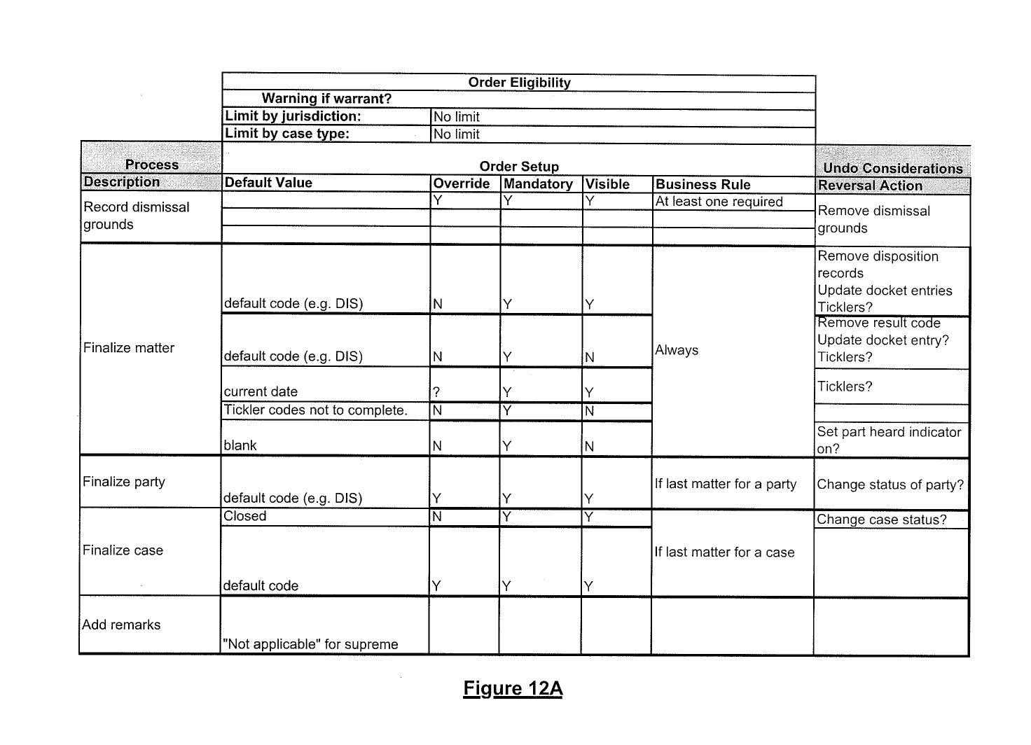

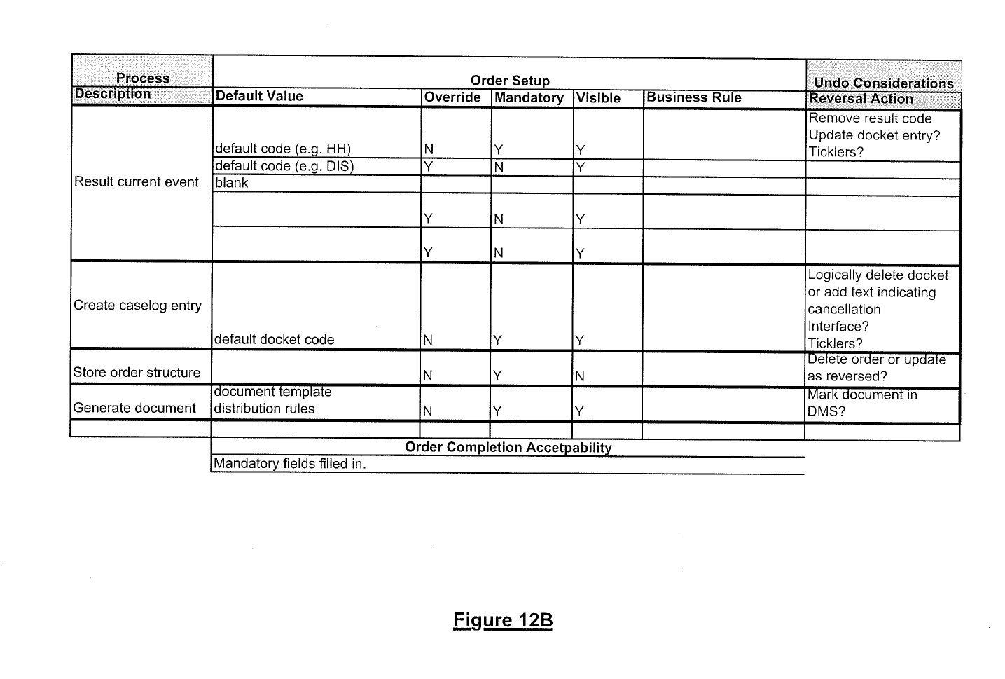

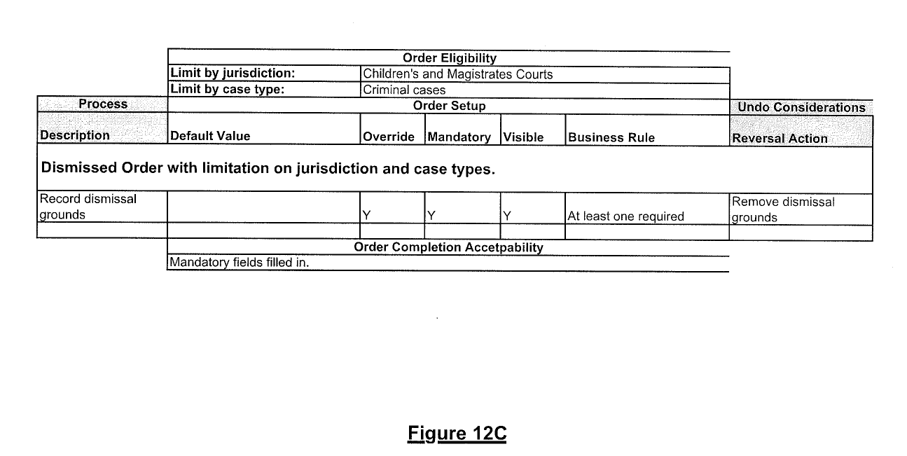

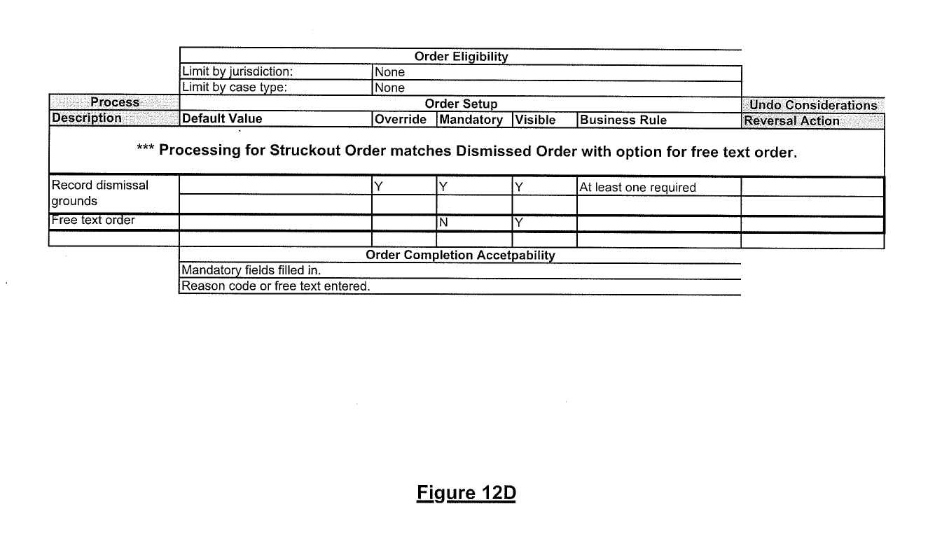

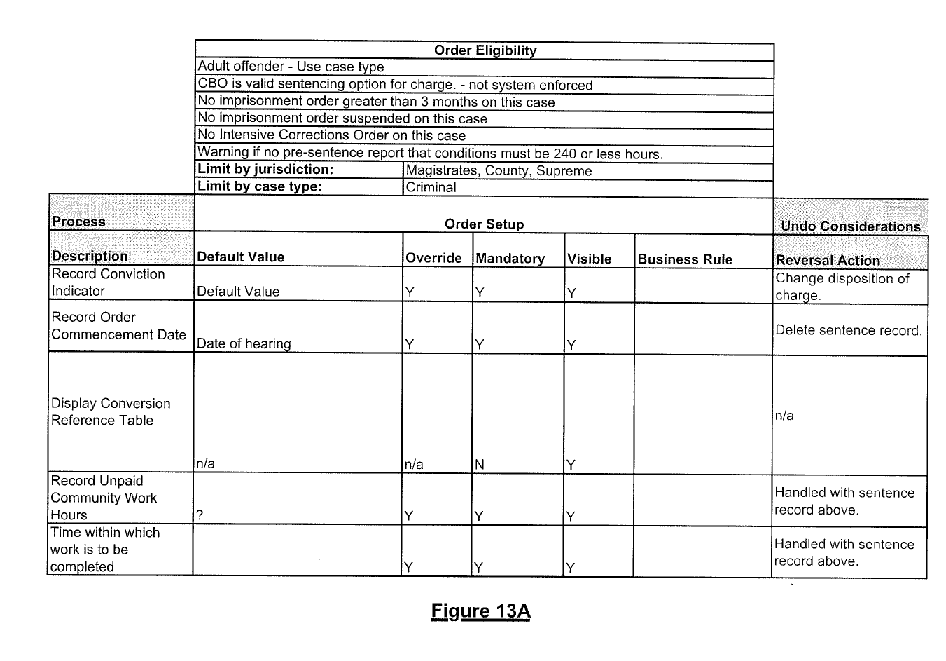

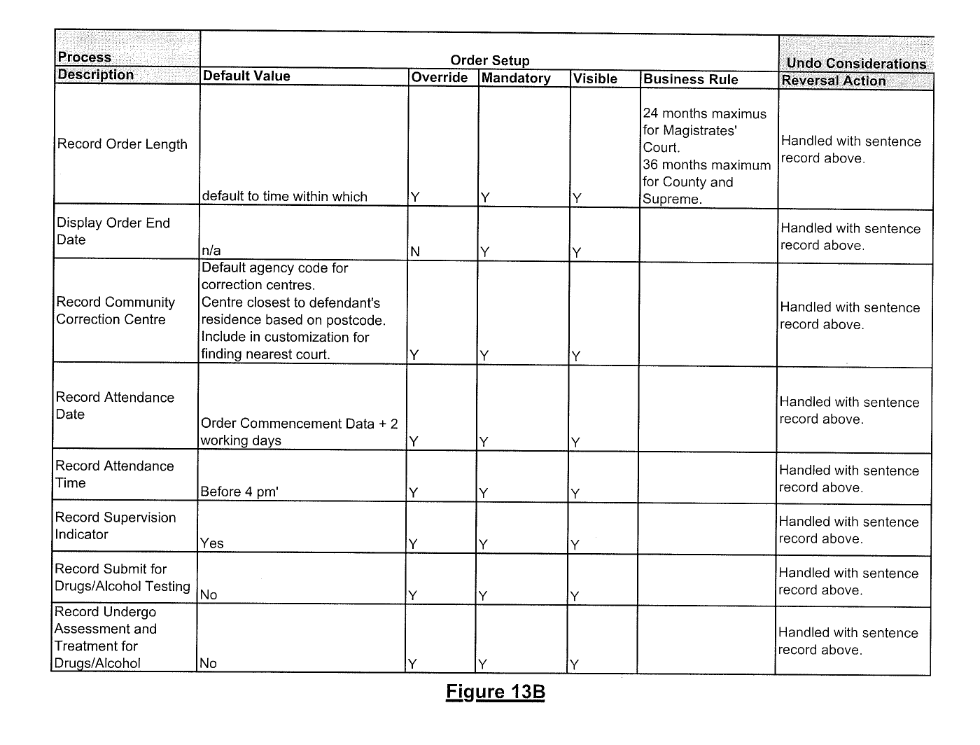

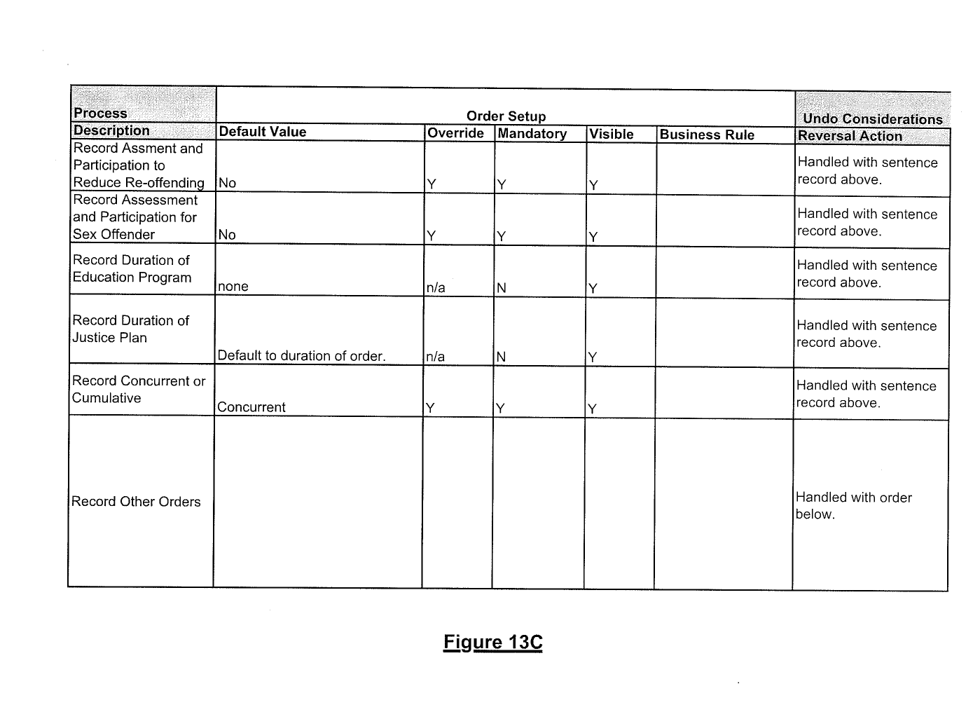

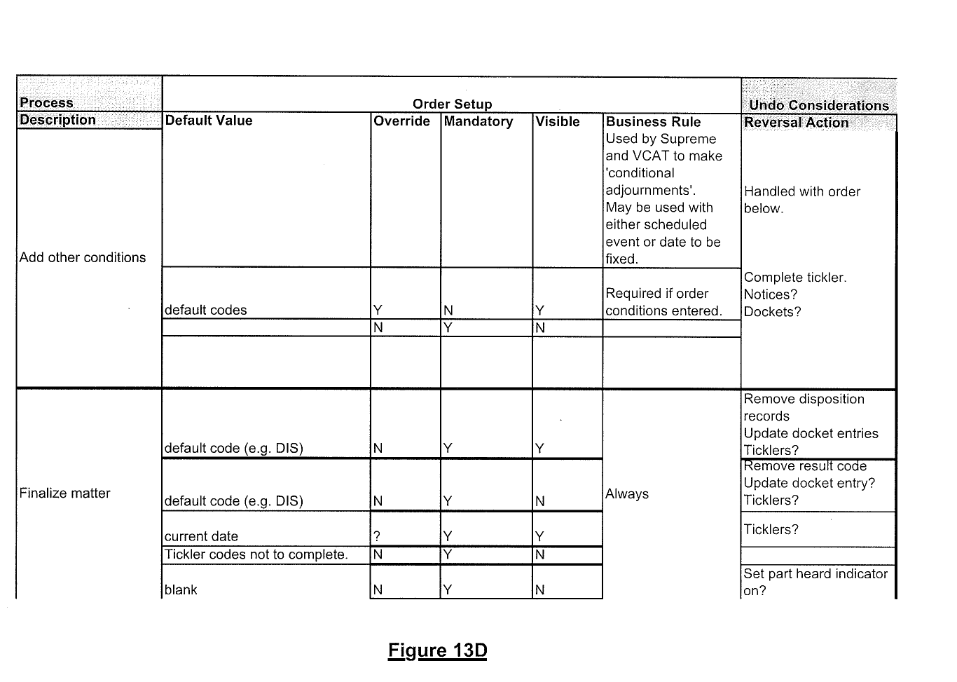

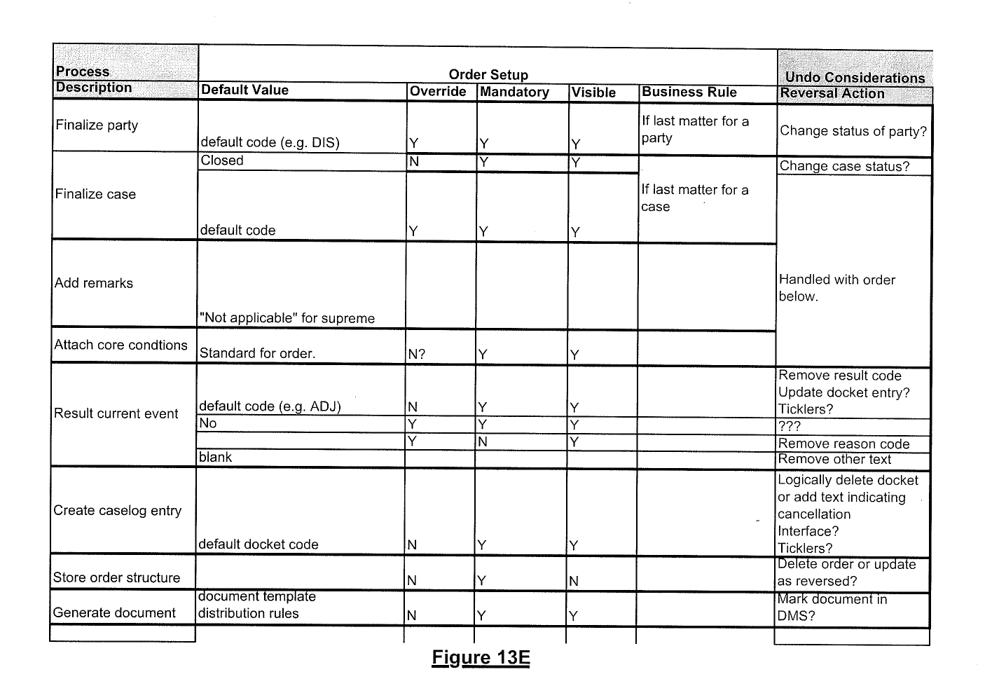

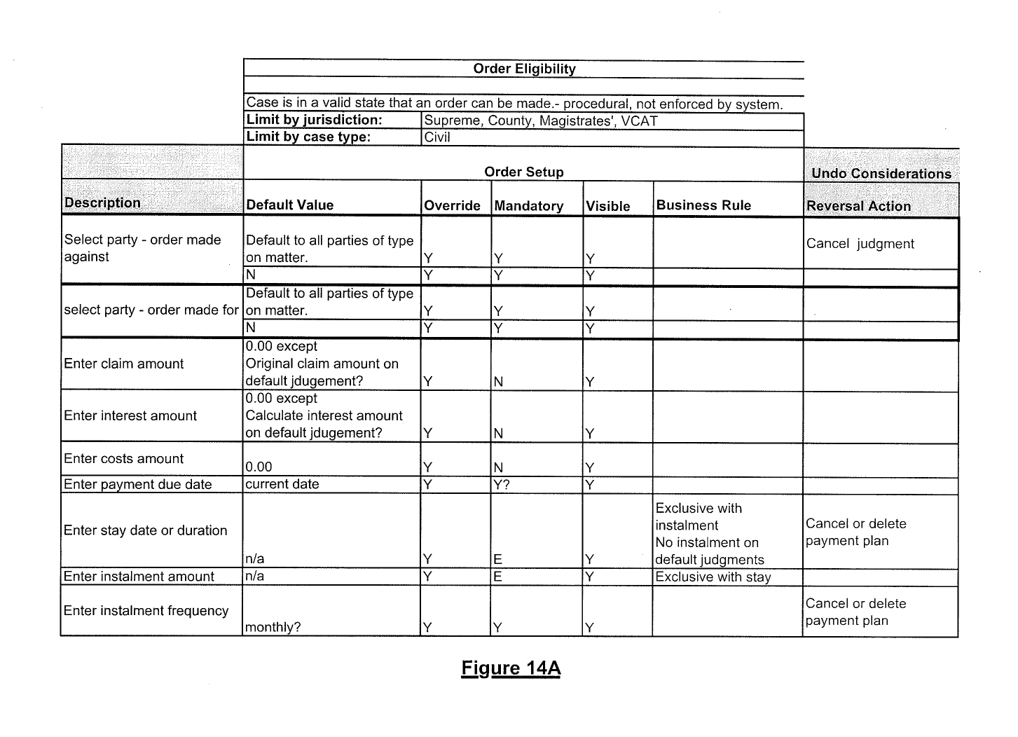

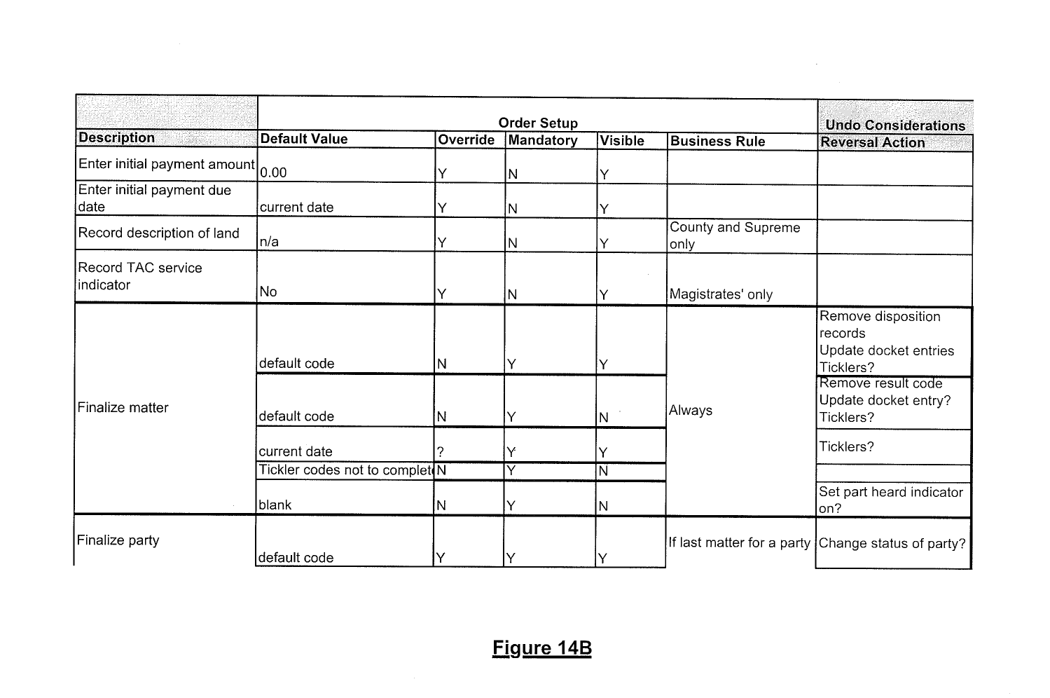

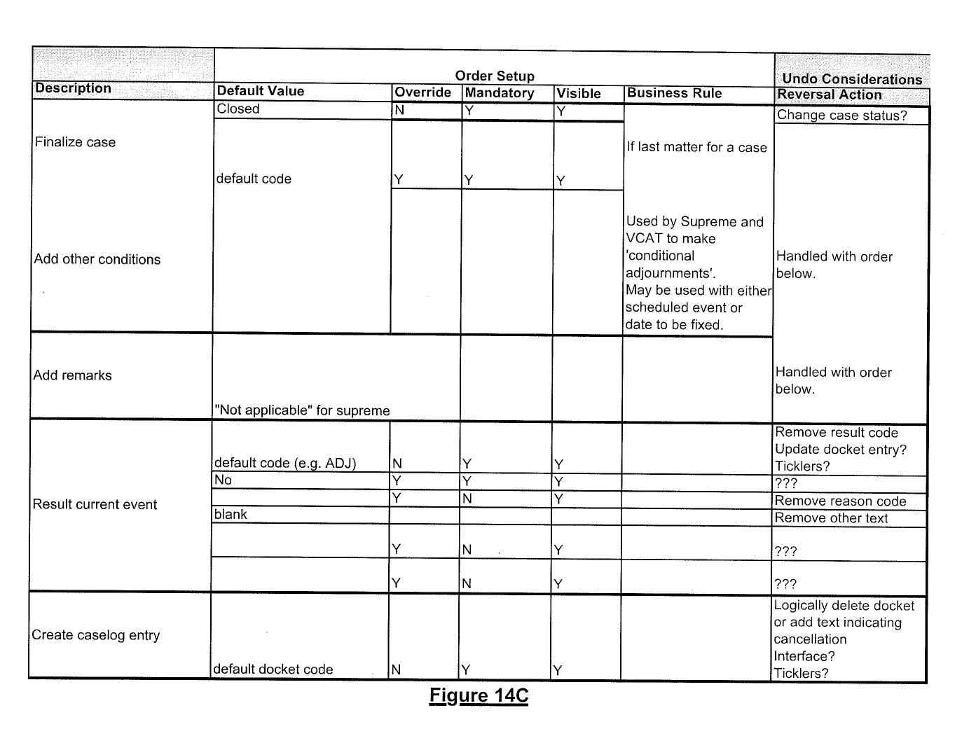

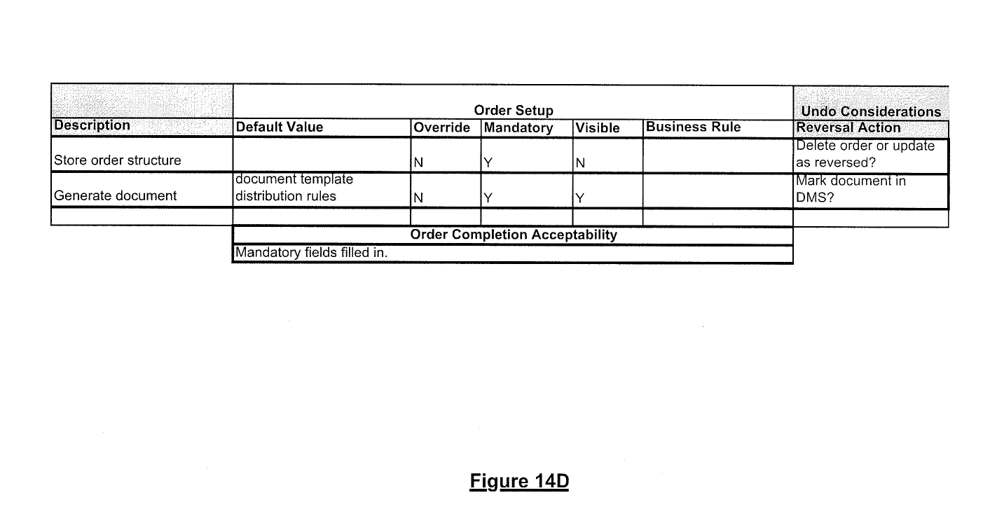

Other types of judicial orders include dismissal orders (dismissed, discharged, struck out), community based orders and civil claim orders. Rule sets for those judicial orders are presented in the tables shown in FIGS. 12A to 12C, 13A, 13B, 14A and 14B, respectively.

Abstracting from the particulars of each order, there are rules that constrain whether an order can be used in a situation, designated order eligibility rules, and rules that constrain whether an order can be accepted as complete, designated order completion rules and there are pieces of functionality that occur repeatedly in capturing and executing orders, designated order process components.

### Order Eligibility Rules

Eligibility rules are applied after a user has selected the cases, matters or parties associated with an event and indicated that an order is to be applied. The eligibility rules constrain which order templates are applicable in the situation. The rules are used either to validate an order code entered by the user or to prepare a list of order templates from which the user can make a selection. An example of a positive eligibility rule is that the order template is valid for the case type.

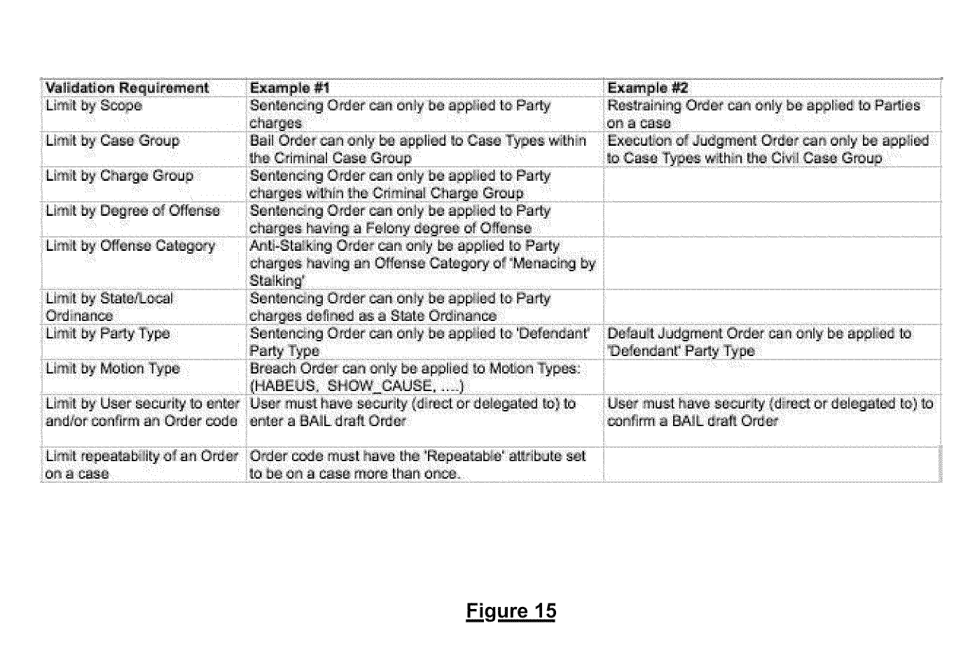

The eligibility rules established for representative orders are listed in the table shown in FIG. 15.

Functional specifications for eligibility rules include configuration of the rules for each order template, the logic to be executed for each rule and maintenance of the supporting reference data, such as valid combinations of orders and case types.

### Order Process Components

Order process components are the individual functions that constitute the capture and execution of an order. In the example of an adjournment order the components are as follows:

creating a reminder that an event is to be scheduled at a later time

recording other conditions to be met

creating reminders for the other conditions

entering remarks

recording the result of the current event

creating a summary case log (docket) entry

creating the order records

generating documents for the order

For each component, there are many attributes that are considered. There can be business rules, such as choosing one or another component but not both. Some are mandatory and some are optional. Some are driven by the user and some will be done automatically by the system depending on configuration. Some are not even visible to the user but enable the correct functioning of the system.

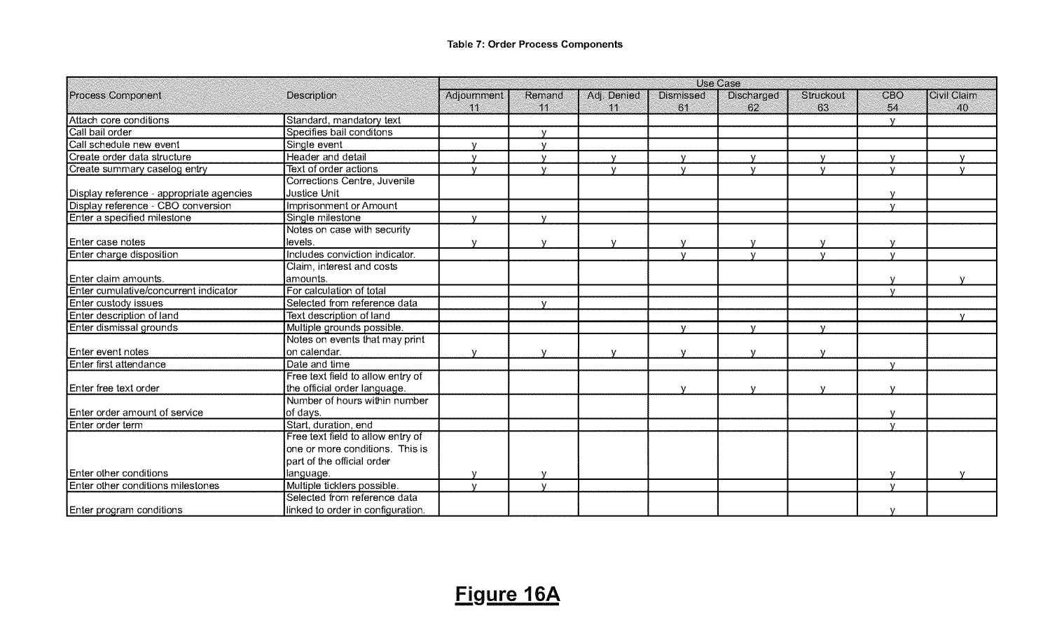

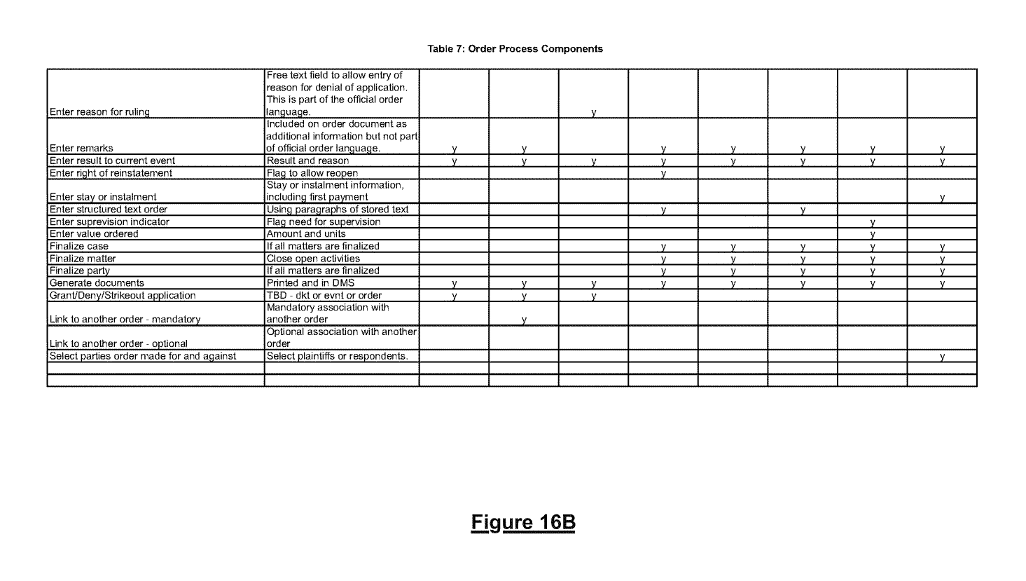

Dismissal order templates, community based order templates and civil claim order templates each have their own components. The order processing components identified during the analysis of representative orders are presented in the table shown in FIGS. 16A and 16B.

Some of the components depend on reference data. Program conditions, for example, are stored in a table with an indication of the data needed for each condition. For some programs, only a time of duration is required but some need a starting date and time, a location or other information.

Together with the eligibility and completion rules, these processing components are the building blocks of the orders model. Abstracting these components from all the individual order templates and carefully identifying exactly what they have to do defines the functionality that can be assembled to create an order template. New order templates are created administratively as long as they are composed of the same functional building blocks as the existing order templates.

Consistency and predictability result from identifying the same function across jurisdictions and using the same building block to implement it. For example, adding remarks that are not part of the official order language but are to be printed on the order documents is standard functionality that is available on any order template and acts the same way wherever it is used.

Functional specifications for order processing components includes configuration of the components for each order template, the logic to be executed for each component and maintenance of the supporting reference data, such as CBO conversion amounts or nearest corrections centre.

### Order Completion Rules

Completion rules are applied when a user indicates that order capture is finished. In addition to confirming that data has been entered in all mandatory fields, the completion rules will include checking that mandatory business rules have been met, such as having program conditions attached, and that prohibitory business rules have not been violated, such as incompatible combinations of order templates.

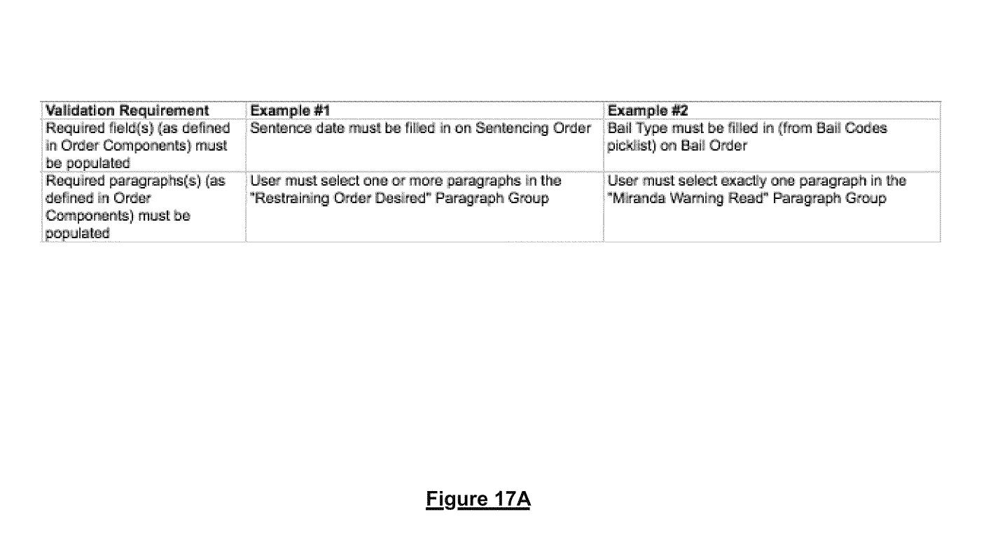

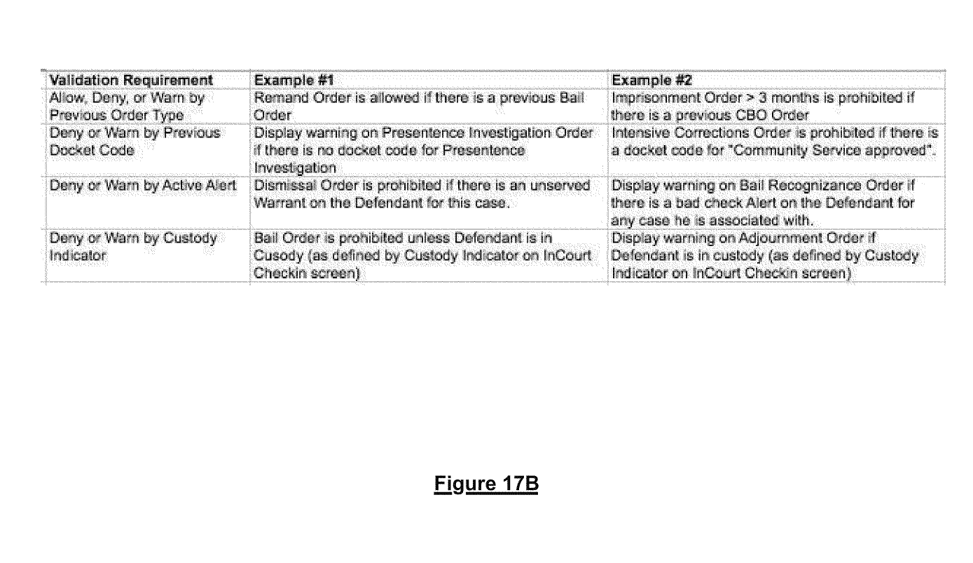

The completion rules for representative order templates are listed in a table shown in FIG. 17A.

Functional specifications for completion rules include configuration of the rules for each order template, the logic that is executed for each rule and maintenance of the supporting reference data, such as invalid combinations of order templates. As much as possible, eligibility and completion rules use the same functionality but the logic to be executed for each rule and the consequences of the rule being fired are different for eligibility and completion rules.

### Order Consistency Rules

Consistency rules are business rules for determining what criteria must be present on a case before a given particular code can be considered valid.

The consistency rules for representative order templates are listed in a table shown in FIG. 17B.

### Finalizing Orders

Finalizing orders are orders that dispose of a matter. They are of special interest in analyzing the process components because they have complex effects. If the matter is the last open matter for a party or for a case, then the party or case is effectively disposed as well. Not only may the status change but also various aspects of a case may be cancelled or closed as a result of the disposition. Future events or milestones may be closed, trackable items may be returned, money may be returned, bail records updated to discharged and so forth.

Administrative orders do not dispose of matters but direct the parties to perform some actions, such as filing documents or going to mediation, by a certain date. Administrative orders need particular attention in terms of their scope. They may apply to a whole case, to multiple matters, to parties or to a party in their role on one matter.

The judicial orders computer system 20 can generate various orders automatically. Two examples of automatic orders relate to enforcement activities and to default judgments.

After the court issues a warrant to the sheriff for enforcement (transferred through the interface), the sheriff may collect money from the defendant, sign the defendant up for community service or bring the defendant to court. If the sheriff signs the defendant up for community service, the court will be notified through the interface. In this instance, the computer system 20 will make a corresponding community-based order and mail the documents to the defendant. Enforcement orders can be generated daily or weekly.

In the event that an interstate address is received for the defendant, the system automatically creates an imprisonment-in-lieu order to be sent to the interstate warrant bureau.

In civil cases, the plaintiff may apply for default judgment if the respondent has not lodged a defense. These applications may be made through electronic filing (“e-filing”) in some jurisdictions and, in some jurisdictions, the computer system 20 generates the order automatically if the rules for allowing enough time for notification and service have been met. These may be handled by scheduling a daily administrative calendar block and having the system create administrative events and default judgment orders in the name of the principal registrar.

### Functional Overview

The judicial management module 132 allows for the convergence of clerk and judicial case management that reduces redundant data entry and helps maintain data integrity. Clerks and judicial case managers can manage a collection of scheduled events, efficiently update case records, generate dockets and forms, produce court orders, and schedule next events all from one point of entry. Activities of the court, whether a collection of actions on the case and/or a single order issued by a judge, can be captured, maintained over time, and finalized, without the need for re-entry of case information.

A scheduling coordinator, clerk, or judge can quickly prioritize cases, schedule additional staff, and check-in participants, attorneys and staff. Courtroom clerks and judges can quickly search for a session, filter cases, and review individual case details.

Once a case is selected, templates are used to present the clerk with the most likely outcome for the case or matters on the case such as common bail conditions or sentencing outcomes for a particular charge. Flexible structuring allows for simple or highly complex templates depending on the needs and business process of the court.

For example, a template can be used to result an event or create a tickler. A template can also be used to result an event, sentence charges, create conditions, assess monetary penalties, generate informational dockets and produce and generate a court order all at once. Populated data entry fields not only update the case but also can insert blocks of pre-defined text into docket entries and forms that can be flagged for editing. Automatic validation each time data is saved enforces user-defined business rules.

Depending on the work breakdown structure, clerk and judicial staff can manage different elements of the same case independently because the details can be saved in a draft status and edited until final confirmation of the matter(s). That is, a courtroom clerk could enter details and save the details in draft for future edits, additions and approval from a judge and/or supervisory clerk staff after the conclusion of the event. Alternatively, clerk staff or judicial assistants can prepare the details for courtroom clerks and judges for confirmation at the conclusion of the event.

While the case processing via the judicial management module 132 is generally fast, consolidated case updates and automatic form generation, the judicial management module 132 can also be used outside a normal day in court, such as processing in chambers or for sudden add-on events, e.g. a last minute motion or Injunction for Protection. Since the InCourt case activities are associated to an event, an administrative event can be created on the fly to accommodate various scheduled and unscheduled court activities. The robustness of the judicial management module 132 allows the functionality to be used in a variety of ways to suit the many needs of today's judicial system.

Case activities are associated to an event and events are scheduled into sessions or session blocks using the judicial management module 132.

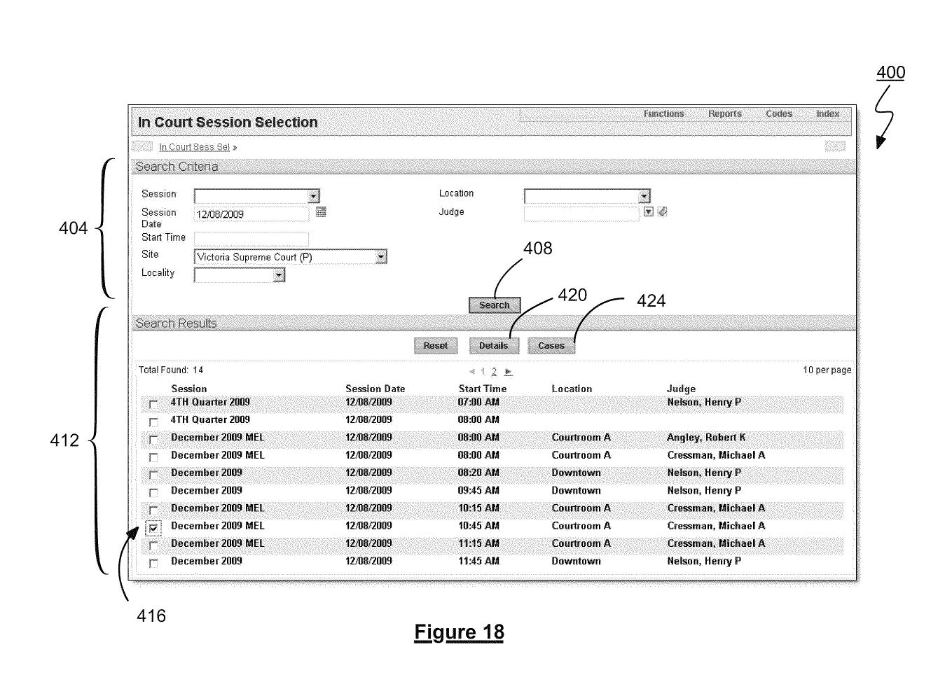

FIG. 18 shows a session selection screen 400 of the judicial management module 132 that enables court staff to manage cases by session and can prepare cases prior to scheduled court dates. The session selection screen 400 includes a search criteria section 404 that allows the user to specify session block descriptions, dates, start times, sites, localities, courtroom locations, or judges to locate corresponding sessions. Upon activation of a search button 408, a list of matching sessions is presented in a search results section 412. The user can select a session by checking an appropriate session selection checkbox 416 beside the session. From the session selection screen 400, the user can select the session in which they wish to work and may indicate staff members present at the session. The user can add court staff to a session event by clicking the “Details” button 420 below.

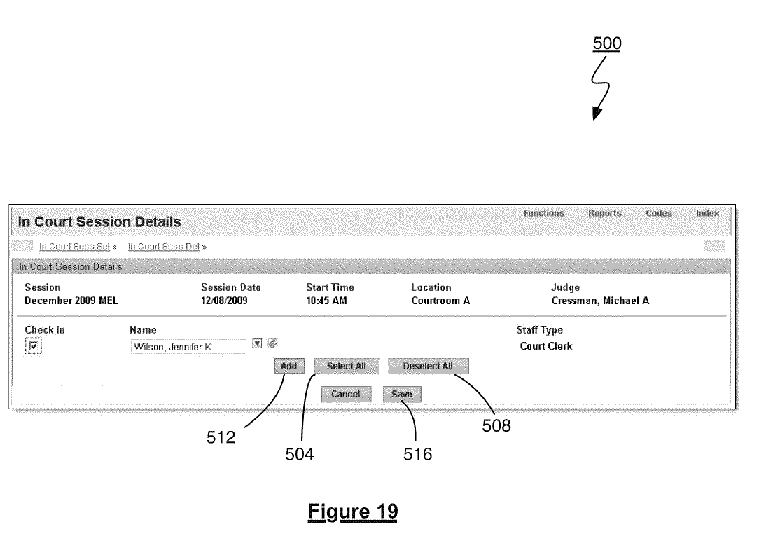

FIG. 19 shows a session details screen 500 that is presented to a user upon activation of the “Details” button 420 that enables checking in of court staff during a session. Staff can be added in advance and checked in as they arrive. Staff may be checked individually or checked and unchecked as a group via a “Select All” button 504 and a “Deselect All” button 508 respectively. An “Add” button 512 allows a new staff record to be added to the session. A save button 516 stores the checked-in records and returns to the session selection screen 400.

Returning again to FIG. 18, selection of a “Cases” button 424 enables a user to view the cases related to the session selected via the session selection checkbox 416.

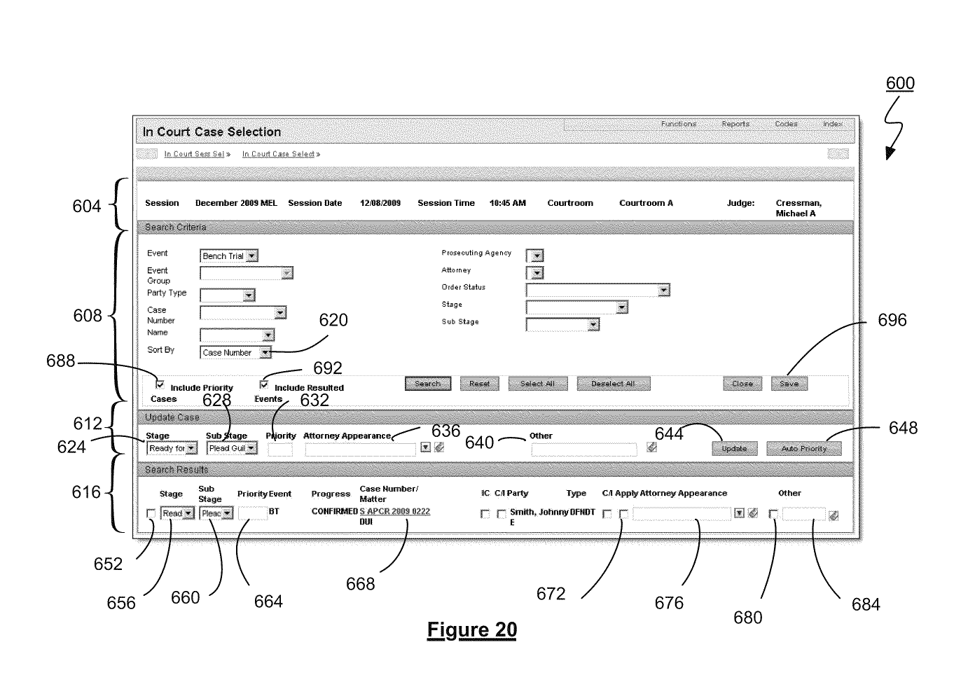

FIG. 20 shows a case selection screen 600 of the judicial management module 132 that is presented to a user upon activating the “Cases” button 424. The case selection screen 600 allows a user to search for cases to be heard, prioritize the cases, stage the case work flow, check in parties attending the event, and record the attorneys appearing on behalf of a party. The user can search for a case within a session based on the event type, case data, and/or party data associated to the session block. Resulted events (i.e., events that are no longer active) can be included or excluded from the search. The user can record appearances of attorneys/solicitors during the event and check in parties attending the event. An information section 604 presents information about the session; namely, the name, date, time, location and judge. A search criteria section 608 permits specification of search criteria to filter sessions by. An update case section 612 enables updating of the case parties and/or attorneys with the data items contained in this section. The returned sessions are presented in a search results section 616.

The search criteria section 608 includes a number of combo boxes, enabling a user to specify criteria for locating cases. A “Sort by” combo box 620 enables sorting of the search results in a manner desired by the user. The update case section 612 includes a stage combo box 624, a sub stage combo box 628, a priority field 632, an attorney appearances combo box 636, an other field 640, an “Update” button 644 and an “Auto Priority” button 648.

A checkbox 652 in the search results section 616 enables selection of a case. Management of the event can be achieved by applying the stage via a stage combo box 656, the sub stage via a sub stage combo box 660, and priority via a priority event field 664 to cases while in court, such as during a pre-trial check in where cases could be staged based on those entering a plea, those ready for trial, and any requesting a continuance. This allows for a smooth workflow between the clerk, judicial officer, or other court staff and the flow of cases before, during and after the courtroom event.

The user can view case information by activating a case number hyperlink 668 shown in the search results section of the case selection screen 600. An apply checkbox 672 allows the attorney to be applied to that party for cases in the search results section 616 from an attorney appearance combo box 676. A checkbox 680 enables an other field 684 to be populated with the contents of the other field 640 from the update case section 612 for the selected party.

FIG. 21 shows an anchor screen 700 that presents case summary information, matters associated to the event, and an order summary. The anchor screen 700 was created to display the case summary information at the top of the screen to anchor the user to the case. The anchor screen 700 has several sections displaying information related to the case, all of which are shown in a collapsed state, hiding the information contained in each section.

An event notes section 704 of the anchor screen 700 relates to event notes, and a case notes section 708 relates to case notes. These sections 704, 708 allow the user to quickly review any notes posted for the event and/or case. A parties section 712 relates to the parties associated with the event. A party charges section 716 is presented for criminal cases, and is replaced by a claims section for civil cases. A maintain orders section 720 summarizes the orders entered for the event, and allows access to the order details as well. A motions section 724 shows motions for the event and visually presents an indicator of the number of motions when in a collapsed state. A case orders section 728 shows case orders on the event and visually presents an indicator of the number of case orders when in a collapsed state. A linked events section 732 pertains to the existing event(s) that the user may include in an order and allows a user to link and schedule future or subsequent events. The linked events section 732 visually presents an indicator of the number of linked events when in a collapsed state. An event timing section 736 also pertains to the event that the user is editing and allows a user to record event timing information for the currently-edited event. The event timing section 736 allows the user to enter the actual duration of the event, and visually provides an indicator of the number of timing events when in a collapsed state.

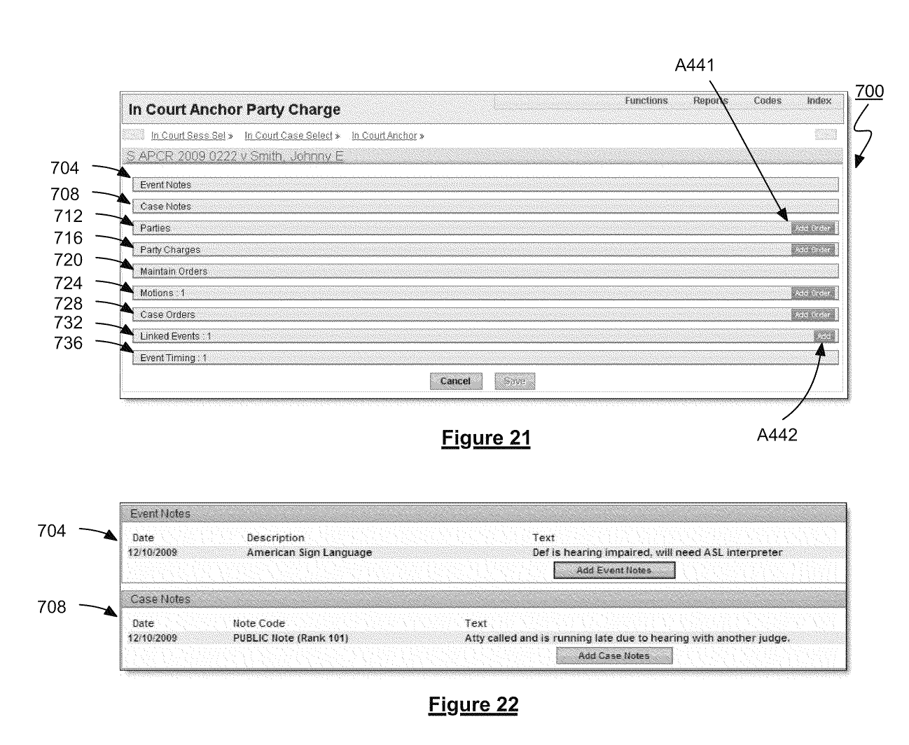

FIG. 22 shows the event notes section 704 and the case notes section 708 after expansion.

FIG. 23 shows the parties section 712 after expansion. Once expanded, the parties section 712 presents all parties associated with the event. The user may record attorney appearance and “Other” information, and enter orders on parties via this section. The parties section 712 includes an orders combo box 740 and a checkbox 744 next to the party.

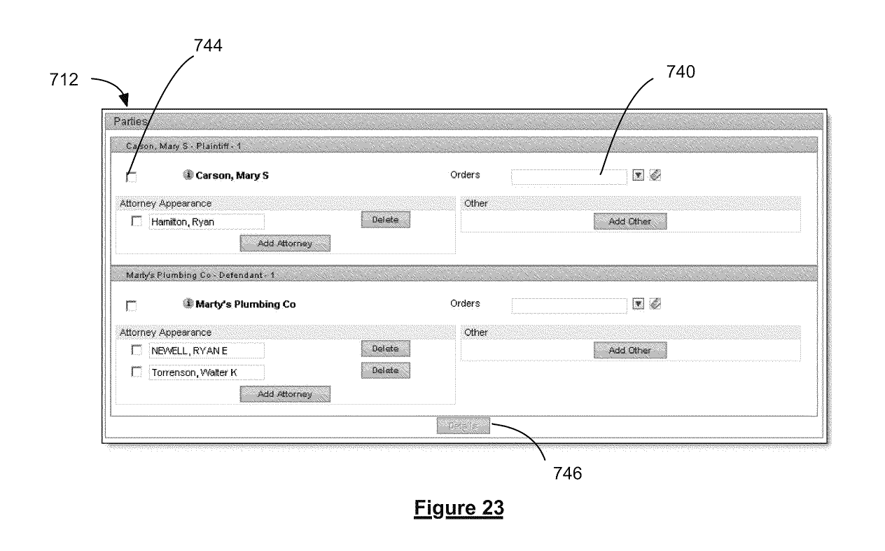

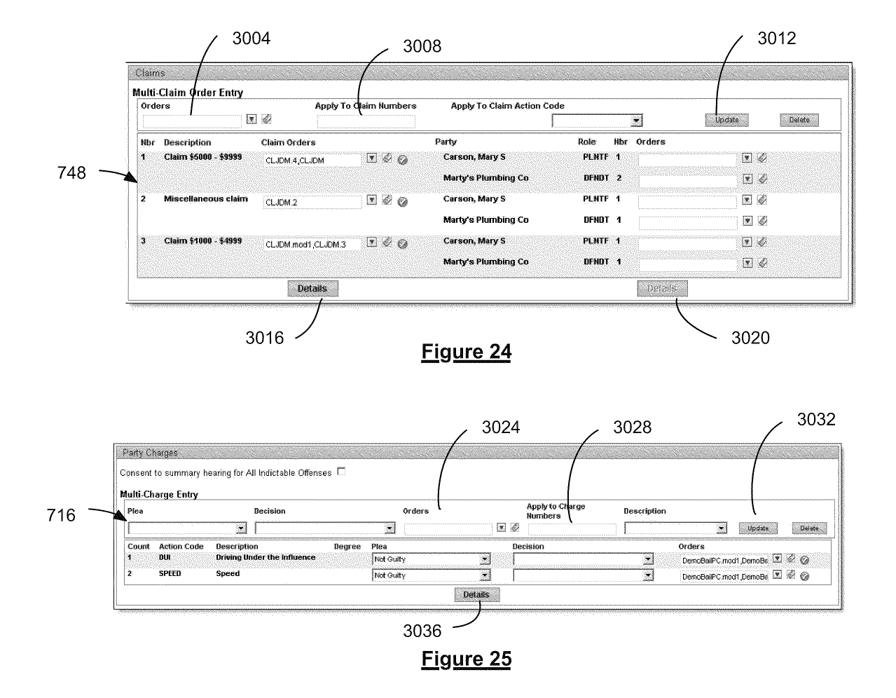

FIG. 24 shows a claims section 748 that is presented on the anchor screen 700 after expansion. The claims section 748 replaces the party charges section 716 for civil cases. Otherwise, the anchor screen 700 includes the same sections.

FIG. 25 shows the party charges section 716 for a criminal case after expansion.

Orders can be added to an event in either of the parties section 712, the party charges section 716, the claims section 748, the party charges section 716, the motions section 724, or the case orders section 728.

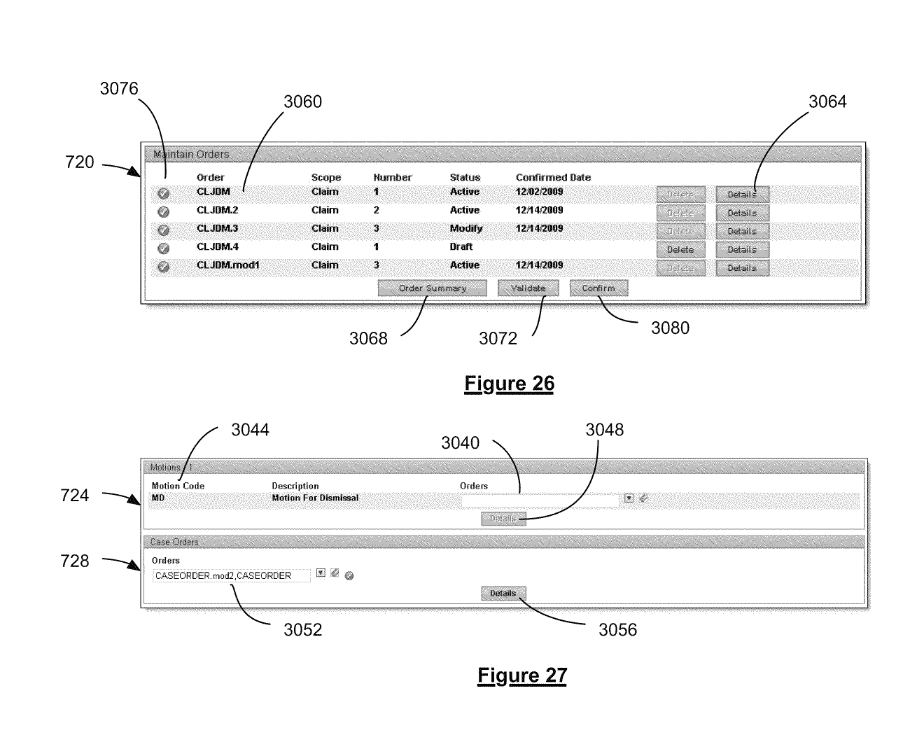

FIG. 26 shows the maintain orders section 720 after expansion. The maintain orders section 720 summarizes the orders entered in the various sections of the anchor screen 700. The user is presented with a list of all the orders that exist on the event, indicating the scope of each order, the status, and confirmation date. This section 720 links to an order details screen and an order summary screen, and enables deletion, validation, and/or confirmation of the draft orders for the event.

FIG. 27 shows the motions section 724 and the case orders section 728 after expansion. Orders can also be entered for motions at a case level.

FIG. 28 shows the linked events section 732 and the event timing section 736 after expansion. The bottom section 736 of the anchor screen 700 is directed to the event on which the user is working. These sections 732, 736 allow the user to link and schedule future or subsequent events and to record event timing information for the current event. The event timing section 736 also allows the user to enter the actual duration of the event. Order codes can be entered for each matter, party, motion, or on the case.

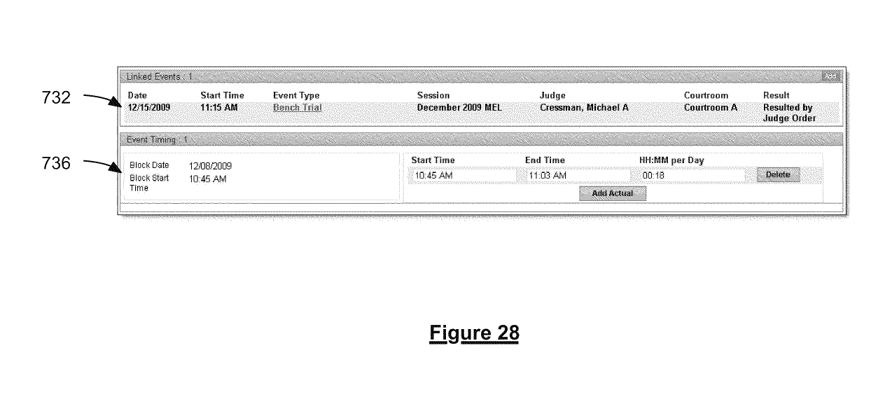

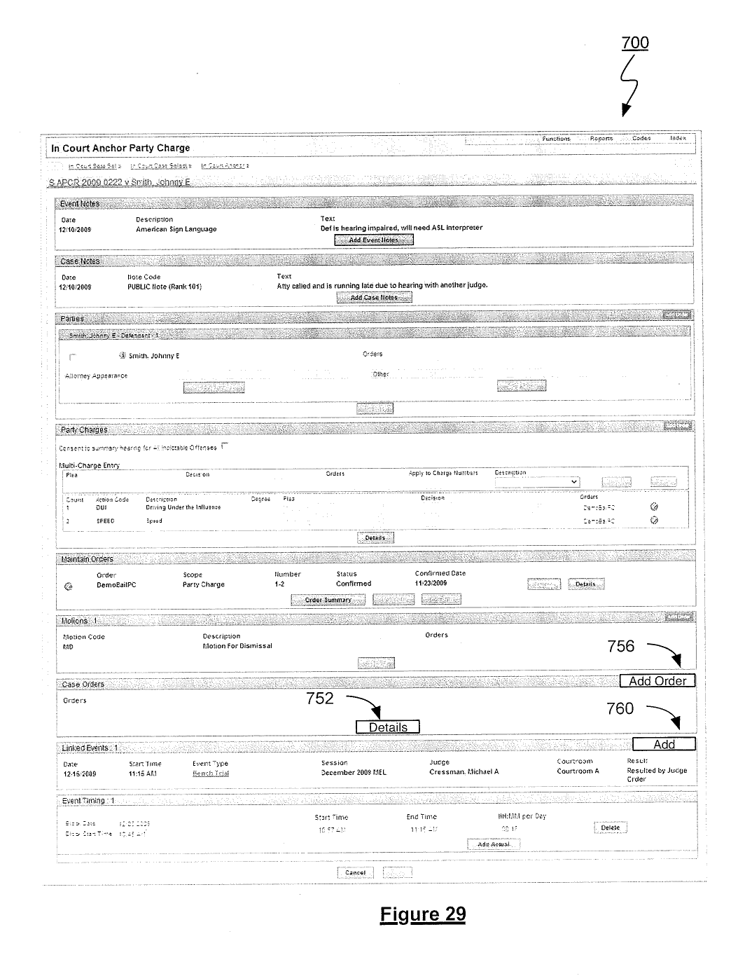

FIG. 29 shows the anchor screen 700 with all of the sections expanded. Once orders are confirmed, the anchor screen 700 is locked down and displays in a read-only mode. All buttons become disabled except “Details” buttons such as “Details” button 752, “Add Order” buttons such as “Add Order” button 756 and “Edit” buttons such as “Edit” button 760. User security controls the editing of the event and/or any modification of orders after confirmation.

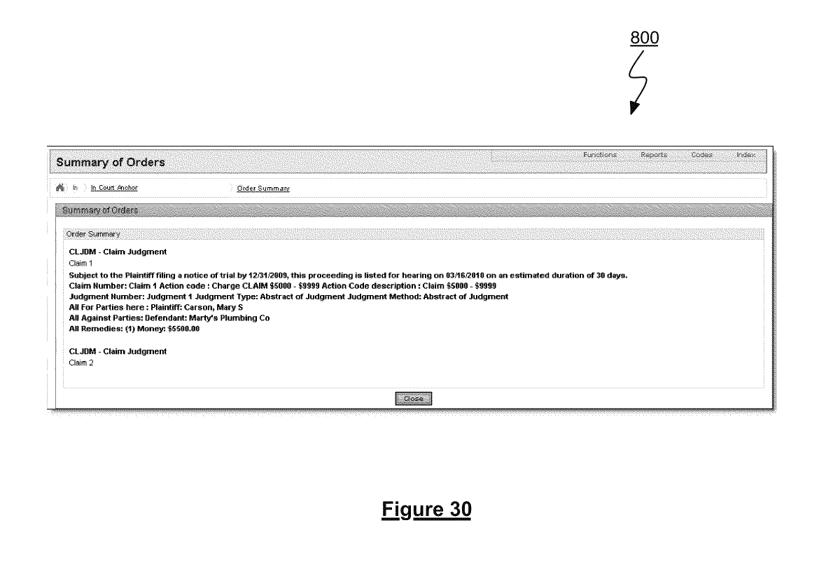

FIG. 30 shows an order summary screen 800 that includes a text representation of the order, the scope of matters the order covers, and totals for applicable fines, costs, or sentencing information. This allows the user to view in summary form all orders added on the event, as well as those orders configured to display text generated upon confirmation of the order.

The judicial management module 132 includes a particular order details screen accessed from the anchor screen 700 that serves as a maintenance screen for pending/draft orders and displays the setup defined for each order.

Components are configured on the particular order code setup screen, and display on the particular order details screen. Components are pre-defined sets of controls for interacting with the case management module 108, the orders module 112 and the event scheduling screen. By defining and testing a set of components for use with various screens, users with the appropriate privileges can build order templates and screens quickly using pre-tested components.

The order template in which components are viewed on the particular order details screen is configured as part of the setup of the particular order code. A user with the appropriate privileges can define from the particular code maintenance screen: whether the component is mandatory, which requires the component to be completed before the order can be confirmed; whether the component “Auto” executes without user interaction; separate display (Disp), validation (Valid), and execution (Exec) sequences, which control how the component is viewed, validated, and executed on the particular order details screen; and the prompt text the user is presented at the top of the component's section on the particular order details screen.

FIG. 31 shows an example of a particular order details screen 900 with a set of components. Specifically, the particular order details screen 900 displays a claim judgment component 904, a paragraph selector component 908, and a free text component 912. The components are displayed in the order template configured on the setup for the particular order code shown.

A top section 916 of the particular order details screen 900 displays as indicated in the image below, with the components displaying beneath this top section 916 in the order template defined on the particular order code setup.

Order templates as shown via the particular order details screen 900 are embodied in configuration files that reference the appropriate components.

FIG. 32 shows an alternative top section 916a of the particular order details screen 900, which indicates that the particular order details screen 900 is in a “draft” state. when the particular order details screen 900 is in a “draft state”, the order is open for editing and has not been confirmed.

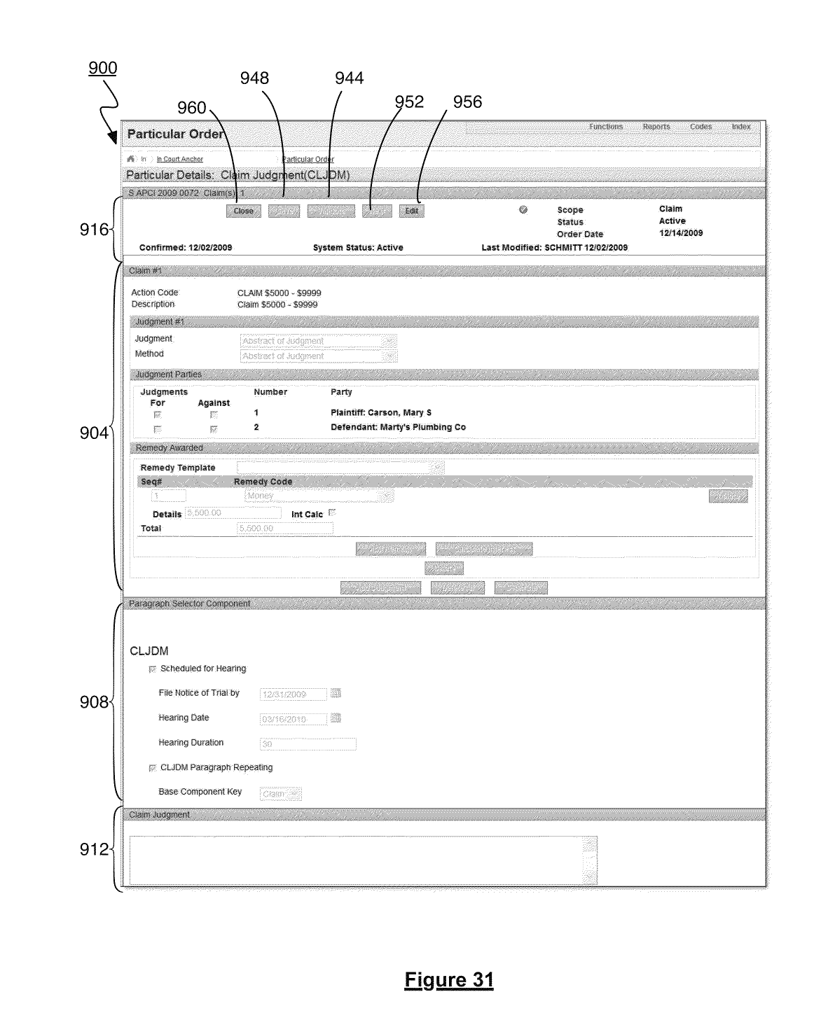

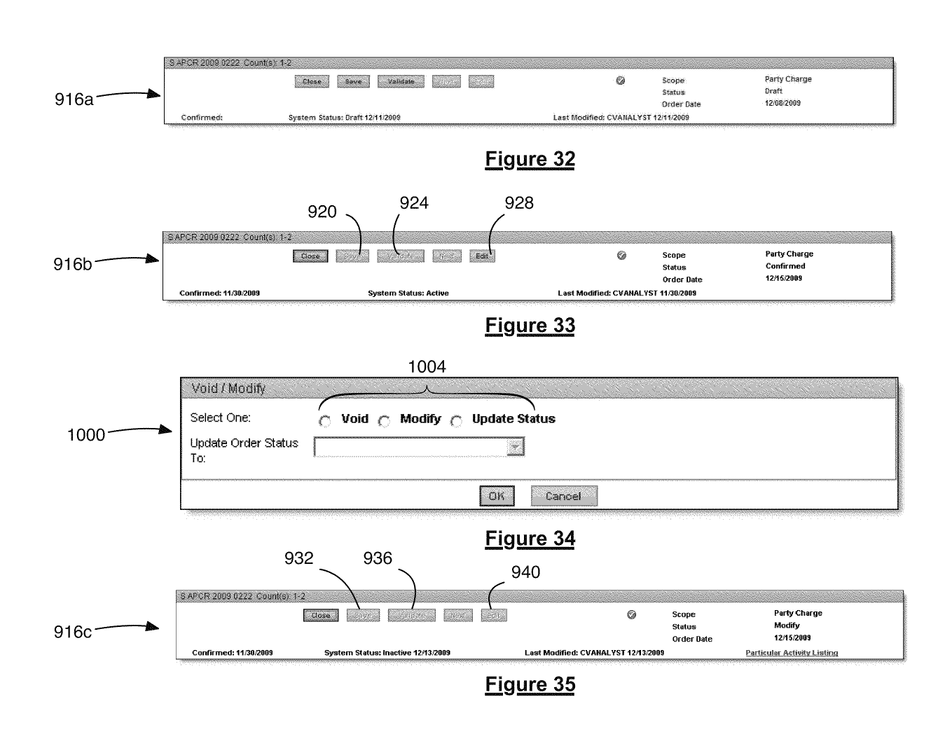

FIG. 33 shows another alternative top section 916b of the particular order details screen 900 after confirmation of the order. After the order is confirmed, additional changes cannot be made to the order. As can been seen, a “Save” button 920 and a “Validate” button 924 are disabled. A user with appropriate view privileges may view the particular order details screen 900 in a read-only mode. A user with the appropriate security privileges may maintain (void or modify) an order by selecting an “Edit” button 928 in the top section 916B of the particular order details screen 900.

FIG. 34 shows a pop-up box 1000 that is presented to a user upon activating the “Edit” button 928. The user is presented with the following modification options via a radio button control 1004: (a) void the order, (b) modify the order, and (c) update the status of the order. Selecting to void the order via the radio button control 1004 deletes the order; this is referred to as “void to delete”. In this case, the order is not removed, but is simply marked as inactive with a corresponding “void to delete” status. Selecting to modify the order will make a copy of the existing order as a starting point. The original order is marked as inactive with a corresponding “void to modify” status. The newly-copied order is added to the case in draft status. The user may make any modification necessary to the new draft order. Selecting to update the status of the order updates legal actions on the order and does not require the event or order to be reconfirmed to save a status change.

FIG. 35 shows another alternative top section 916C after an order has been modified by either a “void to delete” or modification process and that modification is confirmed, the original order has reached the end of the life cycle for that version of the order; no additional modifications or changes can be made. As can been seen, a “Save” button 932, a “Validate” button 936 and an “Edit” button 940 are disabled once an order has reached the end of its life cycle.

FIG. 36 shows an activity listing box 1100 that is presented to a user once an order has been modified. The activity listing box 1100 provides the user with a list of all the transactions that occurred when the order was originally confirmed. This provides an audit trail for the user and allows the user to take any necessary case management actions to maintain the case records.

FIG. 37 shows a particular index screen 1200 that displays the history for an order and provides the user with the ability to search for orders across sessions, case types, and date ranges. The user may view or, with appropriate security, maintain (i.e. void or modify) orders. Hyperlinks in the search results section will take the user to the anchor screen 700 for that order. A user, with appropriate security, may maintain (void or modify) the order by selecting an edit button within the order details screen. The maintaining of orders is completed through the anchor screen 700.

The particular index screen 1200 provides an audit trail of orders entered on cases. Orders that have been modified will be displayed as well. Only users with appropriate security can view and/or modify orders. No further updates can be made to an order whose status is confirmed as voided or modified.

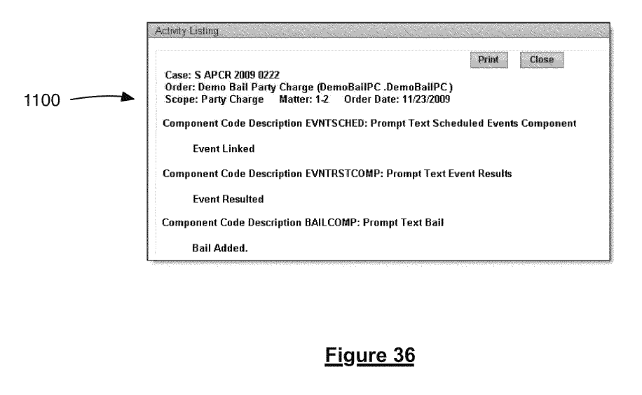

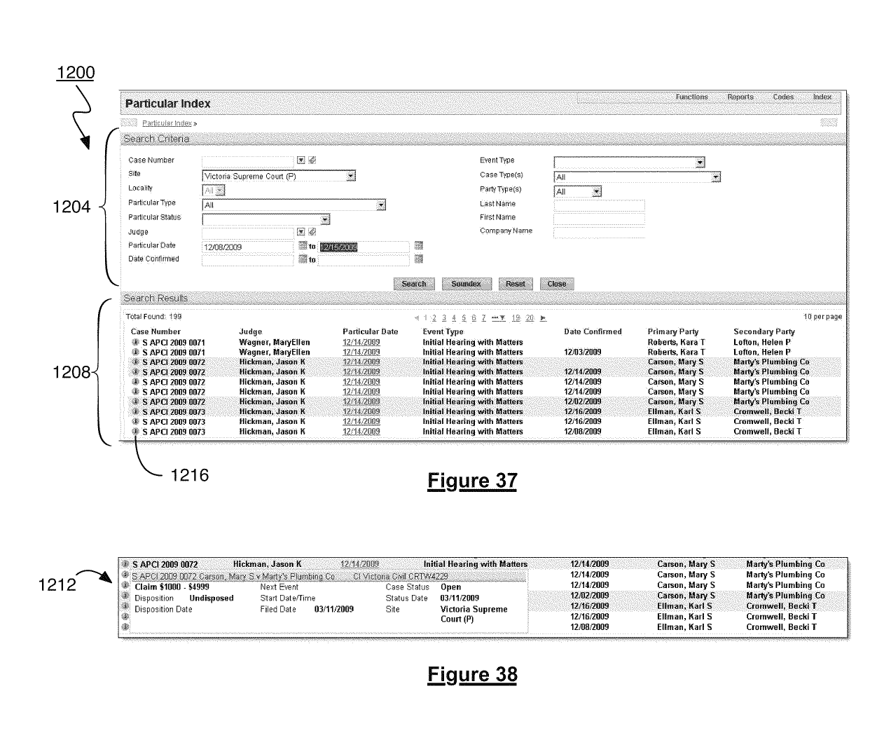

FIG. 38 shows a pop-up 1212 that is displayed when the user hovers over an information icon 1208 of the particular index screen 1200 to view additional case related information without the need to navigate to another screen.

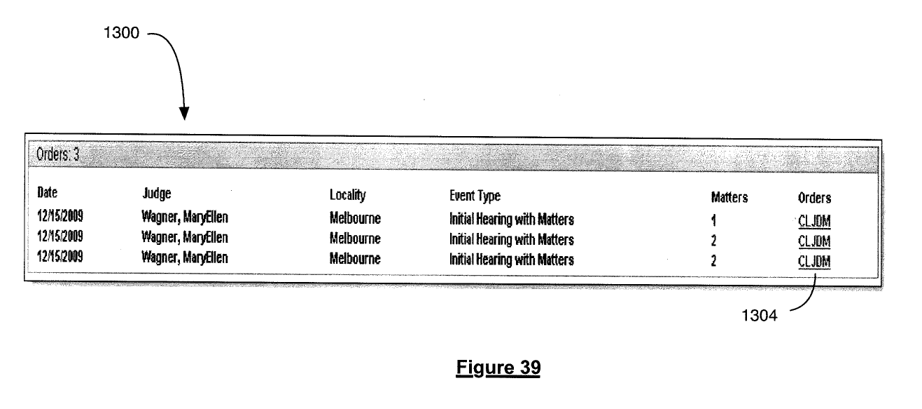

FIG. 39 shows a new orders section 1300 prepared by the case management module 108 that shows a user all orders related to the case, via a new “Orders” section. The hyperlink navigates the user to the anchor screen 700 for the order clicked.

### Order Components

The particular order details screen 900 and court order templates are built through the use of order components. Users can configure order templates to call various components based on the need to record user input, commit changes to the database, and generate text and/or documents.

Components are grouped into three categories: (a) “base” components; (b) “text” components; and (c) “output” components. These categories are important to understand when configuring order templates; however, the normal end user will not need to understand the difference between the types of components available in order template to use the functionality.

Components have scope attributes that restrict their application to certain types of entities, as will be described.

### Base Components

Base components record user input for specific areas of case management. The component fields defined for each base component are made available for use within paragraph text, docket text, and documents and also to commit changes to the database. This allows the user to enter information in one area and based on the configuration of the order template, that information may be used in or manipulated by other areas of the application reducing the requirements of the user to enter the same information in multiple areas.

FIG. 40 shows one type of base component, a sentencing component 1400. The sentencing component 1400 displays party charges on which an imprisonment order can be entered. The sentencing component 1400 allows the user to enter imprisonment details on individual charges or a group of charges at one time.

The sentencing component 1400 displays only charges on which imprisonment orders were added on the anchor screen 700. The user can enter or remove imprisonment details for one or several party charges at the same time by indicating whether or not the sentence is to be recorded as an individual sentence for each charge or is an aggregate sentence for all charges. The user is able to indicate the type of imprisonment and the imprisonment duration in years, months and days, the charge to which other charges relate and the relationship, a partially concurrent charge and the amount that is concurrent, whether a portion of the sentence is suspended, the suspended duration in years, months and days, and the operational period of the suspension, and calculates the total term of imprisonment based on values entered.

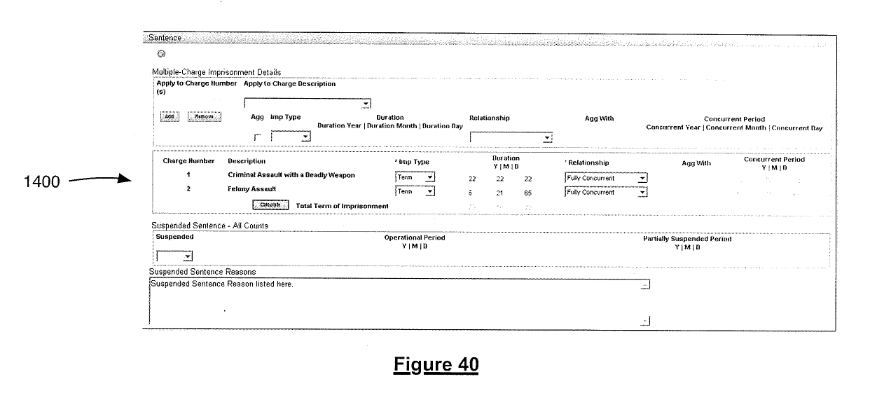

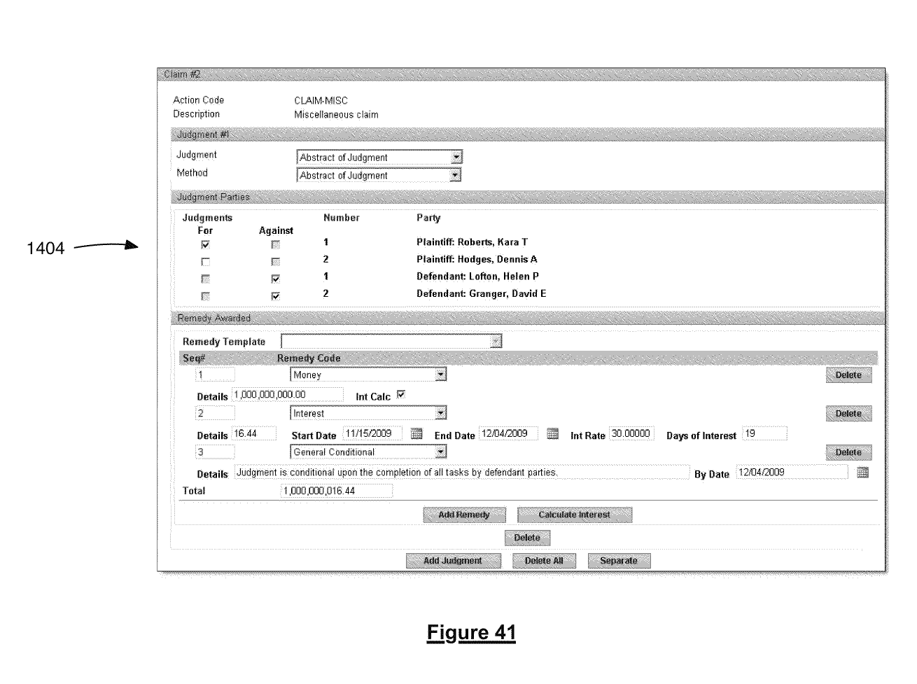

FIG. 41 shows another base component, a claim judgment component 1404. The claim judgment component 1404 displays claims on which judgments and remedies may be entered. This component is able to display multiple claims that may include multiple judgments with multiple parties for, multiple parties against, and/or multiple remedies. The user is able to record which parties each judgment is made for and against, can apply a remedy template or enter remedies manually, calculate interest, and/or separate judgments by party.

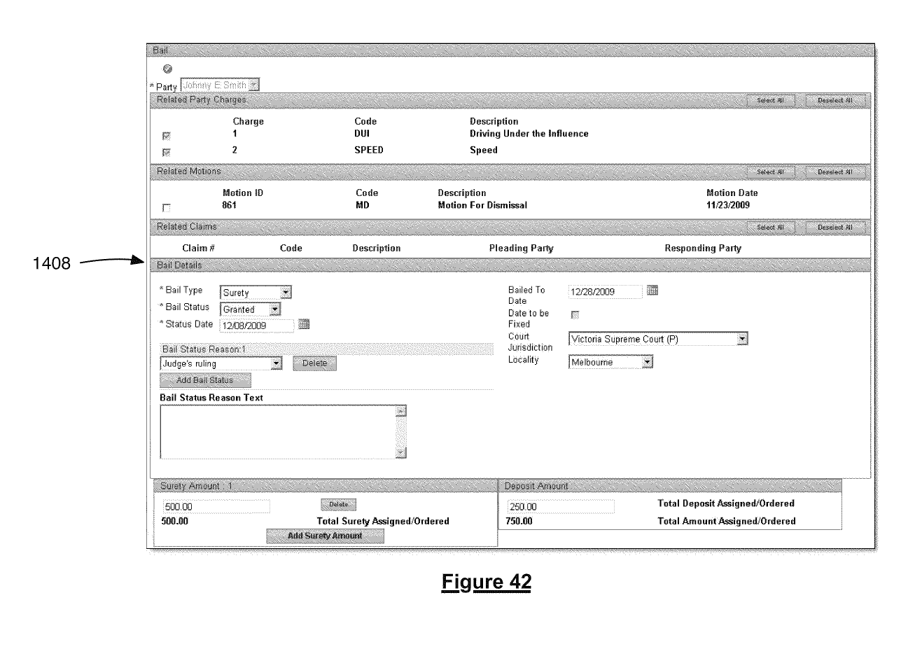

FIG. 42 shows a further base component referred to as a bail component 1408. Court orders for bail are issued on a party on a case by a judicial officer. The bail order method of originating bail uses the bail component 1408. Bail records may also be manually created through a bail maintenance screen in the case management module 108.

The bail component 1408 has multiple allowable scopes. This means the bail component 1408 can be used for several different order scopes. The allowable bail scopes are: (a) party; (b) party charge; (c) claim; (d) party claim; and (e) motion.

There are two main activities to processing bail. “Setting” bail will be used for the activity of the court when ordering the bail amount, type and conditions. “Posting” bail will be used for the activity on behalf of the defendant of entering the deposit amount and sureties received by the court.

The user is able to enter multiple bail status reasons and multiple surety amounts with total amounts calculating automatically.

FIG. 43 shows still another base component referred to as a record event result component 1412. The record event result component 1412 applies the result code configured for the component to the event in which the order is issued. As with the other components, the database is updated only when the order is confirmed.

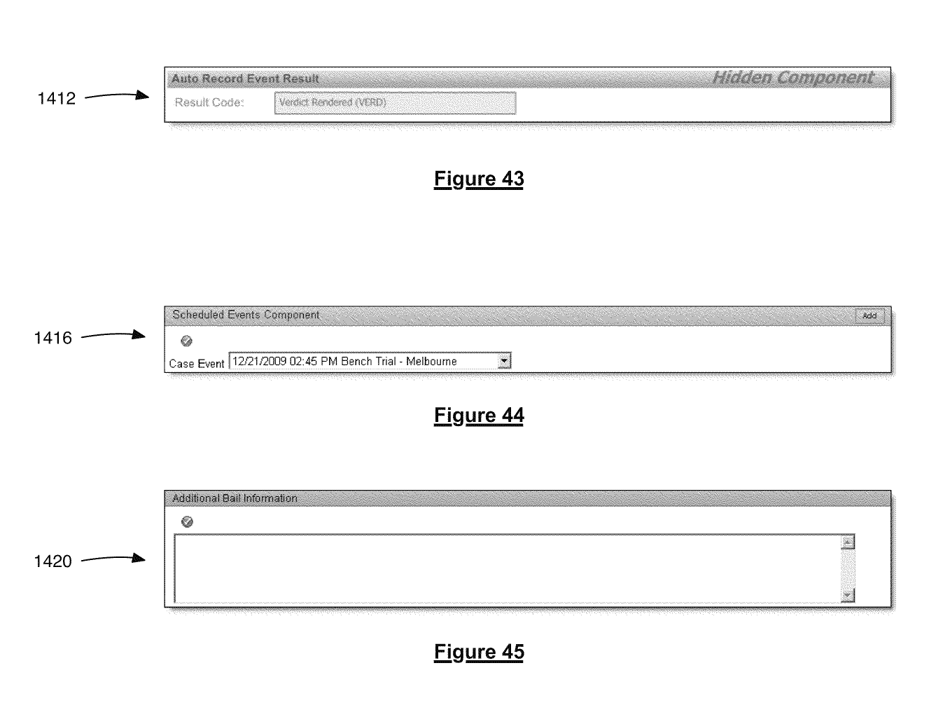

FIG. 44 shows still yet another base component known as a scheduled events component 1416. The scheduled events component 1416 allows a user to link to an existing event or manually or automatically schedule a linked future event. The scheduled events component 1416 links to existing scheduling functionality in the application. Standard conflict checking during manual scheduling will be executed at the time the user saves the order. It is not executed at the time the user confirms the order. Functionality set up on the event code, such as docketing and notice generation, is not called into execution from the scheduled events component 1416. The user can include the appropriate components, such as docketing and document generation components in the order template configuration to achieve this.

The new event can be scheduled in one of two ways. The event can be scheduled manually using event maintenance. When the user navigates away from the event maintenance screen, standard event scheduling conflict checking is executed. The user must deal with any conflicts that require changes to be made prior to saving the event information. Alternatively, the event can be scheduled automatically by using the auto schedule button at the bottom of the event maintenance screen. The auto button is activated to indicate auto-scheduling. A time block must be selected to save the event.

### Text Components

The text components are specifically designed to generate text that can be used by the application as either docket entry text or blocks of text inserted into documents. The paragraph selector and content builder components have additional functionality outside the generation of paragraph text.

FIG. 45 shows a free text component 1420 that is a basic component to record free text the user types. The text entered by the user in the free text component 1420 during the court process then becomes available to be included in docket text and/or a document.

The amount of text in the free text component 1420 is not limited by the application. The user will have the ability to cut and paste text from outside sources into the free text component 1420 but no related formatting will be applied.

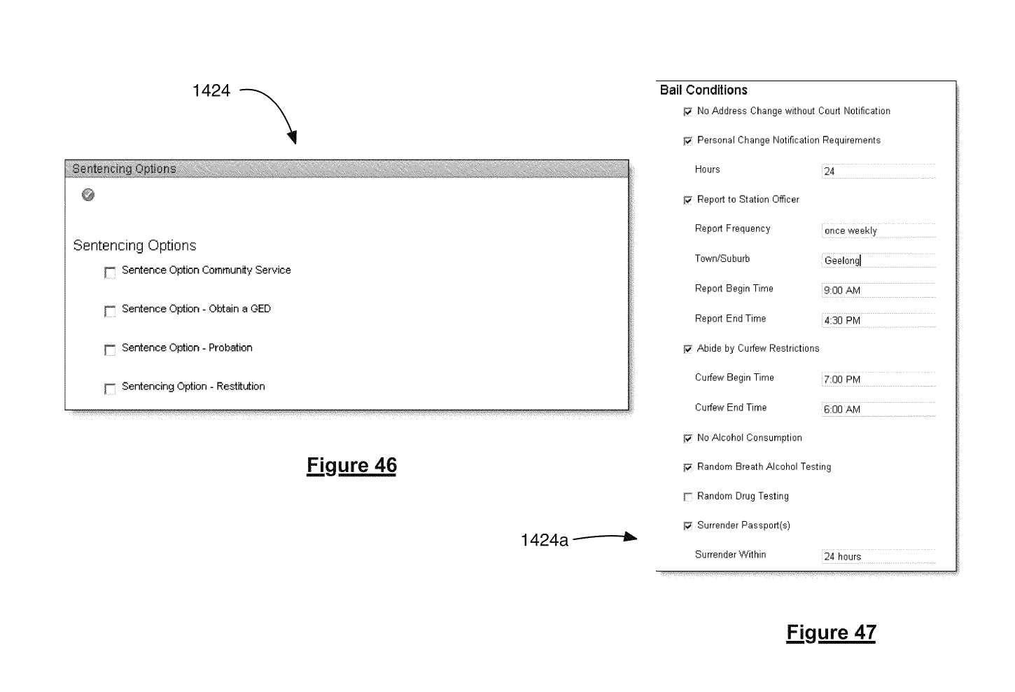

FIG. 46 shows an exemplary paragraph selector component 1424 that presents the user with one or more paragraphs that have been previously identified as potentially appropriate for the order template. The user can then select the paragraphs to include in the order template from the paragraph selector component 1424 as it's displayed on the particular order details screen 900.

A content builder component and a paragraph selector component share the same paragraph setup tables; both have the ability to add sentence options, special conditions, bail conditions, ticklers, or link to another base component based on the paragraphs selected for inclusion by the user. Each included paragraph may have one or more predefined paragraph field that the user can configure by entering data, using lists, or choosing case information (e.g., select a party or charge or list item).

The paragraph selector component 1424 illustrated does not require any additional user input, aside from the user selecting which line items to include in the order template and completing any mandatory paragraph fields.

Depending on the configuration of the paragraph setup, paragraphs may be mandatory or optional, have prompts for user input, and/or tokens for data substitution. The paragraph selector component 1424 is intended for quick data capture using only paragraph descriptions—not full text; it will support data field substitution, but not general editing. The separate content builder component is designed for more complicated full text editing.

FIG. 47 shows another example of a paragraph selector component 1424a that has with additional paragraph fields requiring user input to generate the paragraph text correctly. The paragraph fields are completely user-definable and can be configured to be optional or mandatory for the user to complete prior to confirmation of the order.

The content builder components and the paragraph selector components share the same paragraph setup tables, however the content builder component provides paragraph ordering, indenting, and additional editing capabilities. The content builder component allows the user to assemble pre-defined paragraphs into a block of text for inclusion in docket text and/or documents. Multiple content builder components can be used in a single order template to create separate blocks of text to insert into different areas of a document.

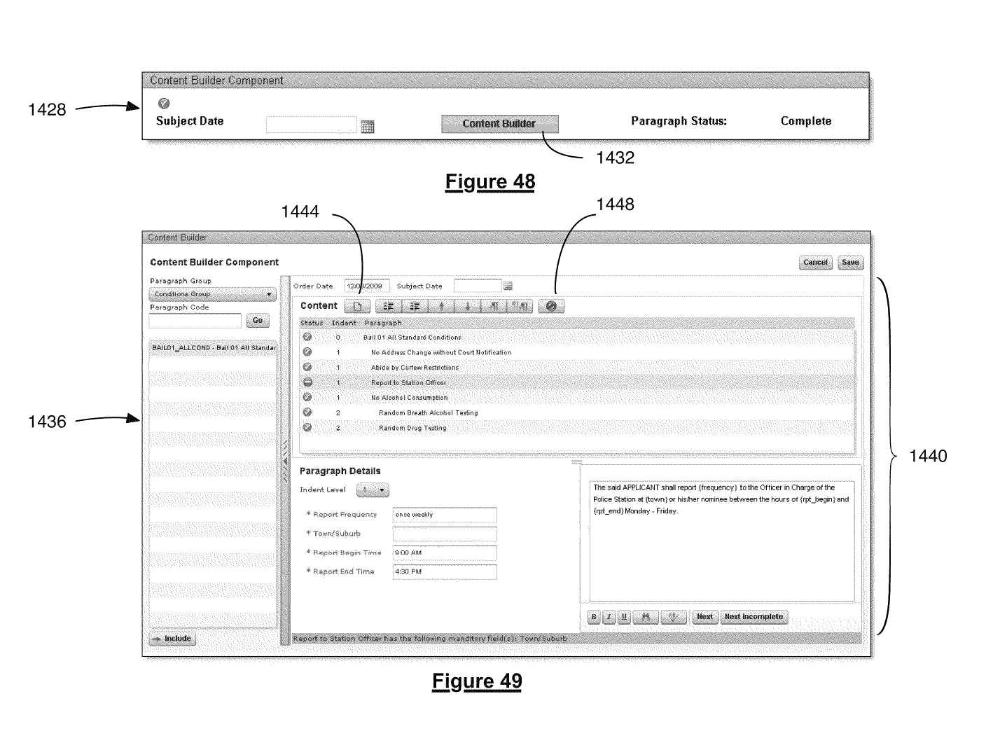

FIG. 48 shows a content builder component 1428 as it displays on the particular order details screen 900. The user calls the text editor by clicking a “Content Builder” button 1432. The content builder component 1428 and the paragraph selector component 1424 share the same setup tables. The content builder component 1428, however, provides paragraph ordering, indenting and additional editing capabilities. The content builder component 1428 allows the user to assemble pre-defined paragraphs into a block of text for inclusion in docket text and/or documents. Multiple content builder components 1428 can be used in a single order template to create separate blocks of text to insert into different areas of a document.

FIG. 49 shows a content builder text editor 1436 that enables a user to search and display paragraph descriptions that the user can include in the block of text or “content”. The user has the ability to search for paragraph codes by using paragraph groups as well as paragraph code values. This provides the user with an additional level of filtering results to allow the user the ability to quickly find the correct paragraph code to include in the content.

The user can drag and drop selected paragraphs into a content section 1440 of the content builder text editor 1436. The user can re-order or change the indentation of the included paragraphs. Each included paragraph may have one or more predefined paragraph field that the user can configure by entering data, using lists, or choosing case information (e.g., select a party or charge or list item).

Subordinate paragraphs are automatically appears in the content section when a superior paragraph is added to the content section. Subordinate paragraphs are configured on the paragraph code setup and include predefined sequence and indentation values. This allows the user to add a series of paragraphs with indentation and sequencing predefined in one action.

In the paragraph details section at the bottom of the content builder text editor 1436, the user is able to define indentation levels, visually identify mandatory paragraph fields, enter data in paragraph fields, cycle through the paragraphs in the content section using the “Next” button, and quickly locate incomplete paragraphs using the “Next Incomplete” button.

The user has extended editing capabilities with the content builder text editor 1436 that are not available with the paragraph selector. Depending on a paragraph code's configuration, the user is able to freely edit the paragraph text displayed in the text area of the paragraph details section. The user is also able to bold, italicize, and underline text.

The user is able to preview their paragraph text using an icon 1444 available in a content toolbar 1448.

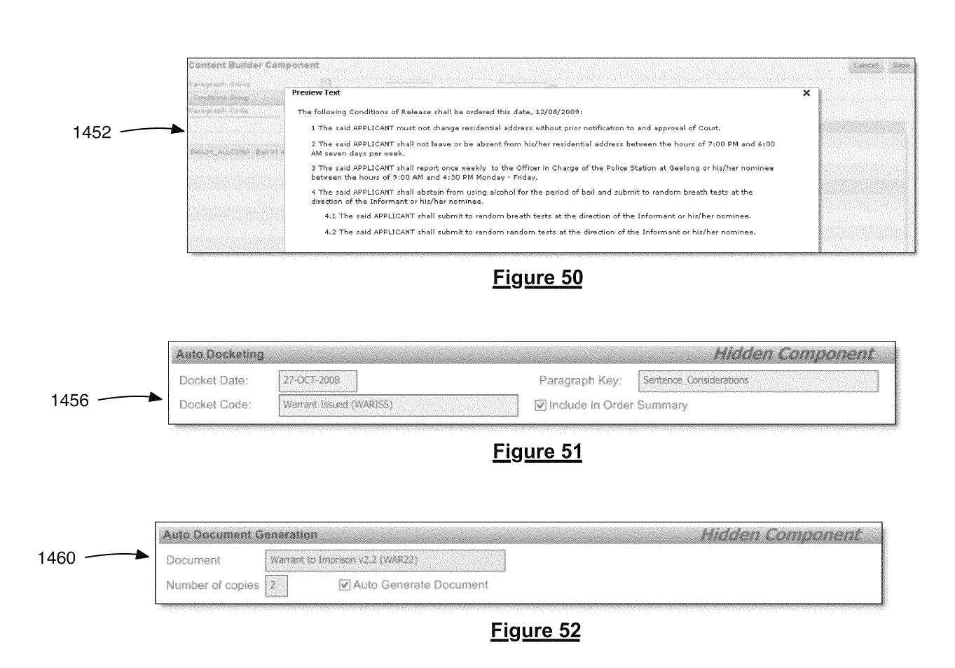

FIG. 50 show an example of a preview 1452 of merged paragraph text from the content builder text editor 1436 example shown in FIG. 49. This allows the user to preview their text prior to exiting the text editor.

### Output Components

Order documents are produced using the forms generation process in which a Microsoft Word template is combined with specific case data through the use of tokens. Tokens are placeholders in the template that indicate the data to be taken from the database and substituted in the document for the token. Tokens may simply indicate that a data value, such as defendant's last name, is to be placed in the document. Tokens may also represent a logical exercise, such as selecting the date of the next event, or a calculation, such as the total amount of money due.

Order documents in some jurisdictions use many selectable paragraphs of text. Some of the text is fixed and may not be altered while other paragraphs may be edited by the user. Some of the paragraphs include embedded tokens for which substitution will have to be made during document production. The option of free text entry is a feature of most order templates. Free text blocks can be of any length and can be cut and pasted in from an external source.

Once the document is assembled in Microsoft Word with token substitutions, it is printed and stored in the document management system as an image. Editing the document in Microsoft Word is not supported in order to maintain consistency between the data in the database and the documents.

The templates for different jurisdictions do not have the same appearance but the process of selecting, editing and assembling the documents function the same way across jurisdictions.

Currently, the registrar physically applies a seal and signature to finalizing orders and certified extracts to certify accuracy. For such orders, the documents are scanned after application of the seal rather than storing the image in the document management system as an automatic part of document production. Future versions may enable the application of an electronic seal instead of a physical one, and, similarly, may allow judges and associated to apply electronic signatures in place of written ones.

Extracts are a special case of document production presenting a summary of the order in a format determined by legislation. Certified extracts are currently generated upon request and payment. Notice of order made is another document that presents the same information in a different format without application of the seal or signature and without the requirement for any payment. Certified extracts are used in situations where formal acknowledgement of the order is required. A notice of order is less formal and currently includes name and mailing address information for the requestor.

The electronic image of a certified extract is created with the order and stored in the document management system. When requested, the extract is reprinted from the image rather than regenerated, if desired.

The output type components take the information entered by the user in base components, text created by the text components, and inserts the data into docket text and/or documents. These components auto-execute without user interaction upon confirmation of the order.

FIG. 51 shows a docket component 1456 that enables a user to add a docket entry to a case the order is issued on. A docket is thrown upon confirmation of each individual order during the confirmation process for each docket component defined. Dockets are created automatically without user intervention or display of the docket maintenance screen. The docket text can be populated with paragraph text created by a text component or a field on a base component that exists on the order template. The docket entry can contain the event date and time, event description, event judge, locality, the order particular code, matters related to order (party, charge, claim, or motion numbers) and the paragraphs chosen on the particular order details screen 900.

FIG. 52 shows a document generation component 1460 that provides methods for the production of forms in the courtroom. As a component of an order template, the document generation component 1460 merges data with the text of the order from a pre-defined forms generation document. The document generation component 1460 produces a document from the forms generation Microsoft Word merge function and paragraph substitution sourced from the free text component 1420, the paragraph selector component 1424, and/or the content builder text editor component 1424. The user has the ability to allow automated or manual printing of the document and to optionally print one or more copies of the document.

The document generation component 1460 allows the user to specify during configuration of the order template the form name, the number of copies to print, and whether or not the document should be generated automatically without user intervention. The component will allow the user to map document paragraph insertion points to fields of the free text component 1420, the paragraph selector component 1424, and/or the content builder text editor component 1424.

### Order Template Setup and Configuration

During setup, default values are configured for each judicial order template type. In addition to the default values, the configuration indicates whether the defaults may be overridden, whether each field is mandatory and whether it should be visible to the user. If the act and section are required, that will also be indicated in configuration. Setup also includes any business rules to be applied. In this simple example, one business rule is that the choices of scheduling to a known date or adjourning to a date to be fixed later are mutually exclusive. Cascading actions also have to be considered. For example, scheduling an event can trigger notices to be sent or a docket to be added to the case. Docket entries, in turn, can be configured to have additional actions, such as triggering an interface to another system.

Particular code setup is used to generate order documents and/or commit changes to the database related to the confirmation of orders.

Users have to the ability to search for particular codes by the code, description, and/or scope values by site. There is an implied wildcard at the end of the code and description fields.

The configuration performed for the judicial orders computer system 20 will now be discussed. This setup is site-based; that is, codes are configured on a site-by-site basis.

Search fields that have an “implied wildcard” automatically append a wildcard to the end of the search field, behind the scenes, when the search is executed and does not require the user to enter a wildcard at the end of the field. Search fields that do not have an “implied wildcard” will not automatically append a wildcard to the end of the search field and will only return result sets that match the search criteria entered by the user. Users can manually enter wildcards before, in the middle, or at the end of search fields that do not have implied wildcards to execute wildcard searches, unless Business Rules prevent the use of wildcard searches for the field.

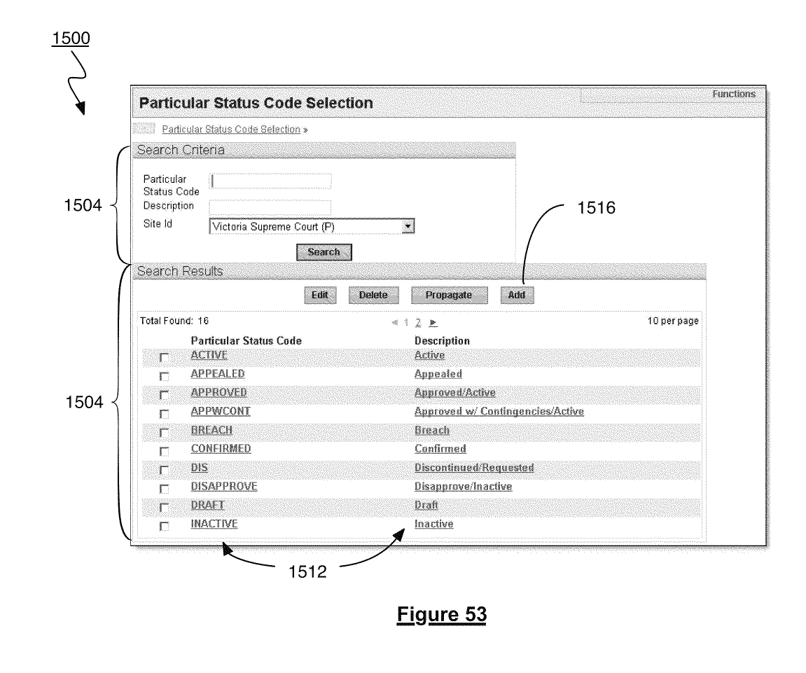

FIG. 53 shows a particular status code selection screen 1500 accessed from a hotlink from the judicial management module 132. Users have to the ability to search for particular status codes by the code and/or description values by site. A search criteria section 1504 enables users to specify search criteria for locating status code. A search results section 1508 presents results of the search. There is an implied wildcard at the end of the code and description fields. Hyperlinks 1512 available for the status code and description navigate the user the particular status code maintenance screen.

To enter a new particular status code, the user clicks an add button 1516 and is navigated to the particular status code maintenance screen in add mode.

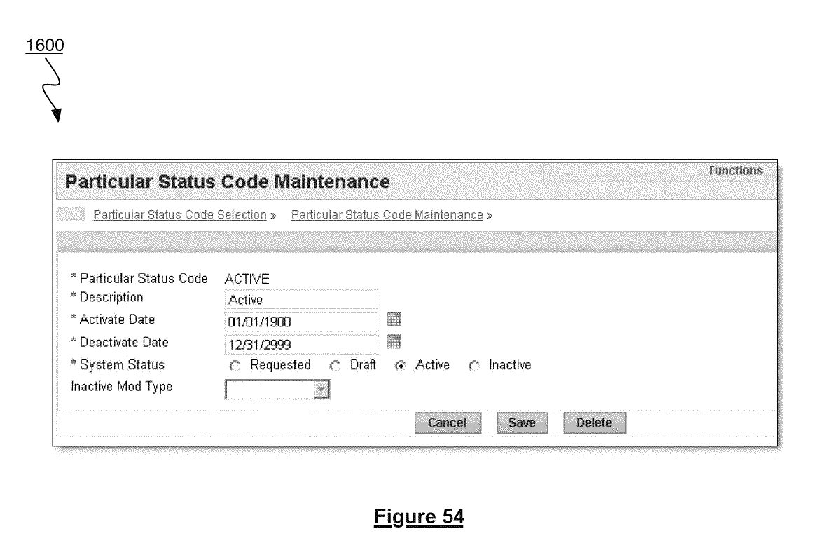

FIG. 54 shows the particular status code maintenance screen 1600. The user will be required to define the status code, description, activate date, deactivate date, and system status values to save a new code value. At least one particular status code value is required to be defined for both system statuses of “draft” and “active” prior to granting the first case type code access to the judicial management module 132. Each case type code can only be linked to one draft and one active status. If the underlying system status is equal to “inactive”, the user is required to select an inactive modification type attribute. Inactive statuses are grouped in one of three categories: (a) void to delete; (b) void to modify; (c) legal action. These values are used to filter status codes in the dropdown menu during void processing.

The system administrator establishes which anchor screen (civil or criminal) to display to the user in the courtroom for each case type. The docket component can be configured with the docket entry to be added to the case when orders are confirmed using the docket component.

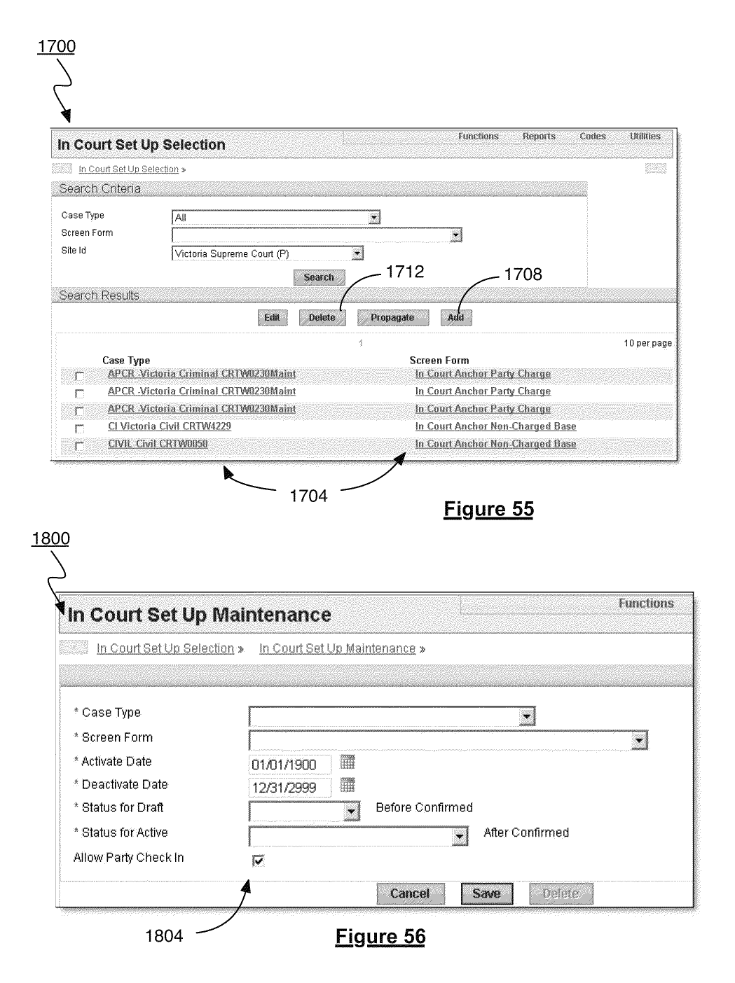

FIG. 55 shows a set up selection screen 1700. Users can filter search results by case type, screen form, and site. Hyperlinks 1704 available for case type and screen form navigate the user to a setup maintenance screen. To enter a new particular status code, the user clicks an add button 1708 and is navigated to a particular status code maintenance screen in add mode.

FIG. 56 shows the set up maintenance screen 1800. The system administrator selects the case type, anchor screen, draft status, and active status from drop down menus. Mandatory fields are visually indicated with an asterisk beside the field name. The anchor screen can be configured to allow party check in by flagging (checking) an “Allow Party Check In” box 1804.

Once a record is saved, the user may edit the setup configuration by accessing the set up maintenance screen 1800 using a hyperlink 1704 available in the search results section of the set up selection screen 1700.

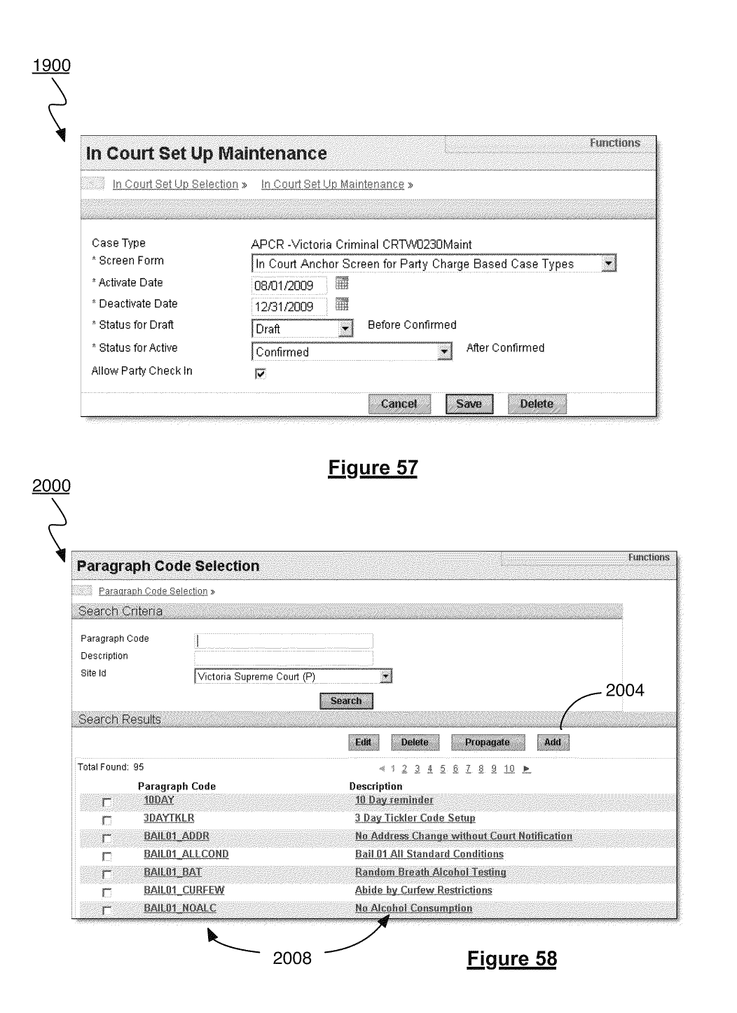

FIG. 57 shows the set up maintenance screen 1900 after the set up configuration is saved. After the initial save, the user is not able to change the case type code associated with the entry, as shown in the following image. The user can utilize a delete button 1712 on the set up selection screen 1700 to remove the set up entry, if necessary.

Paragraph code setup is required for use of paragraph selector and content builder components. Paragraph codes generate/build the text to be included in dockets and documents.

FIG. 58 shows a paragraph code selection screen 2000 used to create new pre-defined paragraphs for insertion into order templates. Users have to the ability to search for paragraph codes by the code and/or description values by site. There is an implied wildcard at the end of the code and description fields.

To enter a new paragraph code, the user clicks an add button 2004 on the selection screen and is navigated to a paragraph code maintenance screen for entry of new paragraph codes. The user may also use hyperlinks 2008 available for paragraph code and description to modify setup of an existing code. The hyperlinks 2008 navigate to the paragraph code maintenance screen in edit mode.

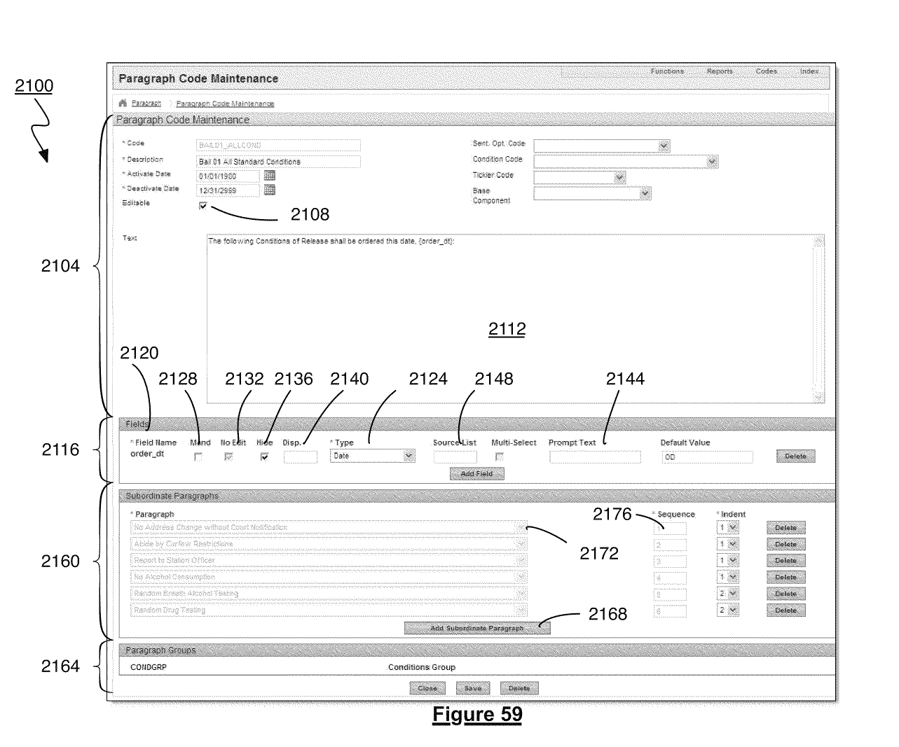

FIG. 59 shows the paragraph code maintenance screen 2100. This is the main functionality for defining “order templates” from the pre-defined components in a modular manner. This screen allows the system administrator to configure a new order template or modify an existing order template using components and rules that have been defined and built at a lower level. Once the particular order code is defined, it may be used by a judicial officer or other authorized user to make an order on a case. These are the order codes that will be applied to cases in the courtroom.

If sentence option, special condition, and tickler code setup are to be utilized during paragraph code setup, they will need to be completed prior to paragraph code configuration to have those database changes committed during the confirmation process of orders. Mandatory fields are visually indicated with an asterisk. The user is required to define the paragraph code, description, activate date, and deactivate date to save a new code value.

A top section 2104 of the paragraph code maintenance screen 2100 contains the basic code setup. This is also where the paragraph code can be linked to sentence options, special conditions, bail conditions, ticklers, and base components. Paragraph code values can only contain the following characters: A-Z, 0-9, and underscore. All other characters, including spaces, are prohibited. An “Editable” checkbox 2108 indicates whether the end user will have permission to edit the paragraph text on the content builder text editor. A text area box 2112 is where the paragraph text will be defined for the paragraph code. This is the text to be merged with dockets and/or documents when the paragraph code is selected on the paragraph selector and content builder components. Paragraph text is not required for code configuration. A paragraph code could be created to just add conditions to the database, without the generation of any text, when the paragraph is selected for inclusion on an order template.

In a paragraph fields section 2116 of the paragraph code maintenance screen 2100 which is a free text component, the user is able to define any additional paragraph fields necessary to correctly generate the desired paragraph text. When a paragraph code is linked to sentence options, special conditions, bail conditions, ticklers, and/or base components, default paragraph fields will automatically populate a paragraph fields section 2116 of the paragraph code maintenance screen 2100.

Paragraph field names can only contain the following characters: A-Z, 0-9, and underscore. All other characters, including spaces, are prohibited. Unique paragraph field names are required for each paragraph field line item. For defaulted paragraph fields as defined for sentence option code, condition code, tickler code, and base component, prefix characters specific to the linked code have been added to the beginning of the field names, so that unique field names are created for each code. A field name 2120 and paragraph field “type” drop-down menu 2124 are required in order to save. A “Mand” checkbox 2128 indicates whether completion of the field is required on the particular order details screen 900. A “No Edit” checkbox 2132 indicates whether the field is editable on the particular order details screen 900. A “Hide” checkbox 2136 indicates whether the field is hidden on the particular order details screen 900. A “Disp.” field 2140 indicates the display sequence of field on particular order details screen 900. If a paragraph field is marked (checked) as hidden, then the “No Edit” checkbox 2132 is required. The “No Edit” checkbox 2132 is checked and disabled (grayed out) automatically, as well as a prompt text field 2144 and the “Disp.” field 2140, anytime the “Hide” checkbox 2136 is checked. If a paragraph field is hidden, then it is not viewable from a component by the user and cannot be edited, therefore a display sequence and prompt text are not necessary. If a paragraph field is not hidden (that is, if the “Hide” checkbox 2136 is unchecked), the “Disp.” field 2140 becomes required. The user manually enters and determines the display sequence for paragraph fields on the paragraph selector and content builder components. There may be gaps in the sequence values, but duplicate sequence values are not allowed.

The following table shows the default field values for sequence option codes.

| | | No | | | Source | Prompt | |
|---|---|---|---|---|---|---|---|
| Field Name | Mand | Edit | Hide | Type | List | Text | Default Value |
| SENTO_dscr | □ | [symbol] | [symbol] | Text | | | = Sentence Option Code |
| | | | | | | | Description |
| | | | | | | | {dscr.SENTOCD} |

The following table shows the default field values for condition codes.

| | | No | | | Source | Prompt | |
|---|---|---|---|---|---|---|---|
| Field Name | Mand | Edit | Hide | Type | List | Text | Default Value |
| COND_dscr | □ | [symbol] | [symbol] | Text | | | = Condition Code |
| | | | | | | | Description |
| | | | | | | | {dscr.SPCONDCD} |
| COND_entry_date | □ | [symbol] | [symbol] | Date | | Entry | OD |
| | | | | | | Date | |
| COND_due_date | □ | □ | □ | Date | | Due Date | |
| COND_required_amt | □ | □ | □ | Integer | | Duration | |
| COND_units | □ | □ | □ | CodePick | UNITCD | Period | |
| | | | | List | | | |
| COND_agency | □ | □ | □ | CodePick | AGNCCD | Agency | |
| | | | | List | | | |

The following table shows the default field values for tickler codes.

| | | No | | | Source | Prompt | |
|---|---|---|---|---|---|---|---|
| Field Name | Mand | Edit | Hide | Type | List | Text | Default Value |
| TKL_dscr | □ | [symbol] | [symbol] | Text | | | = Tickler Code |
| | | | | | | | Description |
| | | | | | | | {dscr.TKLCD} |
| TKL_entry_date | □ | [symbol] | [symbol] | Date | | | {entry_dt_src.TKLCD} |
| TKL_days_due | □ | [symbol] | [symbol] | Integer | | | = {TKL_due_date} − |
| | | | | | | | {TKL_entry_date} |
| TKL_due_date | □ | □ | □ | Date | | Tickler Due | |
| | | | | | | Date | |

The following table shows the default field values for base components.

| | | No | | | Source | Prompt | |
|---|---|---|---|---|---|---|---|
| Field Name | Mand | Edit | Hide | Type | List | Text | Default Value |
| Basecomp_key | □ | □ | □ | List | PRTCOMPCD | Base | {key_token. |
| | | | | | | Component | PRTCOMPCD} |
| | | | | | | Key | |
| {field_nm. | □ | [symbol] | [symbol] | {type. | {sourcelist. | {prompt_text. | |
| COMPFLDS} | | | | COMPFLDS} | COMPFLDS} | COMPFLDS} | |

The following table shows the default field values for docket components.

| Field | | No | | | Prompt | | Multi- | User | DefFld |
|---|---|---|---|---|---|---|---|---|---|
| Name | Mand | Edit | Hide | Type | Text | Default Value | Select | Fld | NoEdit |
| DKT_dscr | □ | [symbol] | [symbol] | Text | | = Docket Code | □ | □ | [symbol] |
| | False | True | True | | | Description | False | False | True |
| | (0) | (1) | (1) | | | {dscr.DKTCD} | (0) | (0) | (1) |
| DKT_date | □ | [symbol] | [symbol] | Date | Docket | OD | □ | □ | [symbol] |
| | False | True | True | | Date | | False | False | True |
| | (0) | (1) | (1) | | | | (0) | (0) | (1) |
| DKT_amt | □ | □ | □ | Integer | Amount | | □ | □ | □ |
| | False | False | False | | | | False | False | False |
| | (0) | (0) | (0) | | | | (0) | (0) | (0) |

When a base component is selected in the top section of the paragraph code maintenance screen 2100, the paragraph fields section 2116 is automatically populated with the component fields for the base component selected. If a component field name for a base component has a field name equal to a field name defined by the user in the paragraph fields section 2116, the user will be required to change the field name for their user defined field. The user is not permitted to change the field name for any default paragraph fields related to a sentence option code, condition code, tickler code, and/or base component selected in the top section 2104 of the paragraph code maintenance screen 2100. The “Basecomp key” field noted in the table above links the paragraph to the specific base component token key defined on a particular order code maintenance screen. This is defined in the particular code setup section.

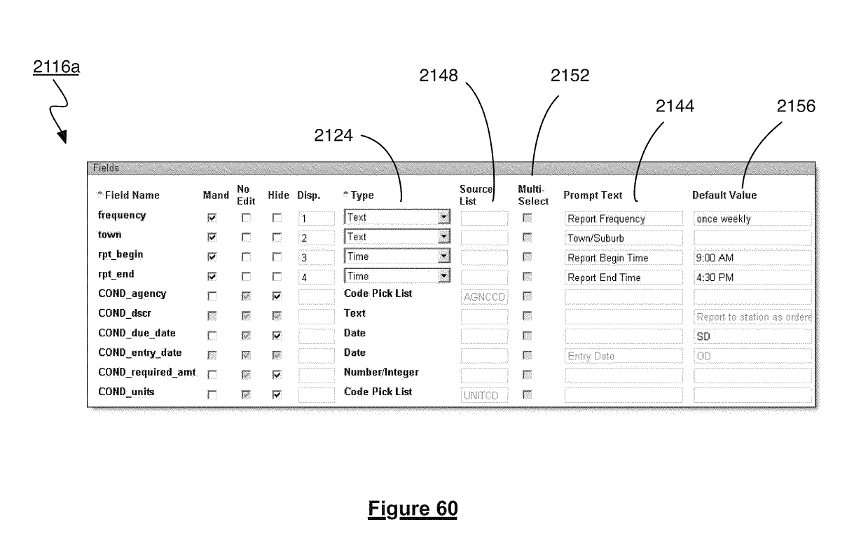

FIG. 60 shows the setup of paragraph fields for display on the particular order details screen by either the paragraph selector and/or content builder components. Values for the paragraph field “type” drop-down menu 2124 can be: text, number/integer, date, time, money, decimal, checkbox/logical, user defined list (UDL), system defined list (SDL), and code pick list (CPL). If the paragraph field “type” drop-down menu 2124 is defined as a list, a source list field 2148 is required. The source list is the UDL code, SDL code, or code table name used to generate the list of values for the drop-down menu on the component from the particular order details screen 900. If the paragraph field “type” drop-down menu 2124 is not a list, then the source list field 2148 is disabled (grayed out). A multi-select checkbox 2152 is enabled if the paragraph field “type” drop-down menu 2124 is defined as a UDL. This allows the user to select multiple values from the drop-down menu presented on the component as it displays on the particular order details screen 900.

The prompt text field 2144 is required for all fields not hidden. This is the label description that is displayed on the component. In the example image below, the “frequency” paragraph field will display with the label “Report Frequency” on the paragraph components.

Default values can be defined for paragraph fields by entering values in a default value field 2156 of the paragraph field section 2116. Default values are limited to 250 variable characters. The data type of the default value field 2156 must match the data type of the paragraph field “type” drop-down menu 2124. If paragraph field “type” drop-down menu 2124 is defined as a checkbox/logical field, the paragraph field displays as a checkbox on the component on the particular order details screen 900. The user may set default “true” and “false” values for paragraph fields of this type by indicating the values in the default value field 2156.

If paragraph field “type” drop-down menu 2124 is defined as a date field, the user may use a date formula to calculate default values for paragraph date fields as specified by the default value field 2156. Date formulas will be based on either the order date (OD) or the subject date (SD) from the particular order details screen 900. Date formulas are not case sensitive and may not include blank spaces. A table of the variables that can be used to define default dates using formulas in the default value field 2156 is presented below.

| Value | Definition of Use |
|---|---|
| OD | Order Date |
| SD | Subject Date |
| + | Will add year(s), month(s), or day(s) to the OD or SD value. |
| − | Will subtract year(s), month(s), or day(s) to the OD or SD value. |
| Y | Indicates a number of year(s) to add or subtract from OD or SD |
| | value. “Y” character must be preceded by a numerical value. |
| M | Indicates a number of month(s) to add or subtract from OD or SD |
| | value. “M” character must be preceded by a numerical value. |
| D | Indicates a number of day(s) to add or subtract from OD or SD |
| | value. “D” character must be preceded by a numerical value. |
| Prev | Indicates the previous business day date should be returned when |
| | date formula yields a value equivalent to a weekend or holiday. |
| Next | Indicates the next business day date should be returned when date |
| | formula yields a value equivalent to a weekend or holiday. |

The following date formula syntax is used:
the user must identify what date the formula will be based on: “OD” or “SD”
the user must identify mathematical function: “+” or “−”
the user must enter a numerical value (1-999) followed by the appropriate time based character (Y, M, or D) reference
the user must enter business day reference of “prey” or “next” at the end of the formula to indicate whether the previous or next business day should be returned for dates falling on weekends or holidays

For example, “OD+1y3 mnext” is used to define a default value for a date equal to the order date plus one year and three months, and the next business day if date falls on weekend or holiday.

If paragraph field “type” drop-down menu 2124 is defined as a list, the user can manually enter a value in the default value field 2156 equal to the “code” value for the list item. If no value is entered in the default value field 2156, the paragraph field displays on the component as a drop-down menu containing the items from the code table or list. If the value in the default value field 2156 is from a code pick table, the “code” value from that table should be entered. If the field value is from a UDL, enter the list item code value from the user-defined list. If the field value is from a hard-coded SDL, enter the system defined value.

The following system lists are available for use with paragraph code setup. The user can specify their own paragraph field name; the names in the table below are for reference only. The table below indicates the correct “source list” value the user will need to enter on the paragraph code maintenance screen 2100.

List of System Lists for the Paragraph Code Setup

| Field Name Example | Source List Value | Comment |
|---|---|---|
| CASE_ATTORNEY | CASEATTORNEY | Case Attorney: Name, Bar |
| | | Number Drop Down |
| ATTORNEY | ATTORNEY | Attorney Selection |
| CASEEVENT | CASEEVENT | Case Event: Event Date-Event |
| | | Type Descr Drop Down |
| EVENTPARTY | EVENTPARTY | Event Party(s): Party Code |
| | | Dscr, Pty Nbr, Name Drop |
| | | Down |
| EVENTJUDGE | EVENTJUDGE | Event Judge Drop Down |
| CASEPARTY | CASEPARTY | Case Party(s): Party Code |
| | | Dscr, Pty Nbr, Name Drop |
| | | Down |
| INSTITUTION | INSTITUTION | Institution Selection |
| JUDGE | JUDGE | Judge Selection |
| STAFF | STAFF | Staff Selection |
| PARTICULAR | PARTICULAR | Particulars from previously |
| | | confirmed active orders where |
| | | evnt dt is less than the first |
| | | evnt dt on the current evnt: |
| | | Event Date, Particular Code |
| | | Descr Drop Down |
| AGENCY | AGENCY | Agency |

Referring again to FIG. 59, the paragraph code maintenance screen 2100 also has a subordinate paragraphs section 2160 and a paragraph groups section 2164.

Subordinate paragraphs allow the user to link other similar paragraphs to a “parent” paragraph. Subordinate paragraphs require the user to define the sequence and indentation values for the paragraphs added in the subordinate paragraphs section 2160. When a subordinate paragraph code is added via an “Add Subordinate Paragraph” button 2168, a subordinate paragraph record is added in the subordinate paragraph section 2160. Upon adding the record, the particular subordinate paragraph can be selected via a paragraph combo box 2172, and a value in a sequence field 2176 is required. The user can manually enter a display sequence value for the subordinate paragraph via the sequence field 2176.

Subordinate paragraphs can be set up for any paragraph but will only be implemented in the content builder component. Subordinate paragraphs will not cascade; that is, if main paragraph code A is to be followed by subordinate paragraphs B, C, and E, the content builder will not check to see if B, C, and E have their own subordinate paragraphs.

When the user selects a paragraph on the content builder component that includes subordinate paragraphs, all paragraphs are added to the content in one action in the sequence defined. The predefined indentation levels are also carried forward into the content.

Paragraph codes are grouped by paragraph group code. Although paragraph group codes are not required to use paragraph codes in the content builder component, they are required for the setup of the paragraph selector component. Paragraph group codes will not be added and/or modified from the paragraph code maintenance screen 2100.

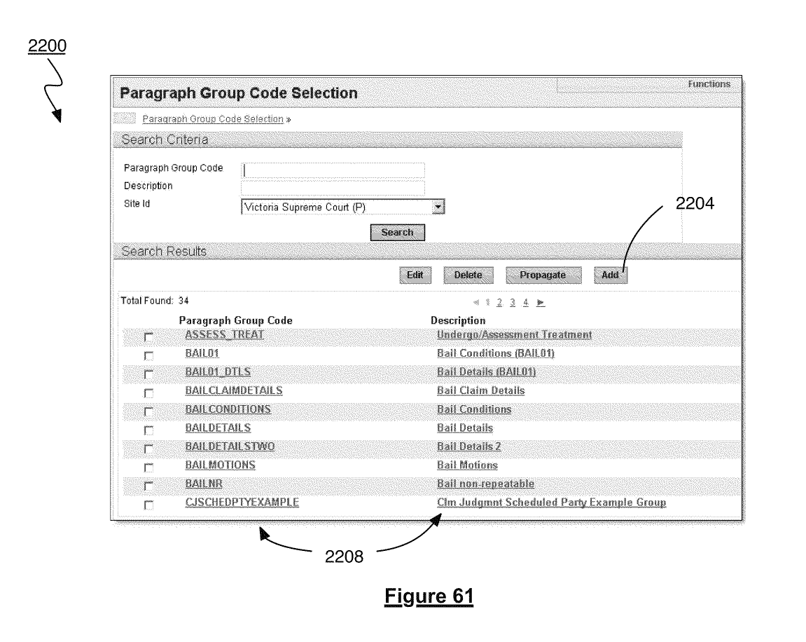

FIG. 61 shows a paragraph group code selection screen 2200 that a user can employ to manage paragraph code assignments to group codes. Paragraph group code setup is required for use of the paragraph selector component and as means of filtering search results in the content builder component. Users have to the ability to search for paragraph group codes by the code and/or description values by site via the paragraph group code selection screen 2200. There is an implied wildcard at the end of the code and description fields.

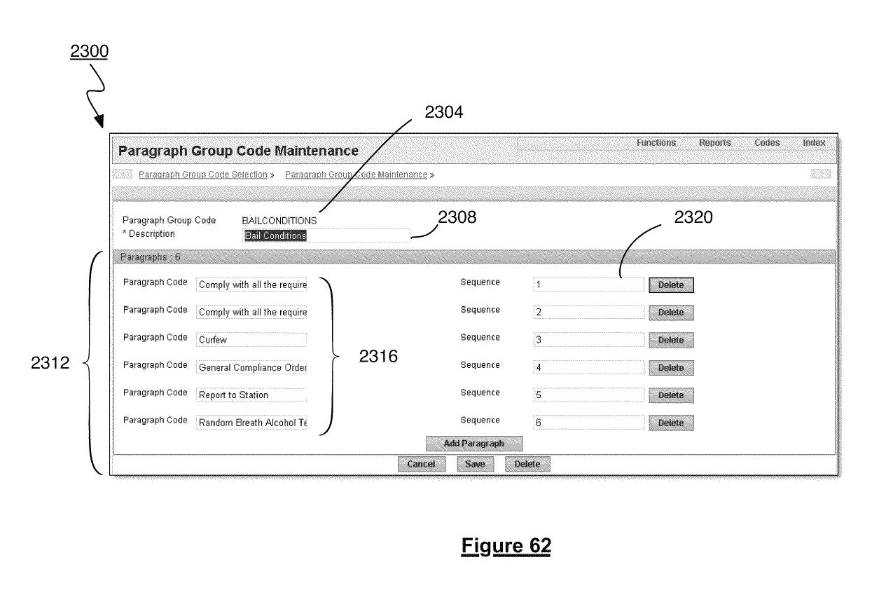

FIG. 62 shows a paragraph group code maintenance screen 2300 that a user can navigate to via an add button 2204 on the paragraph group code selection screen 2200 to enter new paragraph group codes. The user may also use hyperlinks 2208 available for paragraph group code and description to modify setup of an existing code via the paragraph group code maintenance screen 2300. The hyperlinks 2208 navigate to the paragraph group code maintenance screen 2300 in edit mode.

Mandatory fields are visually indicated with an asterisk. The user is required to define a paragraph group code 2304 and a description 2308 to save a new code value. Paragraph group code values can only contain the following characters: A-Z, 0-9, and underscore. All other characters, including spaces, are prohibited.

Paragraph code setup is required to be able to add paragraphs to groups. The user is not required to add any paragraph codes in a paragraphs section 2312 of the paragraph group code maintenance screen 2300 in order to save the record. Paragraph codes 2316 may be assigned to multiple paragraph groups; however, an individual paragraph code 2316 cannot be assigned to the same paragraph group multiple times. Once a paragraph code 2316 is added to a paragraph group, a sequence value 2320 becomes required. The user manually enters display sequence values 2320 for paragraphs to determine the order in which the paragraph will display on the paragraph selector component. There may be gaps in the sequence values 2320, but duplicate sequence values 2320 are not allowed.

The particular code selection screen and the particular code maintenance screen allow for the entry and display of particular code attributes and configuration of components, eligibility constraints, and completion requirements. The particular code defines the components, data elements and rules to drive the business processing of judicial orders. It is used by system administrators for setup and configuration of the order templates.

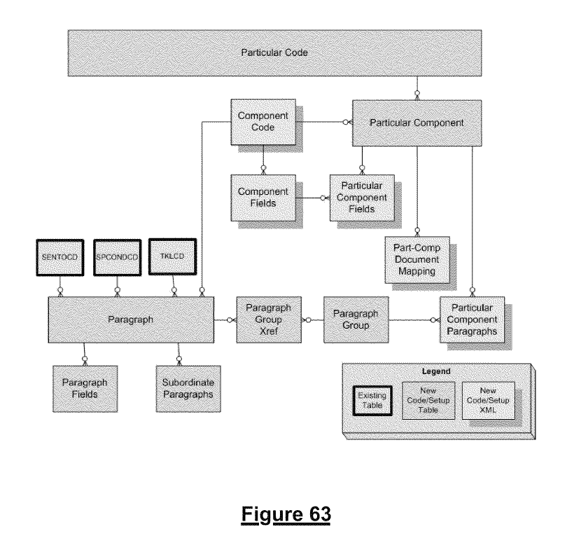

FIG. 63 is an example of a diagram showing the entity relationships for orders particular setup.

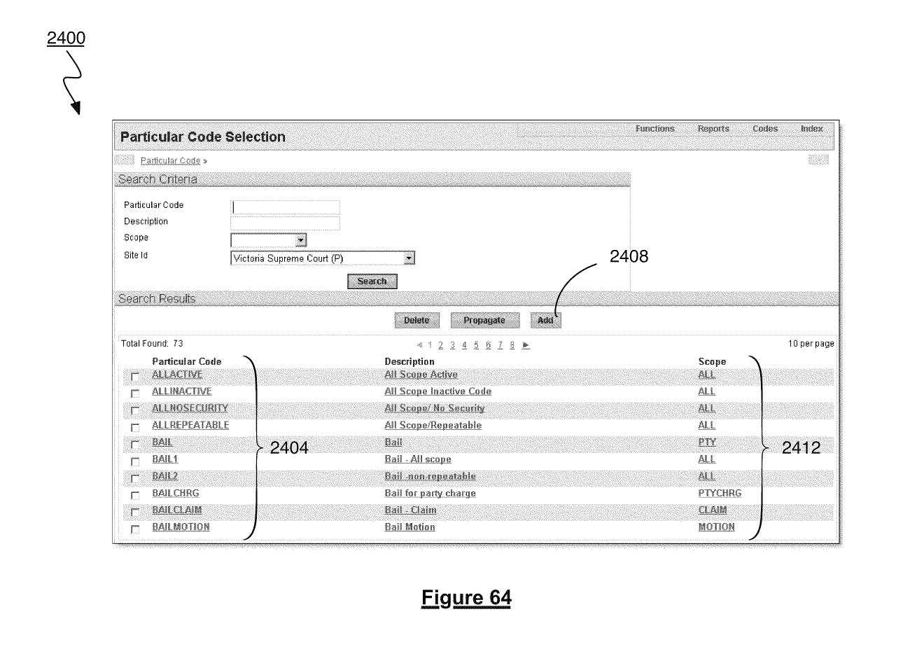

FIG. 64 shows a particular code selection screen 2400 that allows a user to search through available particular codes (or orders) and create new orders. A user may use hyperlinks 2404 available for presently-defined particular codes, description, and scope to modify setup of an existing code. Activation of the hyperlink navigates to a particular code maintenance screen in edit mode for modifying the order. To enter a new particular code, the user clicks an “Add” button 2408 on the particular code selection screen 2400 and is navigated to the particular code maintenance screen for entry of a new order.

Mandatory fields are visually indicated. The user may be required to define the particular code, description, activate date, deactivate date, and scope to save a new code value. The scope 2412 of a particular order is specified. It can be a specific matter type of case, party, party charge, claim, party claim, motion (application) or “All” matter types.

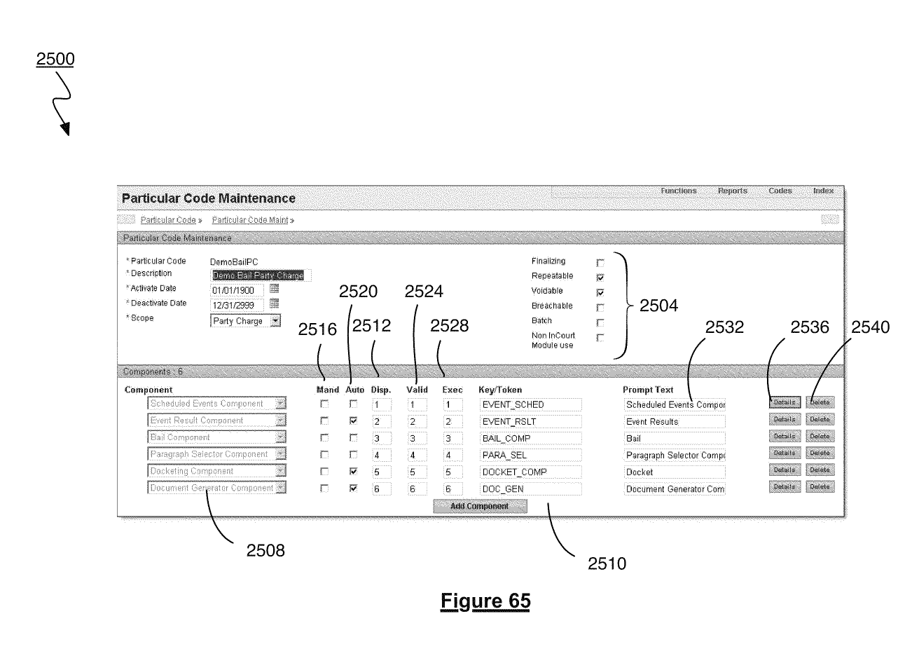

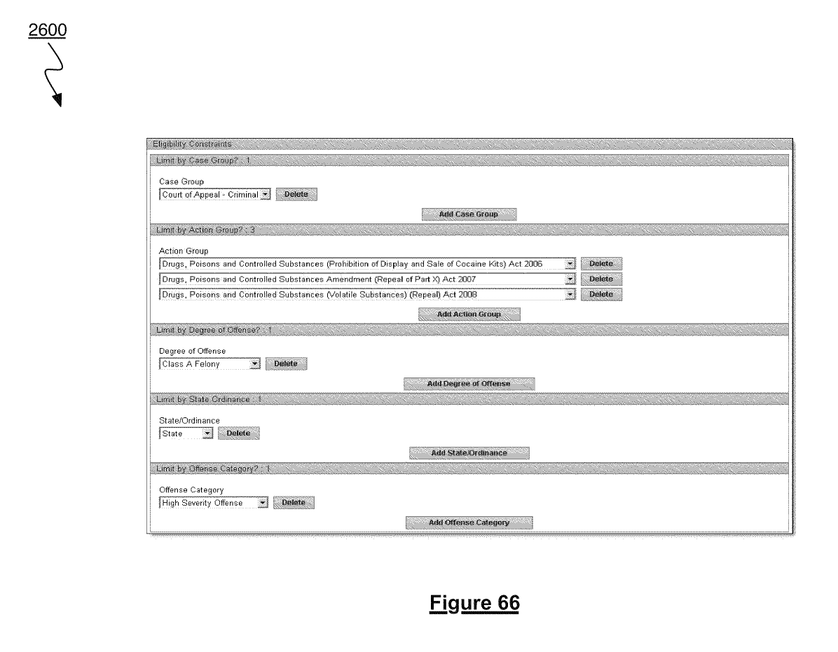

FIG. 65 shows the particular code maintenance screen 2500. Amongst other things, there are six particular code attributes that a user can configure on the maintenance screen via a set of checkboxes 2504. These include: (a) Finalizing; (b) Repeatable; (c) Voidable; (d) Breachable; (e) Batch; and (f) Non InCourt Module Use. Finalizing indicates the order can dispose of a matter, party, and/or case. Repeatable indicates if the particular is repeatable within an event or order header. Voidable indicates whether the order can be voided. Breachable indicates whether an order created with the order template can be breached. Batch indicates whether an order created using the order template can be applied to multiple cases as part of batch processing. Finally, non-InCourt module use indicates an order template that can be used outside of the InCourt orders module (breachable, batch, non InCourt orders functionality will be available in a future release of orders).

The values that display in a set of component drop-down menus 2508 are defined in the metadata of the component code class (COMPCD XML) of the Particular Code (PARTCD) table. The scope of attached components must either: (a) match the scope of an order generated using the order template; or (b) have a scope of “All”. That is, the component selected must be applicable to the type of order template. For example, a particular code for party charges can only include components that work on party charges or components that can work on “all” matter types. It cannot include a component that expects a different matter type, such as a claim (which is non-party charge). A particular code for “All” matters can only include components that work on “All” matter types. The component's primary scope is compared to the particular code's primary scope to determine if the component is applicable.

Multiples of the same components may exist for one particular code. These values are distinguished by unique “key/token” values 2510. The key/token values 2510 default to the component code key XML value automatically when the component is selected from the drop-down menu. The user can change the key/token 2510 values for any duplicate components to ensure that all values are unique.

Components display and execute on the particular order details screen 900 as they are configured on the particular code maintenance screen 2500. The order in which the components are viewed on the particular order details screen 900 is defined in a “Disp” (display) column 2512. The user has the ability to define whether a component is mandatory via a checkbox 2516, requiring the component to be completed before the order can be confirmed. Checking an “Auto” checkbox 2520 causes the component to auto-execute without user interaction. A validation (Valid) column 2524 and an execution (Exec) column 2528 control the priority of the components for validation and execution on the particular order details screen 900. A “Prompt Text” field 2532 specifies the text that a user is presented at the top of the component's section on the particular order details screen 900.

Components fields are further defined through a “Details” button 2536, which navigates to a particular component field maintenance screen described below. Individual components will display as configured on the particular component field maintenance screen. This screen controls whether component fields are mandatory, non-editable, hidden, or will display default values on the particular order details screen 900. A “Delete” button 2540 enables deletion of a component from a particular code.

FIG. 66 shows an eligibility constraints screen 2600 for a particular code corresponding generally to the table shown in FIG. 15. Eligibility constraints limit the use of particular codes based on the type of constraint configured. The types of available constraints depend on the scope of the particular code. This section allows the user to define the constraints to be observed in applying the particular code in the orders module 112. The following constraints are currently available:

| | |
|---|---|
| Case Group | Allows the user to indicate whether the use of this particular |
| | code will be limited by case group. Leaving this section |
| | blank effectively allows all case types to have use of the |
| | order. |
| Action Group | Allows the user to indicate whether the use of this particular |
| | code will be limited by action group. This constraint can be |
| | used only if the scope for the particular charge is ‘party |
| | charge’ or “claim”. |
| Degree of | Allows the user to indicate whether the use of this particular |
| Offense | code will be limited by degree of offense. This constraint |
| | can be used only if the scope for the particular is ‘party |
| | charge’. |
| Offense Code | Allows the user to indicate whether the use of this particular |
| | code will be limited by offense code. This constraint can be |
| | used only if the scope for the particular is ‘party charge’. |
| Offense | Allows the user to indicate whether the use of this particular |
| Category | code will be limited by offense category. This constraint can |
| | be used only if the scope for the particular is ‘party charge’. |
| Motion Code | Allows the user to indicate whether the use of this particular |
| | code will be limited by motion (application) type. This |
| | constraint can be used only if the scope for the particular is |
| | ‘motion (application)’. |
| Party Type | Allows the user to indicate whether the use of this particular |
| | code will be limited by party type. This constraint can be |
| | used only if the scope for the particular is ‘party’. |
| State/ | State Ordinance Constraint (142048) |
| Ordinance | Allows the user to indicate whether the use of this particular |
| | code will be limited by State or Ordinance. This constraint |
| | can be used only if the scope for the particular is ‘party |
| | charge’. |

Case group and action group are preferred over case type and action code in order to facilitate consistent processing as case types and action codes are added over time. As long as the case type and action code are added to the appropriate group, the particular order code will be applicable.

Constraints are available on offense code, offense category, and state or ordinance on the action code for charges. Offense category is a user defined code table.

FIG. 67 shows a free text component of a particular component field maintenance screen 2700 for further defining component fields. The particular component field maintenance screen 2700 is invoked by activating the “Details” button 2536 on the particular code maintenance screen 2500. The top section of the particular component field maintenance screen 2700 displays the particular code, the component code, the key/token, and the particular scope. These values are not editable from the particular component field maintenance screen 2700 and are maintained on the particular code maintenance screen 2500.

A “Fields” section 2704 of the particular component field maintenance screen 2700 allows some field customization by the user. This section controls whether component fields are mandatory, non-editable, hidden, or will display default values on the particular order details screen 900 through the InCourt order module 206. The field name, type, and source list values have been defined for each component. These values are not editable or configurable by the user. A “Mand” (mandatory) checkbox 2708 enables the user to indicate that the field must be completed. A “No Edit” checkbox 2712 enables the user to indicate that the field is to be non-editable. A “Hide” checkbox 2716 enables the user to specify whether the field is visible or hidden on the order template. A “Prompt Text” field 2720 specifies a component field's label on the particular order details screen 900. Default values can be defined for component fields by entering values in a default value field 2724. Default values are limited to 250 variable characters. The data type of the default value field 2724 must match the data type of a component field type combo box 2728. When the default value field 2724 is populated, a default component key drop-down menu 2732 and a default field drop-down menu 2736 are disabled. The default value field 2724 is mutually exclusive with the default component key drop-down menu 2732 and the default field drop-down menu 2736; that is, only one default source can be defined here.

The default component key drop-down menu 2732 contains a list of the component key values defined on the particular code maintenance screen 2500. The menu displays all other component key/token values, except the current component key for the particular code being configured. When this field is populated, the default field drop-down menu 2736 is required. This field is mutually exclusive with default value field 2724 and mutually inclusive with the default field drop-down menu 2736. The default component key drop-down menu 2732 is formatted to display the key/token value with the component description in parentheses.

The default field drop-down menu 2736 contains a list of field names associated with the default component key selected via the default component key drop-down menu 2732. When a default component key is specified for a component field, the fields defined for the selected component become fields within the default field drop-down menu 2736. The default field drop-down menu 2736 contains the component code field name values for the component key selected in the default component key drop-down menu 2732.

If “Checkbox/Logical field” is selected via the component field type combo box 2728, the component field displays as a checkbox on the component on the particular order details screen 900. The user may set default ‘True’ and ‘False’ values for component fields of this type by indicating the values in the default value field 2724.

If “List” is selected via the component field type combo box 2728, the user can manually enter a default value via the default value field 2724 equal to the “code” value for the list item. If no default value is entered in the default value field 2724, the default component key drop-down menu 2732 displays on the component as a drop down menu containing the items from the code table or list. If a code pick table item is selected from the default field drop-down menu 2736, the “code” value from that table is used. If a user-defined list is selected from the default field drop-down menu 2736, the list item code value from the user-defined list is used. If the default field drop-down menu 2736 is from a pre-defined system list (SDL), the system-defined value is used. If a date field is selected from the component field type combo box 2728, the user may use a date formula to calculate default values for component date fields. Date formulas are based on either the order date (OD) or the subject date (SD) from the particular order details screen 900. Date formulas are not case sensitive and may not include blank spaces.

The sentencing component 1400 is specifically designed for use in the party charges section 716 of the anchor screen 700, and should be used only with particular codes having a scope of “party charge”.

The claim judgment component 1404 is specifically designed for use in the claims section of the anchor screen 700, and should be used only with particular codes having a scope of “Claim”.

The bail component 1408 is specifically designed for use in the one of the following sections of the anchor screen 700: the party charges section 716, the claims section, or the motions section 724, and should be used only with particular order codes having a scope set to whichever section it is to be used in.

The record event result component 1412 does require user configuration to execute properly during order confirmation. The record event result component 1412 applies the result code configured for the component to the event during order confirmation. As with the other components, the case management data structure 104 will be updated only when the order is confirmed. The record event result component 1412 auto-executes without user interaction and is not visible to the user from the particular order details screen 900.

As shown in FIG. 68, the record event result component 1412 applies the result code selected by the user from a drop-down menu that replaces the default value field 2724 to the event when the order is confirmed through the judicial management module 132.

The scheduled events component 1416 does not require any special setup to use the component through the judicial management module 132.

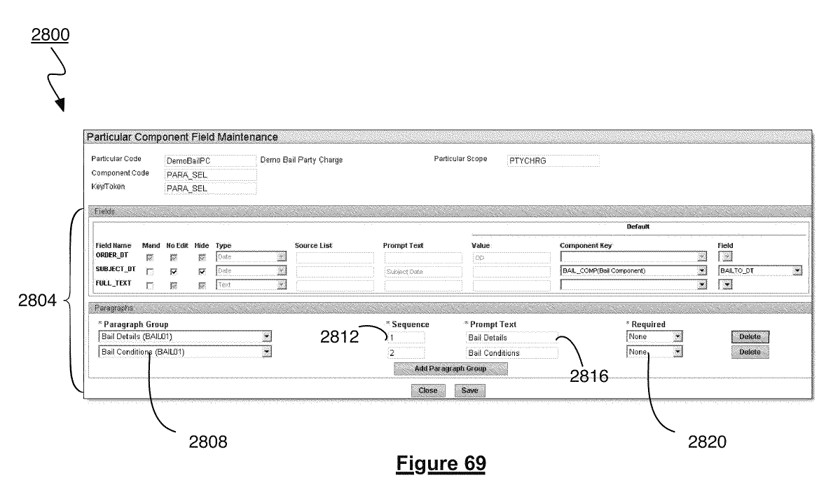

FIG. 69 shows the particular component field maintenance screen 2800 displaying an additional paragraphs section 2804 for the paragraph selector component 1424. Configuration of the paragraphs section 2804 is required for the paragraph selector component to display correctly on the particular order details screen 900 and generate text during order confirmation. The user can define each paragraph group that will be presented to the user on the particular order details screen 900 through the judicial management module 132. Paragraph group code setup is required to generate the drop-down menu items for paragraph groups fields 2808. Completion of configuration of this component requires set-up of this code.

When a paragraph group code is added, “Sequence” fields 2812, “Prompt Text” fields 2816 and “Required” fields 2820 in the paragraphs section 2804 become required. Unique paragraph group sequence values are required for each line item in the paragraphs section 2804.

The “Required” field 2820 determines the selection(s) required on the paragraph selector component 1424 on the particular order details screen 900 through the anchor screen 700 of the judicial management module 132. The drop-down menu values are defined as: “None”, “Exactly One”, “One or More”, and “All”.

The same paragraph group code may be assigned to multiple paragraph selector components for a particular order code; however, a paragraph group code cannot be assigned to the same particular component sequence multiple times.

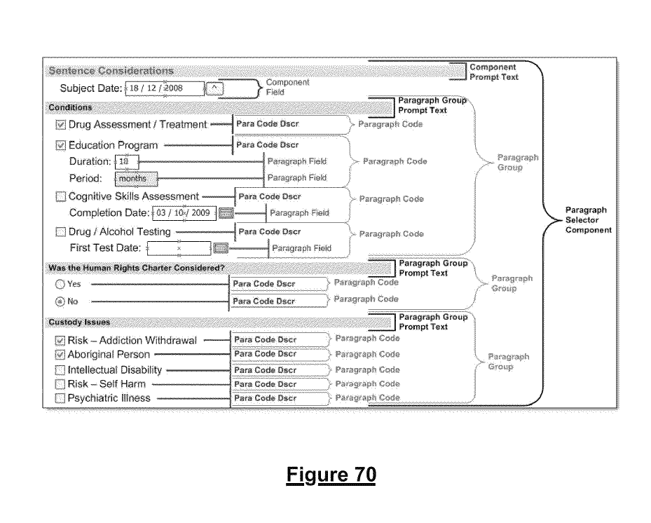

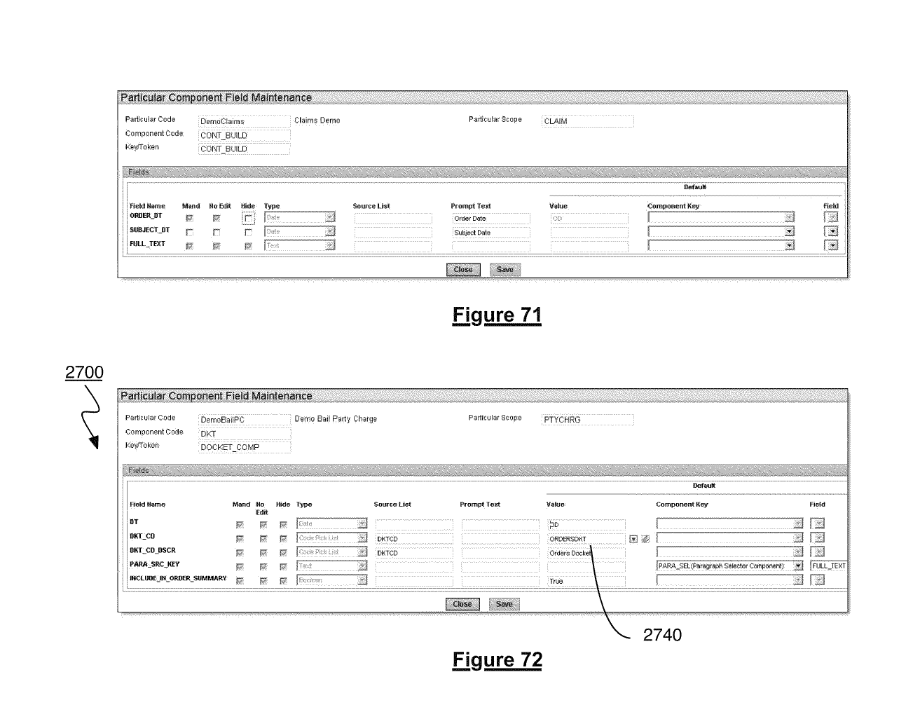

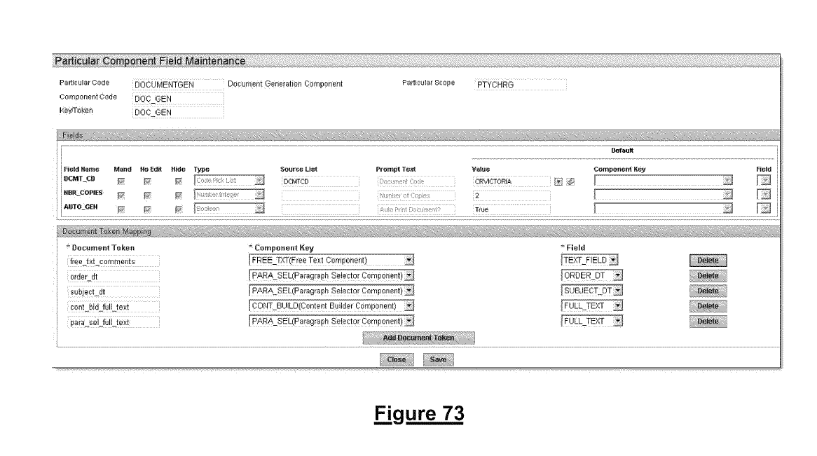

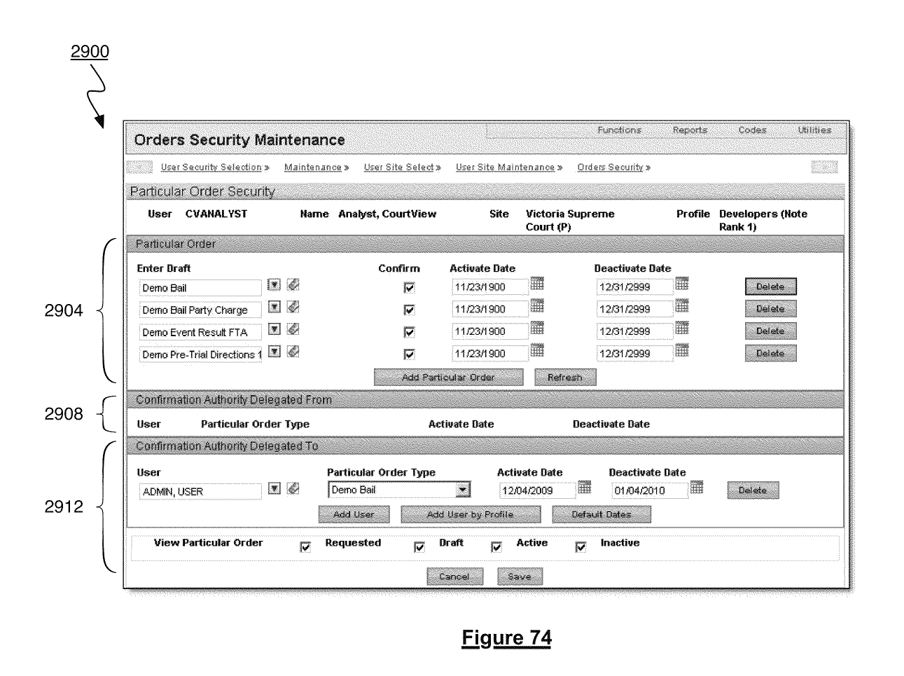

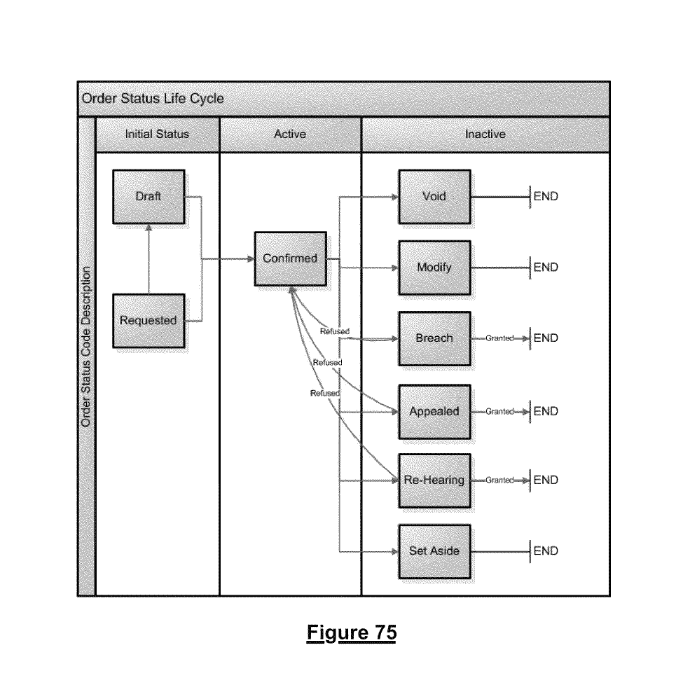

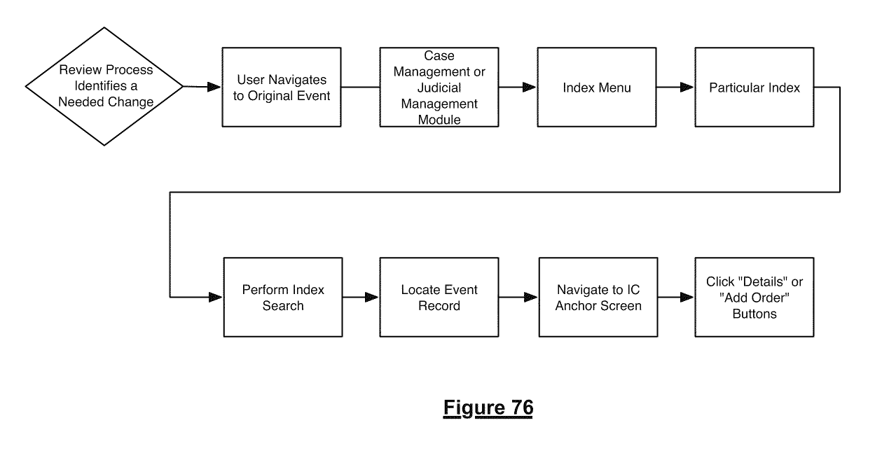

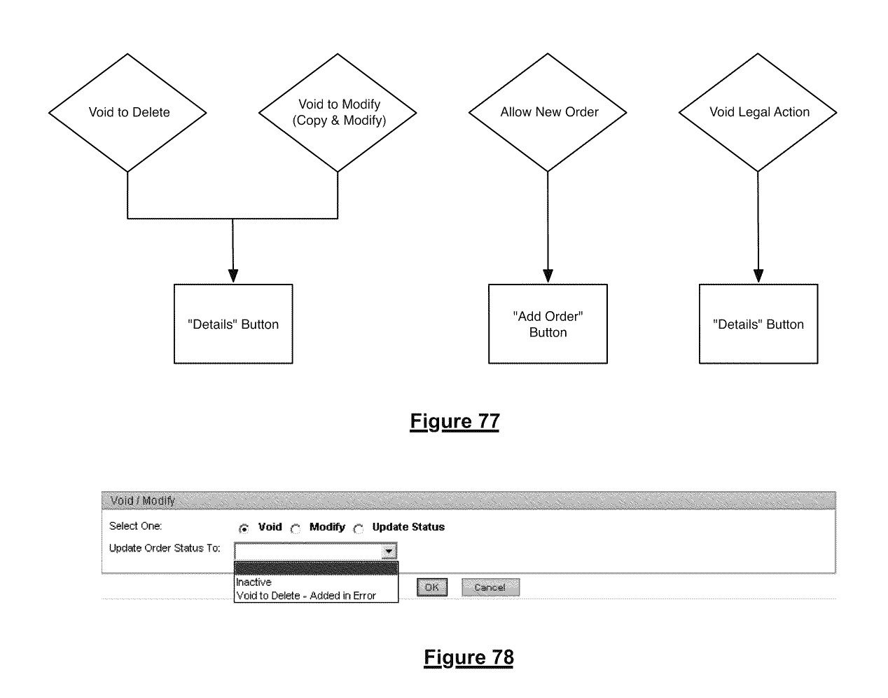

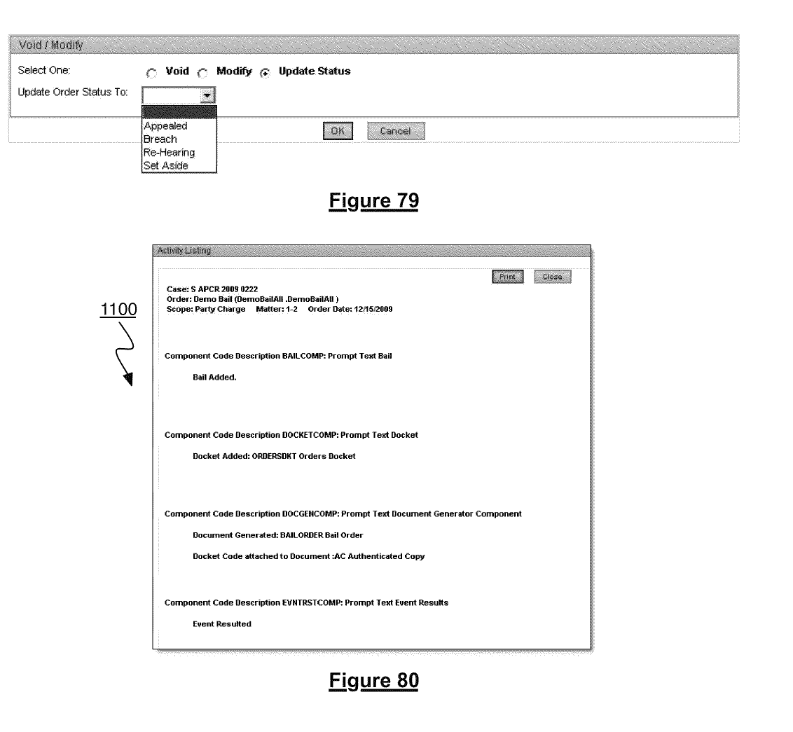

FIG. 70 shows a section of the particular order details screen for a paragraph selector component. This figure shows a breakdown of the setup of the paragraph selector component. This is a visual aid to users to help them understand how paragraph codes and paragraph group codes display on the paragraph selector component from the particular order details screen.

A validation step executes upon saving the particular component fields for the paragraph selector component when a paragraph group code has a paragraph code with a base component setup. That base component's scope is evaluated against the particular's scope.

FIG. 71 shows the particular component field maintenance screen 2700 for the content builder component 1428. The content builder component 1428 does not require any special setup on the particular component field maintenance screen 2700 to use the component within the judicial management module 132. Paragraph code setup is performed for this component to function correctly on the particular order details screen 900 through the anchor screen 700 of the judicial management module 132. Paragraph group code setup is also required to filter search results within the content builder component 1428.

The user may choose to default the subject date, either to a field in another component or by using a date calculation.

FIG. 72 shows the particular component field maintenance screen 2700 for the docket component 1456. The docket component 1456 does require user configuration to execute properly during order confirmation. The component creates the docket code configured for the component during order confirmation. As with the other components, the case management data structure 104 is updated only when the order is confirmed. This component auto-executes without user interaction and is not visible to the user from the particular order details screen 900.

Docket code setup is used to generate the menu items for the default value field 2740. Configuration of this component is not completed without this code setup.

The user can define default values for the docket date (DT) and docket code (DKT_CD) component fields. These values are required to create a new docket entry during order confirmation.

Linking to a text component is not required, as generation of docket text is optional for this component. If the component is linked to a text component to create docket text, the user can further specify whether the docket text should be displayed on the order summary screen within the judicial management module 132, by entering “True” in the INCLUDE_IN_ORDER_SUMMARY default value field 2724.

FIG. 73 shows the particular component field maintenance screen 2700 for a document generator component. The document generator component generates the document configured for the component during order confirmation. As with the other components, the document is generated only when the order is confirmed.

The document generator component auto-executes without user interaction and is not visible to the user from the particular order details screen 900.

Document code setup is required to generate the menu items for the default value field 2724. Configuration of this component is completed with this code setup. This component also requires other text components to exist for the particular order code, as this component links to the text components. This component is configured to execute after all text and docketing components to ensure that text is included in the generated document.

The user defines default values for the document code (DCMT_CD), the number of copies (NBR_COPIES), and auto-generate (AUTO_GEN) component fields. These values are required to create a document during order confirmation.

When a document token is added, the other fields (component key and field) in the document token mapping (DTM) section become required. Unique document token values are required for each line item in the document token mapping section. The DMT values function as merge fields and should be added to the forms generation document template accordingly.

FIG. 74 shows an orders security maintenance screen 2900 that allows the user to assign privileges for entering, confirming, and viewing orders to users of each site in the application. The user is also able to delegate authority to confirm orders from one user to another.

Delegation of confirmation authority for particular codes must take into account both users' privileges for case types; that is, a user receiving delegated authority for a particular code must have privileges for the case type of the case(s) on which they are confirming orders.

The user can grant draft and confirmation privileges to users in a “Particular Order” section 2904 at the top of the orders security maintenance screen 2900. Users have draft privileges to orders displaying in this section. For confirmation rights, the user can check the confirm checkbox. Activate and deactivate dates are required when confirmation rights are granted for an order.

Confirmation authority can be delegated from one user to another. Confirmation rights delegated to a user from another user will appear in a “Confirmation Authority Delegated From” section 2908. This section is read-only.

The user can delegate confirmation privileges from a user account being configured to another user account in a “Confirmation Authority Delegated To” section 2912. The user can indicate the user and the order rights that are to be delegated. Activate and deactivate dates for the period of delegation are required.

### Operation of the Judicial Orders Computer System

In order to better understand the computer system 20, its operation will now be described with respect to examples. A user navigates through the selection screens of the judicial management module 132 to access the appropriate anchor screen 700, where orders may be placed on a case. It is assumed that users have the proper orders security defined for the different orders they are creating and/or maintaining.

The process begins with the session selection screen 400 of FIG. 18.

The session selection screen 400 allows a user to search and select sessions. As previously noted, the search criteria section 404 allows searching by the session code, session date, start time, site, locality, location and judge associated to a session. The session date and site fields must be populated in order to conduct a search.

Upon entry to the session selection screen 400, the session date defaults to the current date. The site and locality fields are set to the default site and locality of the logged-in user, if the system parameter DEFAULT_SEARCH_LOCALITY for this screen has been configured for use, otherwise the locality field defaults as null. The site combo box displays only those sites to which the logged-in user has security access. The locality combo box allows the user to select from all the localities in the system, but is not a required search field. The judge field is a type/tab field that can be cleared using the eraser widget next to it.

Once the user hits the search button 408, results are displayed in the search results section 412. A separate row is displayed for each search result that has a unique session block identifier. When the user selects a record from the search results, the “Details” button 420 and the “Cases” button 424 become activatable.

Activating the “Details” button 420 displays the session details screen 500 of FIG. 19. The session details screen 500 allows for staff to be checked in for the session. Upon initial presentation of the screen, all staff attached to the session block are shown as unchecked. Staff may be checked individually or checked and unchecked as a group via a “Select All” button 504 and a “Deselect All” button 508 respectively. An “Add” button 512 allows a new staff record to be added to the session. A save button 516 stores the checked-in records and returns to the session selection screen 400.

The case selection screen 600 of FIG. 20 is accessed from the judicial management module 132 and is opened by selecting an event session record and the “Cases” button 424 on the session selection screen 400. The case selection screen 600 displays all the cases and events associated to a particular session, location and judge and provides the ability to search on the events and cases within the session. This allows the modification and creation of link records for the session block records listed in the search results area of the case selection screen 600.

The information section 604 includes the event session, name, date, time, location and judge. The search criteria section 608 has several fields that filter the selections available by events in the session passed in. These are: event, event group, party type, case number, name, sort by, and prosecuting attorney. The event and event group search fields are mutually exclusive; also one or the other must be populated with a value.

The “Sort by” field 620 has two options: (a) case number, which sorts by case number and party within case number; and (b) not checked in, which displays all cases that have any event participants that have not yet appeared. The selections available for three search criteria field entries, order status, stage and sub stage do not filter by the event/session data selected but will only retrieve cases within the selected event session.

The include priority checkbox 688 is, by default, checked and allows for retrieving cases that have been assigned a priority. These cases are listed grouped together first in the search results section 616. If the include priority checkbox 688 is unchecked then another search criteria is used to conduct a search. The include resulted checkbox 692 allows cases with resulted events in the selected session to be retrieved and displayed in the search results section 616.

The update case section 612 of the case selection screen 600 allows records in the search results section 616 to be modified. The user may populate the stage combo box 624, the sub stage combo box 628, an attorney appearance combo box 676, and other fields in the update case section 612 with values that modify their respective fields in the user-selected rows (with checkbox selected) in the search results section 616 when the user presses an update button 644.

The user may further filter this update process by selecting the checkboxes in each row of the search results as follows, then pressing the update button 644:
select the left-most checkbox 652 to update the stage and sub stage fields 656 and 660 in the search results section 616 from the stage and sub stage fields 624, 628 in the update section 612;
select an apply checkbox 672 next to an attorney combo box 676 allows the attorney to be applied to that party from the attorney appearance combo box 676 in the update case section 612;
select a checkbox 680 next to an other field 684 in the search results section 616 to allow the other field 684 to be applied to that party from an other field 640 in the update case section 612.

All existing attorney appearance or other entries are bumped down a row to display the newest entry on top.

The stage combo box 624, the sub stage combo box 628, the attorney appearance combo box 676 and the other field 640 in the update case section 612 and the apply checkbox 672 and the other checkbox 680 in the search results section 616 are cleared after the update button 644 is activated.

The attorney appearance combo box 676 and other entries can be cleared by using an eraser widget next to each field. The attorney appearance combo box 676 can also be updated by using an adjacent down arrow in the search results section 616 to open an attorney selection screen for attorney selection. This field is a type/tab field. The other field is a free text field and can be updated in the search results section. Both of these fields are additive, i.e., multiple values may be added to each party/participant on cases.

Changes made via the update case section 612 or the search results section 616 to the rows in the search results section 616 for a case are stored when the user activates a save button 696. This restores case number hyperlinks in the search results section 616.

Once the user is ready to open a case, they may click on the case number hyperlink 668 to take them to the appropriate anchor screen 700, where they may add and maintain orders, or do other updates.

Referring again to FIG. 21, there are two anchor screens 700, for charge-based and non charge-based case types. The anchor screen 700 is defined for the case type in case type setup, and it is the principal screen from which orders are maintained on a case. The screen is accessed from the judicial management module and is opened by selecting an event session record and the “Cases” button 424 on the session selection screen 400.

New orders may be entered in the parties section 712, the party charges section 716, the claims and party claims sections (not shown in FIG. 21, but present when a civil case is represented), the motions section 724 and the case orders section 728.

The Maintain Orders section is where users may view, edit, validate, and confirm orders on a case.

When referring to an order's scope, it relates directly to which section(s) on the anchor screen 700 the order may be applied. For example, if a particular code has a scope of “Party Charge”, then it may only be applied to charges in the party charges section 716 of the anchor screen 700. If it has a scope of “All”, then it may be applied to any of the sections on the anchor screen 700.

The particular code dropdown selection is filtered by the scope of the order relating to the section where the dropdown is located; i.e., the scope applicable for the order being selected, the case group and the effective date range of that particular code. When attempting to select back an invalid or inactive code the following error message will display: “The following invalid or inactive Particular Codes have been removed: <particular code>”. Clicking on the Ok button to close the pop up returns focus to the previous screen.

The event notes section 704 and the case notes section 708 of the anchor screen 700 allow the user to quickly add and review any notes posted for the event and/or case.

Referring again to FIGS. 21 and 23, by default, the parties section 712 is collapsed upon presentation of the anchor screen 700. Once expanded, all parties associated to the event are displayed in the parties section 712 of the anchor screen 700. The user may check in parties, record attorney appearance, and enter orders on parties. Particular codes in the parties section 712 must have a scope of “Party” or “All”. To add an order to a party, the user can first click the title bar of the parties section 712. The anchor screen 700 refreshes and an orders combo box 740 and checkbox 744 next to the party will be visible. Particular codes may be manually entered in the orders combo box 740 (this field is a type and tab field), or by clicking the pull-down arrow at the right. If the arrow is selected, or the value entered in the orders combo box 740 applies to more than one particular code, then the user may select one code from the particular code selection screen 2400.

Multiple orders may be applied to any of the parties, however, if the same particular code is applied more than once to the same party, it must be differentiated from the others by manually typing a dot “.” and an extension to the particular code, e.g., BAIL.1, PROT.abc, HABEU.S.AUG, etc.

Once order(s) have been entered for one or more parties, users may enter additional information on each order by pressing a details button 746 in this section, which will call the particular order details screen 900 sequentially for all of the orders entered in this section.

As previously noted, both the criminal and civil versions of the anchor screens 700 are identical with exception to the associated matters. The criminal screen has a party charges section 716, while the civil version has a claims section 748.

Referring again to FIG. 24, the user may enter two types of orders in the claims section 748: claims, which relate to a matter on the case associated to the event, and party claims, which relate to a party to a specific claim associated to the event on the case. There are two ways to enter claim orders:

(a) one claim at a time in a claim orders pull-down field next to a claim particular codes may be manually entered in the orders pull-down field (this is a type and tab field), or by clicking the pull-down arrow at the right; and
(b) multiple claims at one time in the orders pull-down in a multi-claim order entry section (as shown in FIG. 24), by manually entering or selecting the particular code in an order 3004, then enter the claim number(s) in a “Apply to Claim Number” field 3008. Multiple numbers are separated by commas or hyphens to denote a range; e.g., claim numbers 1 through 4 can be represented as “1, 2, 3, 4” or “1-4”.

A user can also select an “Apply To” claim from an “Apply to Description” pull-down, which will apply the particular(s) to all claims on the case matching the selected description.

Multiple orders may be applied to any of the claims. If the same particular code is applied more than once to the same claim, however, it must be differentiated from the others by manually typing a dot “.” and an extension to the particular code, e.g., CLCLM.1, PROT.abc, HABEU.S.AUG, etc.

The user can then activate an update button 3012 to apply the particular(s) to the designated claim(s). The user may apply orders to one or more claim parties on the case by using the orders pull-down next to the claim parties in the same section as claim orders. These orders have a scope of “Party Claim”, instead of “Claim”.

Once order(s) have been entered for one or more claims or party claims, users may enter additional information on each order by pressing one of two details buttons 3016, 3020 in this section, which will call the particular order details screen 900 sequentially for all of the orders entered in this section. The claim judgment component 904 is specifically designed for this section. The two details buttons 3016, 3020 correspond to claim orders and party claim orders respectively.

Returning again to FIG. 25, the party charges section 716 is present on the anchor screen 700 for criminal cases. Users may enter orders for any of the charges on the case associated to the event. Particular codes in the party charges section 716 must have a scope of “Party Charge” or “All”.

There are two ways to enter party charge orders:

(a) one charge at a time in a charge orders pull-down field next to a charge particular codes field, or by clicking a pull-down arrow at the right;
(b) multiple charges at one time in the orders pull-down field 3024 (this is a type & tab field) in the multi-charge order entry section (as shown in FIG. 25) by manually entering or selecting the particular code, then enter the charge number(s) in a “Apply to Charge Number” field 3028. Multiple numbers are separated by commas or hyphens to denote a range; e.g., charges 1 through 4 can be represented as “1, 2, 3, 4” or “1-4”.

A user can also select the “Apply To” charge from the “Apply to Description” pull-down, which will apply the particular(s) to all charges on the case matching the selected description.

Multiple orders may be applied to any of the charges. If the same particular code is applied more than once to the same charge, however, it must be differentiated from the others by manually typing a dot “.” and an extension to the particular code; e.g., BAIL.1, PROT.abc, HABEU.S.AUG, etc.

The user can then click an update button 3032 to apply the particular code(s) to the designated charge(s). Once order(s) have been entered for one or more party charges, users may enter additional information on each order by pressing a details button 3036 in this section, which calls the particular order details screen 900 sequentially for all of the orders entered in this section.

There are two components that are specifically related to the party charges section 716: the sentencing component 1400 and the bail component 1408.

Referring again to FIG. 27, orders can also be entered for motions associated to the event or at a case level. To enter motion orders, there must be at least one motion on the case already associated to the event. The user may enter one motion at a time in an orders pull-down field 3040 (this is a type and tab field) next to a motion particular code 3044, or by clicking a pull-down arrow at the right. Particular codes in this section should have a scope of “Motion” or “All”.

Once orders have been entered for one or more motions, users may enter additional information on each order by pressing a details button 3048 in the motions section 724, which will call the particular order details screen 900 sequentially for all of the orders entered in this section.

Case orders may be entered at the case level as there is no association with any parties or matters on the case. Case orders have a scope of “Case” or “All”, and are entered in the same way as particular codes in the other sections. The user may enter case orders one at a time in an orders pull-down field 3052 in the case orders section 728. Particular codes may be manually entered (this is a type and tab field), or by clicking the pull-down arrow at the right. Once one or more order(s) have been entered into the case orders section 728, users may enter additional information on each order by pressing a details button 3056, which invokes the particular order details screen 900 sequentially for all of the orders entered in this section.

Orders can be added to an event in any of the following sections: the parties section 712, the party charges section 716, the claims section 748, the party claims section, the motions section 724, or the case orders section 728.

Referring again to FIG. 26, the maintain orders section 720 is devoted to summarizing the orders entered in the various sections of the anchor screen 700. The user is presented with a list 3060 of all the orders that exist on the event indicating the scope of each order, the status, and confirmation date. This section links to the particular order details screen 900 and an order summary screen 800. This section is also where the user can delete, validate, and/or confirm draft orders for the event, as will be discussed below. Users may select a details button 3064 in the maintain orders section 720 to access the particular order details screen 900 where specific information on the order may be entered and maintained. Selecting the details button 3064 also saves the data that exists on the anchor screen 700. The difference between maintaining orders in the maintain orders section 720 and the other sections is that the details button 3064 in this section allows access to just the order on that row, rather than all orders for a section of the screen. An order summary button 3068 accesses the order summary screen 800 to view the text for all existing orders if the components are set up to display their fields in the particular order details screen 900. A validate button 3072 executes the save process and then performs both the eligibility and completion validation processes for all existing orders on the event.

The state of each order is determined by the results of the validation processes. Icons 3076 to the left of each order in this section (and to the right of each order pull-down in the other sections) are a visual indicator of the state. There are two possible states: (a) an icon with a box and a check will appear when all orders are validated without an error; and (b) an icon with a red circle and a white line will appear when an error has occurred on an order. One important difference between the icons in the maintain orders section 720 and the icons in the other sections is that the icons in this section refer to the state of the order for a group of parties or matters, where the icons in the other sections refer to individual parties or matters.

A confirm button 3080 performs the eligibility and completion validation processes and attempts confirmation for all existing orders on the event, performing any updates appropriate to the particular orders being confirmed. All orders must pass validation before the confirmation process will complete successfully. Once orders are confirmed, the screen is locked down and displays in a read-only mode. All buttons are disabled except the details button 3064, an add order button and an edit button that become visible after the order is confirmed. User security controls the editing of the event and/or any modification of orders after confirmation. The particular order details screen 900 is assessable in a read-only mode as well, after confirmation. The lock icon displays on the particular order details screen 900.

Referring again to FIG. 28, the bottom two sections of the anchor screen 700 are devoted to the event in which the user is working. These sections allow the user to link and schedule future or subsequent events, to record event timing information for the current event, and to enter the actual duration of the event.

Referring again to FIG. 30, the orders summary screen 800 is a summarization of the substance of all orders currently on the event that is being maintained in the anchor screen 700. The save process is executed before the order summary screen 800 displays. The text in the summary is compiled from the XML used to create the orders, and is also displayed in the docket text of all components in those particular codes, once the orders are confirmed. The docket text only displays when the display on summary flag is checked.

The order summary screen 800 displays orders in the following sort order: (a) by particular code; and (b) by party/matter number. The information displayed includes the particular code and description, the scope and party/matter number, and all paragraphs and fields contained within the components of the order particulars. The information displayed also includes all text components of the orders on the event; that is, from the paragraph groups component, the content builder component, the free text component and the text from all dockets flagged as “include in order”.

Referring again to FIG. 31, the particular order details screen 900 serves as a maintenance screen for pending/draft orders and will display the setup defined for each order. Components display as configured on the particular order code setup. The order in which components are viewed on the details screen is configured as part of the setup of the particular order code. The user has the ability to define from the particular code maintenance screen: whether a component is mandatory, which requires the component to be completed before the order can be confirmed; whether a component “auto” executes without user interaction; separate display (Disp), validation (Valid), and execution (Exec) sequences, which control how the component is viewed, validated, and executed on the particular order details screen 900; and the prompt text the user is presented at the top of a component's section on the particular order details screen 900.

The top section 916 of the particular order details screen 900 includes basic order data and status. Order components are displayed beneath the top section 916 in the order defined on the particular order code setup.

Referring again to FIG. 32, the top section 916A indicates that the order is in a “Draft” state, which means the order is open for editing and has not been confirmed.

FIG. 33 illustrates the top section 916B once an order is confirmed. Once confirmed, additional changes cannot be made to the order. The save and validate buttons 920 and 924 are disabled. Users with the appropriate view privileges may view the particular order details screen 900 in a read-only mode. A user with appropriate security may maintain (void or modify) an order by selecting the edit button 928.

FIG. 35 shows the top section 916C once an order has been modified.

FIG. 36 shows the activity listing box 1100 that is created to provide the user with a list of all the transactions that occurred when the order was originally confirmed.

This provides an audit trail for the user and allows the user to take any necessary case management actions to maintain the case records.

Referring again to FIG. 31, an example of the Order Details screen with components is shown. The components display in the order configured on the setup for the particular order code shown in FIG. 65. This example displays the claim judgment component 904, the paragraph selector component 908, and the free text component 912. The user maintaining the order must complete all of the required fields in those components that have required paragraphs and/or fields, in order to be successfully validated. Requirements are detailed in the respective components.

Users may validate orders from this screen as well as the anchor screen 700. In this case, a validate button 944 only validates the order on the screen, instead of all orders like on the anchor screen 700.

When the user navigates to the particular order details screen 900 from the anchor screen 700, and activates the validate button 944, it triggers execution of completion validation, logging of error messages, updating the particular status, and saving of the data entered as XML draft order. If the order is confirmed or inactive, the validate button 944 will be disabled or not visible.

The user may press a save button 948 to save the particular details. If the particular order details screen 900 was called from the anchor screen 700, pressing the save button 948 executes completion validation, logs error messages, updates the particular status, and saves the data entered as an XML draft order. The user is then returned to the anchor screen 700.

If the order is confirmed or inactive, the save button 948 will be disabled or not visible. The user may press a next button 952 to save the particular details, and bring up the next order within the screen area (if one exists), if the particular order details screen 900 was called from the party, party charge, claim, party claim, motion, or case sections of the screen. When clicked, the next button 952 executes completion validation, logs error messages, updates Particular status, and saves the data entered as XML draft order.

If the user navigates to the particular order details screen 900 from the maintain orders section 720 of the anchor screen 700, the next button 952 should be disabled or not visible. An edit button 956 is enabled after the order has been confirmed, and is used to void or modify the order. A close button 960 closes the particular order details screen 900 without saving any of the data entered on the screen and returns the user to the anchor screen 700.

### Eligibility, Consistency, and Completion Validation

### Eligibility Validation

Eligibility validation is like the use of business rules for determining what particular codes can be applied to which areas of the screen. An eligibility validation process has been created to validate particular codes entered on the anchor screen 700. When entering or selecting a particular code, the anchor screen component's own scope will govern which particular codes are made available from the particular code selection screen 2400. The eligibility validation process validates the particular code based on the eligibility rules configured for the individual particular code. Those eligibility attributes can include case group, action code group, offense code, offense category, action code ordinance, party type, and motion code. The eligibility validation process is called when adding a particular code to any orders field on the anchor screen 700. This occurs when tabbing out of the orders pull-down list or selecting a particular code from the pull-down. The eligibility validation process is also called when selecting validate, save or confirm on the anchor screen 700 or selecting validate on the particular order details screen 900.

The particular code drop-down selection is filtered by the scope of the order relating to the section where the drop-down is located; i.e., the scope applicable for the order being selected, the case group and the effective date range of that particular code. When attempting to select back an invalid or inactive code the following error message will display: “The following invalid or inactive particular codes have been removed: <particular code>”. Clicking on the ok button to close the pop up returns focus to the InCourt screen.

The user's orders security is evaluated as part of the overall validation process. If the user does not have security to enter a draft order for the particular code they are attempting to apply to an area of the screen, a warning message will be generated on the anchor screen 700.

When a particular code passes validation, the anchor screen 700 displays a green “OK” icon next to the orders pull-down. This symbol first appears when a particular code passes eligibility validation. This state may change after the user performs completion validation; for example, they may have entered a particular code in an orders pull-down, which would have been eligible for where it was entered, but then have not completed required fields in the particular orders details screen 900. This is detected when they press the validate or confirm buttons, or enter the particular order details screen 900, and then not fill out the required fields.

The symbol for an invalid particular code is a red “Stop” icon. No orders on the same event may be confirmed if any one particular code is invalid. In general, an ineligible particular code is blanked out of the orders pull-down where it was entered, and the message text of the invalid particulars will display at the top of the anchor screen 700 for the invalid particular code(s).

### Consistency Validation

Consistency validation can be described as business rules for determining what criteria must be present on a case before a given particular code can be considered valid. Orders can be saved in draft status with errors but mandatory requirements must be satisfied before an order can be confirmed. Consistency validation can be applied to a particular code relating to previous orders, dockets, alerts, and a party's custody status on the case. Refer again to FIG. 17B for examples of consistency validation.

For previous particular codes, the rule may specify a positive requirement (allow), a negative requirement (deny), or allow the particular but warn the user that the previous particular exists on the case. The rules can be refined to allow, deny, or warn if an active (confirmed) order exists on the same matter (charge, claim, or motion) as the particular being added, or it can be applied to any matter on the case having the same scope as where the particular is being added, both are evaluated across all events on the case. The same tests can be applied for draft orders as active orders.

For previous docket (caselog) codes, the rule may specify a negative requirement (deny), or allow the particular but warn the user that the previous docket exists on the case.

For previous alert codes, the rule may specify a negative requirement (deny), or allow the particular but warn the user that the previous alert exists on the case. An alert code is a way of placing a warning on a party for a given case; e.g., a defendant can have a bench warrant issued on a traffic case, or a bad check alert on a civil case. Particular codes can be configured to validate the alert code for the party on the case, or the identity (the record describing the person) which may have the alert regarding another case. This also applies to orders where the scope is party charge, party claim, or claim, if the party related to those matters has an alert or their identity has an alert on another case.

For custody status, the rule may specify a negative requirement (deny), or allow the particular but warn the user that the party to whom they are adding the particular is in custody on the case. This also applies to orders where the scope is party charge, party claim, or claim, if the party related to those matters is in custody. This attribute can be turned on or off for each particular code; i.e., the custody indicator can be evaluated (or not) for the given particular code.

The consistency validation process is called when selecting validate, save, or confirm on the anchor screen 700 or selecting validate, save, or next on the particular order details screen 900. The consistency validation process applies rules as configured for the individual particular code. When particulars pass completion validation, the green “ok” icon displays next to the orders pull-down, as it does in eligibility validation. When particulars fail completion validation, the red “stop” icon displays next to the orders pull-down, and the related error message appears in the particular order details screen 900.

### Completion Validation

Completion validation can be described as business rules for determining what particular code's components or parts of components of must be completed for an order to be considered valid. Orders can be saved in draft status with errors but mandatory requirements must be satisfied before an order can be confirmed.

The completion validation process is called when selecting validate, save, or confirm on the anchor screen 700 or selecting validate, save, or next on the particular order details screen 900. The completion validation process applies rules as configured for the individual components of a particular code. The completion rules may indicate mandatory requirements, such as a field must be populated, a paragraph code selected or a component must be completed. Refer again to FIG. 17A for examples of completion validation.

When particulars pass completion validation, the green “OK” icon displays next to the orders pull-down, as it does in eligibility validation. When particulars fail completion validation, the red “Stop” icon displays next to the orders pull-down, and the related error message appears in the particular order details screen 900.

### Maintaining Orders

The majority of orders have a simple life cycle. They are entered as draft or requested orders, and maintained as draft orders. During this time, an order can be modified or deleted without any impact to the case it has been placed on, because the actions contained in the order do not occur until the order is confirmed.

FIG. 75 illustrates the various possible states of an order's life cycle. An order can be freely modified while in a draft or requested status, but once it is confirmed, it requires special processing before it can be modified or revoked.

FIG. 76 illustrates a path to navigate to existing orders. If the user does not already have the original event open on the anchor screen 700, the suggested navigation path for locating a previously confirmed or closed out event would be through the case management module 108 or the judicial management modules.

Returning again to FIG. 37, the particular index screen 1200 provides the user with the ability to search for orders across sessions, case types, and date ranges. In order to initiate a search, the user enters one of the following in a search criteria section 1204: case number, particular date range, or confirmed date range.

A search results section 1208 includes the following columns for the search results: case number, judge, particular date, event type, date confirmed, primary party and secondary party. No column displays for particular order. Multiple occurrences may be displayed for each case number/event type if multiple particulars (orders) exist on the case.

Using the filtering provided in the search criteria section 1204, the particular index screen 1200 can display an order history and provides an audit trail of orders entered on case(s). Orders that have been modified will be displayed as well.

The user may view or, with appropriate security, use this screen to navigate to the anchor screen 700, where they may maintain (i.e. void or modify) orders. Hyperlinks in the search results section 1208 take the user to the anchor screen 700 for that order.

The particular index screen 1200 is also available as a dynamic link in the orders section 1300 of the anchor screen 700. When accessing the particular index screen 1200 from the orders section 1300 of the anchor screen 700, the case number is pre-populated in the particular index screen 1200 case number field.

Another method of navigating directly to an order is via the orders section 1300 of the anchor screen 700 in the case management module 108. The anchor screen 700 includes an orders section 1300 shown in FIG. 39 for viewing existing orders and a hotlink to the anchor screen 700. This section appears below the case schedule section and above the docket entries section of the screen. The orders section 1300 remains collapsed and inactive if no records exist. The orders section 1300 displays orders in ascending particular header date order. If multiple records exist with the same particular header date, then a secondary sort will be in ascending order by particular detail sequence. The judge, locality, event type and matter information associated with the particular record are displayed. The particular order code appears as a hotlink to the appropriate anchor screen 700.

### Void Processing

Before confirmation, pending orders can be modified or deleted. As the pending orders exist in the screens of the judicial management module 132 or the XML store, they do not affect the case management data structure 104, so they can be modified or deleted without implication for the case management data structure 104.

Voiding an order is the process of changing a previously confirmed order to an inactive status and addressing actions that occurred when the order was confirmed and any additional follow on actions necessary.

Once an order is confirmed, additional changes cannot be made to the order. There are two scenarios where changes have to be made to a confirmed order and, consequently, to its follow on actions. These two scenarios shall be referred to as a void correction and a void legal action.

FIG. 77 shows the navigation paths a user may take when voiding orders. The path may vary slightly depending on the action to be completed.

The void correction scenario is when an error has been made on the order, and the order was confirmed without discovery of the error so that is has to be corrected after confirmation. For example, the order was made on the wrong case or the wrong amount was entered on the order. In this scenario the original order is deemed to no longer be a valid order and a record is kept for audit purposes only. Another assumption is that corrections are generally made in close proximity to the original order and that little, if any, activity would have occurred but the evaluation process will be complete in addressing all validations.

There are three process paths associated with a void correction:

(a) void to delete: void an existing order without replacing it with a newly modified one;
(b) void to modify: modify an existing order by making a copy of the original order as a starting point and creating a new order to replace the original; and
(c) add new order: an order was left off the event by mistake and needs to be added after the event has been confirmed or closed out.

These paths are used in conjunction with each other to correct multiple problems. For example, an incorrect order may have been added to the original event. The user would need to delete the incorrect order using the void to delete process and then add the new correct order using the add new process path. Under both assumptions, the user needs the ability to add a new order to a previously confirmed event.

The void legal action scenario is when subsequent activity results in the need to change an order legally. For example, when a breach is proven or an application to vary is granted. In this scenario the original order is still a valid order, it has just been superseded and will not continue to be enforced.

These scenarios are different in user perception and presentation but share a good deal of processing behind the scenes. In all cases, a complete audit trail will be maintained of any changes to a confirmed order and the follow on actions that occurred when the order was confirmed. The differences in the scenarios will be in how the user makes the change, whether the change is stored as part of the original order or as a new order, the degree of visibility of the changed order, and the exact follow on actions that occur. The process of reversing the impact of a component depends on what database activity the component executed upon confirmation of the order. Different values, such as status codes, may be used depending on whether the change was the result of a correction or a subsequent legal action.

Referring again to FIG. 33, the top section 916b of the particular order details screen 900 is shown for a confirmed order. The save button 920 and the validate button 924 are disabled in the confirmed order example below. A user with appropriate view privileges may view the particular order details screen 900 in a read-only mode. A user with appropriate security may maintain (void or modify) an order by selecting the edit button on the particular order details screen 900.3 A user with the appropriate security may modify an order by clicking the edit button 928 on the particular order details screen 900. The user is presented with the following modification options shown in FIG. 34:

### (a) Void (Void Correction—Void to Delete);

### (b) Modify (Void Correction—Void to Modify); and

### (c) Update Status (Void Legal Action).

Selecting “Void” deletes the order; this is referred to as “void to delete”. However, the order is not removed; it is simply marked as “inactive” with a corresponding “inactive” or “void to delete” status as shown in FIG. 78.

Selecting “Modify” makes a copy of the existing order as a starting point. The original order is marked as “inactive” with a corresponding “void to modify” status. The newly copied order is added to the case in “draft” status. The user may make any modification necessary to the new draft order.

FIG. 79 shows a pop-up presented after selecting “Update Status”. Selecting “Update Status” enables updating of legal actions and does not require the event or order to be reconfirmed to save a status change.

After an order has been modified by either a “void to delete” or “void to modify” process, and that modification is confirmed, the original order has reached the end of the life cycle for that version of the order; no additional modifications or changes can be made.

The save button 932, the validate button 936, and the edit button 940 are disabled as shown in FIG. 35 once an order has reached the end of its life cycle.

FIG. 80 shows an activity listing box 1100 that is created once an order has been modified. The activity listing provides the user with a list of all the transactions that occurred when the order was originally confirmed. This provides an audit trail for the user and allows the user to take any necessary case management actions to maintain the case records.

While the computer system in accordance with the above-described embodiment is a single physical computer, it will be appreciated that the computer system can include two or more physical computers in communication with each other. Further, the physical computers can be located locally on a local area network, or remotely. Similarly, the data stored by the computer system can be distributed over a number of computer systems. For example, the case management data structure can be stored in a distributed database.

The computer system can provide the functionality that is provided by a client computer in the above-described embodiment.

While it may be beneficial in some circumstances to store the data for draft orders in the case management data structure, this data can be alternatively stored outside of the case management data structure.

Computer-executable instructions for implementing the system and method for providing judicial orders could be provided separately from the computer system, for example, on a computer-readable medium (such as, for example, an optical disk, a hard disk, a USB drive or a media card) or by making them available for downloading over a communications network, such as the Internet.

One or more portions of the method may be executed by third parties. For example, a first party could develop components to be used by a user interface developed by a second party.

The above-described embodiment is intended to be an example of the present invention and alterations and modifications may be effected thereto, by those of skill in the art, without departing from the scope of the invention that is defined solely by the claims appended hereto.

What is claimed is:

1. A system for providing judicial orders, comprising:
storage;
case management data stored in said storage;
components stored in said storage, said components comprising a set of controls that are related, at least some of said controls providing access to said case management data structure; and
a user interface for defining judicial order templates by selecting said components included in said judicial order templates, said judicial order templates being used to create orders.

2. The system of claim 1, wherein said user interface enables configuration of said controls.

3. The system of claim 2, wherein each of said components has a scope attribute specifying the applicability of said component.

4. The system of claim 1, wherein said order templates have defined scopes.

5. The system of claim 1, wherein data for confirmed orders is saved in said case management data structure.

6. The system of claim 1, wherein data for draft orders is saved separate from said data for said confirmed orders.

7. The system of claim 1, wherein default values are established for at least one field of said order templates.

8. The system of claim 1, wherein fields of said order templates can be flagged as mandatory.

9. The system of claim 1, wherein fields of said order templates can be flagged as hidden.

10. The system of claim 1, wherein said first user interface enables the definition of rules governing the use of said order templates.

11. The system of claim 1, wherein said order templates are populated in said second user interface with data from said case management data structure related to a case and/or event for which an order is being generated.

12. The system of claim 1, wherein at least one of said components enables pre-defined text paragraphs to be inserted into an order.

13. The system of claim 1, wherein said user interface enables selection and insertion of said components into an order template.

14. The system of claim 13, wherein said user interface enables specification of the order of display of said components in said order template.

15. The system of claim 6, wherein, upon confirmation of said draft orders, the data from said draft orders is saved in said case management data structure.

16. The system of claim 15, wherein said system restricts confirmation of said draft orders based on privileges of a user using said system.

17. A method for providing judicial orders, comprising:
providing a set of components in storage of a computer system, said components comprising a set of controls that are related, at least some of said controls providing access to case management data structure;
providing a user interface for defining judicial order templates by selecting said components included in said judicial order templates, said defined judicial order templates being used to create orders.

18. The method of claim 17, wherein said user interface enables configuration of said controls.

19. The method of claim 18, wherein each of said components has a scope attribute specifying the applicability of said component.

20. The method of claim 17, wherein said order templates have defined scopes.

21. The method of claim 17, wherein data for confirmed orders is saved in said case management data structure.

22. The method of claim 17, wherein data for draft orders is saved separate from said data for said confirmed orders.

23. The method of claim 17, wherein said user interface enables the definition of rules governing the use of said order templates.

24. The method of claim 17, wherein said order templates are populated by said computer system with data from said case management data structure related to a case and/or event for which an order is being generated.

25. The method of claim 17, wherein at least one of said components enables pre-defined text paragraphs to be inserted into an order.

26. The method of claim 17, wherein said user interface enables selection and insertion of said components into an order template.

27. The method of claim 17, wherein said user interface enables specification of the order of display of said components in said order template.

28. The method of claim 22, wherein, upon confirmation of said draft orders, the data from said draft orders is saved in said case management data structure.
